(19) United States
(12) Patent Application Publication
(10) Pub. No.: US 2026/0309371 A1
(43) Pub. Date: Oct. 8, 2026

(54) Geothermal Heat Exchangers and Related Installation Apparatuses, Systems, and Methods

(71) Applicant: Fluidaptic, LLC, Maple Grove, MN (US)

(72) Inventors: Thomas Scott BREIDENBACH, Maple Grove, MN (US); Neil F. BREIDENBACH, Reynolds, ND (US)

(73) Assignee: Fluidaptic, LLC, Maple Grove, MN (US)

(21) Appl. No.: 19/550,251

(22) Filed: Feb. 25, 2026

Related U.S. Application Data
(60) Provisional application No. 63/762,649, filed on Feb. 25, 2025.

(51) Int. Cl. F24T 10/15; F24T 10/00

(52) U.S. Cl. CPC F24T 10/15; F24T 2010/53

(57) ABSTRACT

The presently claimed and described technology provides geothermal heat exchangers and related apparatuses, tools, systems, and methods that facilitate economical installation of the heat exchangers. The heat exchangers may be installed using a penetrator that is driven into ground by a driving assembly. The driving assembly may drive the penetrator via a central drill string or drill rod and/or by overlapping driving members of alternating orientation. Tubes of the heat exchangers may be configured in a helical configuration and/or a straight configuration and/or be configured with an extended tube-to-tube spacing. Such extended tube spacing reduces tube-to-tube thermal conduction and increases tube-to-ground thermal conduction and thereby increases efficiency, effectivity, etc. of the geothermal heat exchanger. Sheathing may be positioned around the tubes for protection during installation. The sheathing and/or the driving assembly may place grout and/or other material around and or adjacent the tubes. A housing may be positioned around a fluid return portion of the heat exchanger tubing, and fluid passages may deliver fluid into the ground to facilitate penetration and/or to backfill grout during withdrawal. A removable sheath may be positioned around the tubing and selectively retained and released to permit sheath retrieval while leaving the tubing installed.

### CROSS-REFERENCE TO RELATED APPLICATIONS

This application claims priority to U.S. Provisional Application No. 63/762,649, which was filed on Feb. 25, 2025, U.S. Provisional Application No. 63/897,895, which was filed on Oct. 12, 2025, and U.S. Provisional Application No. 63/958,288, which was filed on Jan. 12, 2026, and all are hereby incorporated herein by reference in their entireties.

### FIELD

The present disclosure relates to geothermal energy technologies, specifically to geothermal heat exchangers, ground loop fields, and ground-source heat pumps, as well as their installation systems, apparatuses, and methods.

### BACKGROUND

U.S. Pat. No. 9,897,347 B2, titled Screw-In Geothermal Heat Exchanger Systems and Methods, and U.S. Pat. No. 11,892,201 B2, titled Installation Apparatus/Tool for Tubular Geothermal Heat Exchanger Systems and Methods, and U.S. Patent Publication No. 2024/0295345 A1, titled Screw-In Geothermal Heat Exchanger Systems and Methods, are incorporated herein by reference in their entireties and are related to this application.

Commercially available equipment for installing geothermal heat exchangers includes well drilling machines, horizontal directional boring machines, excavators, and similar heavy equipment. Such equipment is expensive, may require specialized operators, and increases overall installation cost for geothermal ground loop fields used with ground-source heat pumps.

Conventional installation methods commonly cause extensive disruption to the surrounding area. Conventional equipment also typically requires significant staging area and high clearance (headroom), limiting practical installation locations and increasing logistics costs.

In certain commercial practices, loops of geothermal heat exchangers include an outgoing tube or tube portion and a returning tube or tube portion positioned together within the borehole and are thus relatively close to each other (or even touching). The borehole may require a casing to prevent borehole collapse and/or satisfy other requirements. Such casings further add to the cost of material and labor. The borehole may be filled with grout upon the geothermal heat exchanger loop being placed in the borehole. Such grout further adds to the cost of material and labor, especially in volumes sufficient to substantially fill the borehole. Such close tube-to-tube placement results in significant thermal conduction between the outgoing tube or tube portion and the returning tube or tube portion. This tube-to-tube thermal conduction (i.e., thermal interference or thermal short-circuiting) reduces tube-to-soil thermal conduction and thereby lowers the efficiency, effectivity, etc. of the geothermal heat exchanger. To overcome this lowered performance, a larger geothermal heat exchanger and/or a larger borehole may be used, but at increased initial cost, installation cost, and operating costs, and a larger geothermal ground loop field may further be required.

Accordingly, there is a need for geothermal heat exchangers, and related apparatuses, systems, and methods, that facilitate more economical installation, reduced equipment and labor costs, minimized site disruption, smaller staging requirements, lower material cost, reduced installation time, and/or increased tube-to-tube spacing to improve thermal performance.

Further limitations and disadvantages of conventional and traditional prior art geothermal heat exchangers and related conventional and traditional prior art apparatuses, tools, systems, and methods and apparatuses, tools, systems, and methods that facilitate economical installation, minimal installation site disruption, reduced installation time, extended spacing of the tubes and/or tube portions, etc. will become apparent to one of skill in the art, through comparison of such mechanisms and/or methods with certain aspects of the present disclosure, as set forth in the remainder of the present application with reference to the drawings.

### BRIEF SUMMARY

The present disclosure describes geothermal heat exchangers and related apparatuses, systems, and methods that facilitate economical installation and placement of heat-exchanger tubing and fluid/thermal interconnections for geothermal ground-loop fields. Embodiments reduce capital equipment and material costs (for example by reducing or eliminating grout and/or bore casings), lower labor and staging costs, and minimize short- and long-term site disturbance. Reduced staging area and headroom permit installation in constrained locations such as crawl spaces, basements, small yards, and between closely spaced structures.

When multiple heat exchangers are installed, the heat exchangers may be interconnected by manifold(s) laid in one or more trenches. Trench depth can be selected for frost protection, and trenches can be narrow to minimize disruption. By using narrow trenching tools and compact base equipment (for example, mini-trenchers and mini skid steers) site disturbance may be minimized.

Certain embodiments use compact mobile base equipment (e.g., a mini skid steer, compact pile driver) or non-mobile mounts (e.g., tripods, building-mounted frames) as a driver base and drive the penetrator using a driver that transmits axial, torsional, impact, and/or vibratory forces. The driver may transfer fluid (e.g., via an injection adapter or a rotary union) through a driver connector body (sometimes referenced as a housing connector where the housing interface is emphasized) and through internal fluid passages in the penetrator to assist penetration or to place grout and other materials during installation or withdrawal. Sheathing may be applied to protect tubing during installation and to serve as a conduit for fluid delivery (e.g., grout) during withdrawal.

Embodiments include elongate load-transferring assemblies formed by drill rod strings (center-driven systems) and/or by overlapping joint driving assemblies composed of modular driving members that are sequentially added and removed to lengthen/shorten the assembly. The overlapping-joint approach permits a low-transverse-cross-section driving assembly and enables modular removal and reuse of driving members while leaving distal consumable components in place when desired.

The disclosure also describes multi-thread start couplings, locking coupling joints, sheath retainers/releasers, helical and linear penetrators and housings, guides for maintaining tube spacing, spool and supply arrangements, and methods for injecting lubricating fluids, jetting fluids, and grout to assist penetration and backfilling. Various embodiments and permutations are described in the detailed description and figures that follow.

### BRIEF DESCRIPTION OF THE FIGURES

Embodiments of the present disclosure will now be described, by way of example only, with reference to the attached Figures, wherein:

FIGS. 1A-1F are side elevation views illustrating a mini skid steer used as a base for a preinstallation system preparing an installation site (shown cutaway) with a center-driven helical (i.e., double helicoid) penetrator for receiving a dual-tube helical geothermal heat exchanger, where the penetrator is positioned at various positions by the mini skid steer including just above ground level at FIG. 1A, within a trench at FIG. 1B, ≈½ a drill rod's length into the ground at FIG. 1C, ≈1 drill rod's length into the ground at FIGS. 1D & 1E, with an additional drill rod added at FIG. 1E, and ≈2 drill rod's length into the ground at FIG. 1F;

FIG. 2A is a replacement portion of FIG. 1B, as called out at FIG. 1B, but instead illustrating a center-driven linear penetrator preparing an installation site (shown cutaway) for receiving a dual-tube linear geothermal heat exchanger;

FIG. 2B is a replacement portion of FIG. 1C, as called out at FIG. 1C, but instead illustrating the linear penetrator of FIG. 2A preparing the installation site (shown cutaway);

FIGS. 3A & 3B are side elevation views similar to FIGS. 1A-1F, but with the center-driven helical penetrator oriented at an angle to vertical thereby preparing for angular installation of the helical heat exchanger, where FIG. 3A illustrates the helical penetrator positioned into the ground (shown cutaway), and FIG. 3B illustrates the helical penetrator substantially removed from the ground (shown cutaway);

FIG. 4A is a replacement portion of FIG. 3A, as called out at FIG. 3A, but instead illustrating the center-driven linear penetrator of FIG. 2A preparing for angular installation of the linear heat exchanger;

FIG. 4B is a replacement portion of FIG. 3B, as called out at FIG. 3B, but instead illustrating the center-driven linear penetrator of FIG. 2A preparing the installation site for the linear heat exchanger;

FIG. 5A is a partial exploded perspective view of a driver, an adapter, and a drill rod of the preinstallation system of FIGS. 1A-1F;

FIG. 5B is an enlarged portion of FIG. 5A, as called out at FIG. 5A;

FIG. 5C is an enlarged portion of FIG. 5A, as called out at FIG. 5A;

FIG. 5D is an enlarged partial cross-sectional elevation view of FIG. 1A, as called out at FIG. 1A, illustrating the driver, the adapter, and the drill rod of FIG. 5A and a joint lock;

FIG. 6A is an enlarged exploded perspective view of the penetrator and drill rod of FIG. 1A with a joint lock for selectively locking a coupling joint therebetween and further illustrating a nose portion and a blade portion of the penetrator;

FIG. 6B is an enlarged portion of FIG. 6A, as called out at FIG. 6A;

FIG. 6C is an enlarged portion of FIG. 6A, and similar to FIG. 6B, but unexploded;

FIG. 6D is an enlarged cross-sectional elevation view, as called out at FIG. 1A, of the penetrator and drill rod of FIG. 1A locked by the joint lock of FIG. 6A and with optional fluid passages schematically illustrated;

FIG. 7 is an enlarged perspective view of the linear penetrator of FIG. 2A with optional fluid passages schematically illustrated and further illustrating a nose portion and a blade portion of the penetrator;

FIGS. 8A-8C are perspective views illustrating a prior art single thread-start coupling on end portions of prior art drill rods, where FIG. 8A is a cutaway view of the coupling, FIG. 8B illustrates a male end portion, and FIG. 8C illustrates a female end portion;

FIG. 9 is an enlarged side elevation view illustrating a mount for mounting the driver of FIG. 5A to the mini skid steer of FIGS. 1A-1F;

FIGS. 10A-10R are side elevation views, or portions thereof, illustrating the base of FIGS. 1A-1F used as a driver base and transporter in an installation system installing a dual-tube helical geothermal heat exchanger into the ground (shown cutaway) with a center-driven helical (i.e., double helicoid) penetrator with a nose portion and a blade portion, where the installation system and/or the penetrator are transported and/or positioned at various positions by the driver base (e.g., the mini skid steer) including at a service position above the ground level at FIG. 10A & enlarged portion thereof, FIG. 10B, with an above-ground portion of the installation system supported at the ground level by a spool and utilities base and the penetrator positioned within the trench by the driver base at FIGS. 10C & 10D, with a first drill rod added at FIG. 10D, with the penetrator ≈1 drill rod's length into the ground at FIG. 10E & enlarged portion thereof, FIG. 10F, and FIG. 10G, with a second drill rod added at FIG. 10G, with the penetrator ≈2 drill rods'length into the ground at FIG. 10H & enlarged portions thereof, FIGS. 10I & 10J, FIG. 10K & enlarged portion thereof, FIG. 10L, FIG. 10M & enlarged portions thereof, FIGS. 10N & 10O, Fig. P, Fig. Q, and Fig. R, with a sheath holding mechanism securing a pair of sheaths around the dual-tubes at FIGS. 10A-10I, releasing the pair of sheaths at FIG. 10J, and separated from the pair of sheaths at FIGS. 10K-10R, with the pair of sheaths ≈½ retrieved from the ground at FIGS. 10K & 10L, with the pair of sheaths retrieved from the ground at FIGS. 10M-10R, with the second drill rod retrieved from the ground and the ground backfilled with grout (shown cutaway) at FIG. 10P, with the first drill rod attached at Fig. Q, with the first drill rod further retrieved from the ground and the ground further backfilled with additional grout (shown cutaway) at FIG. 10R, with a drill string clamp illustrated at FIG. 10B (clamped) & 10N (unclamped), with tube and/or sheath constraints illustrated at FIG. 10F, with the sheath holding mechanism illustrated at FIG. 10I (held) & 10J (released), and with a pair of sheath retaining tabs for engaging the sheath holding mechanism illustrated at FIGS. 10L & 10O;

FIGS. 11A-11G are perspective views, or portions thereof, illustrating the installation system of FIGS. 10A-10R with the driver base hidden and only an attachment flange of the driver of FIG. 5A shown in dashed-line, where a frame is illustrated as both a base for a pair of spools and a base for a utility-providing arrangement at FIG. 11A & enlarged portions thereof, FIGS. 11B & 11D, where FIG. 11C is a replacement portion for FIG. 11B, as called out at FIG. 11A, and further illustrates a pair of tube/sheath conditioners/processors, where FIG. 11D illustrates a clamp/constraint for selectively constraining the sheath and/or the heat exchanger tube to the spool (of FIG. 12), where FIG. 11E is a cut-away replacement portion for FIG. 11A, as called out at FIG. 11A, illustrating an interior portion within the sheath and a spool-mounted fluid supply connection separated from a fluid connection to the sheath, where FIG. 11F is an enlarged portion of FIG. 11E, as called out at FIG. 11E, illustrating accessing the heat exchanger tube with a compressed air chuck, and where FIG. 11G is a replacement portion for FIG. 11F, as called out at FIG. 11E, and further illustrates supplying compressed air to the heat exchanger tube within the sheath;

FIG. 12 is an enlarged perspective view of one spool of the pair of spools of FIG. 11A;

FIG. 13A & enlarged portion thereof, FIG. 13B, are rear elevation views illustrating the base for the pair of spools and for the utility-providing arrangement of FIG. 11A and further illustrating a spool actuator set;

FIG. 14 is an enlarged cut-away portion of FIG. 10D, as called out at FIG. 10D, illustrating a load carrying rotary union compatible with the preinstallation systems of FIGS. 1A-4B and at least the center-driven installation systems herein;

FIG. 15 & enlarged replacement portion thereof, FIG. 16, are perspective views and similar to FIGS. 11A & 11B but with a drill rod added between an adapting drill rod and the rotary union of FIG. 14 and with legs removed from the frame, where FIG. 15 illustrates the drill string clamp clamped, and FIG. 16 illustrates the drill string clamp unclamped;

FIG. 17 is a replacement portion of FIG. 10E, as called out at FIG. 10E, illustrating a helical guide for the installation of the tubes of the heat exchanger of FIGS. 10A & 11A;

FIG. 18 is an enlarged perspective view of the helical guide of FIG. 17;

FIG. 19 & enlarged replacement portion thereof, FIG. 20, are perspective views and similar to FIGS. 15 & 16 but with the drill rod substantially extended into the ground (not shown) and portions of the heat exchanger and sheathes installed, where FIG. 20 also shows the helical guide of FIG. 17 and the pair of tube/sheath conditioners/processors of FIG. 11C;

FIG. 21 & enlarged replacement portion thereof, FIG. 22, are broken perspective views with FIG. 21 being similar to FIG. 15 but with the heat exchanger and sheathes substantially installed, where FIG. 21 illustrates a sheath retainer retaining the pair of sheaths to the penetrator, and FIG. 22 illustrates the sheath retainer releasing the sheaths from the penetrator;

FIG. 23 & enlarged portions thereof, FIGS. 24-26, are perspective views with FIG. 23 being similar to FIG. 21 but with the pair of sheaths substantially retrieved onto the pair of spools, the drill rods retrieved from the ground, and with the heat exchanger substantially installed into the ground (not shown), where FIG. 24 illustrates a tabbed end of a first sheath, where FIG. 25 illustrates a first end of the installed heat exchanger separated from the first sheath, and where FIG. 26 illustrates a tabbed end of a second sheath separated from a second end of the installed heat exchanger;

FIG. 27 is a perspective view and similar to FIG. 23 but with the adapting drill rod of FIG. 15 (i.e., the distal-most drill rod) connected to the rotary union of FIG. 14;

FIG. 28 is a perspective view and similar to FIG. 27 but with the installation system of FIGS. 10A-10R removed (i.e., transported) from the heat exchanger installation site and with the legs reinstalled on the frame of FIG. 11A providing a service position that does not require the mini skid steer (or other driver base);

FIG. 29 & enlarged replacement portion thereof, FIG. 30, are perspective views with FIG. 29 being similar to FIG. 11A but of an installation system adapted for installing a dual-tube linear geothermal heat exchanger with a center-driven linear penetrator with a nose portion and a blade portion and where transport straps are not shown, where FIG. 30 further illustrates the pair of tube/sheath conditioners/processors of FIG. 11C and a pair of heat exchanger tube guides;

FIG. 31 is an enlarged partial rear elevation view and similar to FIG. 13B but illustrating the installation system of FIG. 29, the pair of tube/sheath conditioners/processors of FIG. 11C, and the pair of tube guides of FIG. 30;

FIG. 32A is a side elevation view further illustrating the installation system of FIG. 29, the pair of tube/sheath conditioners/processors of FIG. 11C, and the pair of tube guides of FIG. 30, with the center-driven linear penetrator in a trench at an installation site (shown cutaway);

FIG. 32B is a side elevation view and similar to FIG. 10H but further illustrating the driver base of FIGS. 1A-1F used with the installation system of FIG. 29 for installing the linear heat exchanger, with the center-driven linear penetrator, into the ground (shown cutaway);

FIGS. 32C-32H are side elevation views, or portions thereof, further illustrating the installation system of FIG. 29 installing the linear heat exchanger with the center-driven linear penetrator, where FIG. 32C & enlarged portion thereof, FIG. 32D, illustrate the heat exchanger substantially installed into the ground (shown cutaway), where FIG. 32E is a replacement portion for FIG. 32D, as called out at FIG. 32C, where FIGS. 32D & 32E are similar to FIGS. 10I & 10J, respectively, but illustrate using a sheath holding mechanism for retaining and releasing a pair of sheaths in a linear installation with the sheaths being held at FIG. 32D and released at FIG. 32E, where FIG. 32F & enlarged portion thereof, FIG. 32G, are similar to FIGS. 10K & 10L, respectively, but show the sheaths (along with sheath retaining tabs for engaging the sheath holding mechanism) partially linearly withdrawn from the ground, and where FIG. 32H is similar to FIG. 10P in showing grout (shown cutaway) backfilling the ground as the drill string (i.e., the elongate load-transferring assembly) is withdrawn from the ground after the pair of sheaths have been withdrawn from the ground but shows the linear installation;

FIG. 33 is a broken perspective view and similar to FIG. 19, but with the linear installation system of FIG. 29 installing the linear heat exchanger of FIG. 29;

FIG. 34 is a partial perspective view and similar to FIG. 27, but illustrating the linear installation system of FIG. 29 and the linear heat exchanger of FIG. 29, upon installation;

FIG. 35 is a perspective view and similar to FIGS. 11A & 29 but illustrating an installation system adapted for installing a dual-tube linear geothermal heat exchanger with an overlapping joint-driven linear penetrator with a nose portion and a blade portion driven by an overlapping joint driving assembly and where extended transport straps and extended legs for the frame of FIG. 11A are shown;

FIG. 36 is an enlarged replacement portion of FIG. 35, as called out at FIG. 35, and similar to FIG. 30 and further illustrating the pair of tube/sheath conditioners/processors of FIG. 11C and the pair of tube guides of FIG. 30;

FIGS. 37A-37J are side elevation views, or portions and/or cross-sections thereof, illustrating the driver base of FIGS. 1A-1F used with the installation system of FIG. 35 in installing the linear heat exchanger into the ground (shown cutaway) with the overlapping joint-driven linear penetrator, where the installation system and/or the penetrator are transported and/or positioned at various positions by the driver base (e.g., the mini skid steer) including at a service position above the ground level and/or above a trench at an installation site at FIG. 37A, where FIG. 37B illustrates the heat exchanger substantially installed into the ground, where FIG. 37C is an enlarged cross-sectional view of FIG. 37B, as called out at FIG. 37B, illustrating the linear penetrator with a pair of anchors at retracted positions, a housing connected to and abutting the penetrator and substantially enclosing a fluid return, and a distal driving member and a medial driving member of the overlapping joint driving assembly, where the distal driving member connects to and abuts the housing and further connects to, abuts, and overlaps the medial driving member, where FIG. 37D & enlarged portion thereof, FIG. 37E, FIG. 37G & enlarged portion thereof, FIG. 37H, and FIGS. 37I & 37J are similar to FIGS. 10P, 10Q, 10R, & 32H in showing grout (shown cutaway) backfilling the ground as the elongate load-transferring assembly is withdrawn from the ground but with the overlapping joint driving assembly as the load-transferring assembly (instead of a drill string) being withdrawing, where FIG. 37F is an enlarged partial cross-sectional elevation view of FIG. 37D, as called out at FIG. 37D, illustrating a shearable fastener sheared to facilitate removal of a reusable portion of the overlapping joint driving assembly from the linear penetrator of FIG. 35 and thus the withdrawal of the load-transferring assembly, where FIG. 37G & enlarged portion thereof, FIG. 37H, illustrate the medial driving member separated and spaced from the distal driving member (which remains in the ground with the heat exchanger), and where FIGS. 37I & 37J illustrate the overlapping joint driving assembly fully withdrawn from the ground with FIG. 37I having a pair of sheaths around a pair of tubes of the heat exchanger and with FIG. 37J not having a pair of sheaths around the pair of tubes;

FIGS. 38A-38I are reverse perspective views, with the ground shown cutaway, illustrating the installation system of FIG. 35 sequentially installing two additional driving members (i.e., medial driving members) in the overlapping joint driving assembly and thereby driving the linear penetrator of FIG. 35 farther into the ground (or sequentially removing the two additional driving members from the overlapping joint driving assembly, if taken in reverse order), where FIG. 38A shows a proximal driving member of the overlapping joint driving assembly adjacent and attached to a prior-installed medial driving member of the overlapping joint driving assembly, where FIG. 38B shows the proximal driving member released and raised above the prior-installed medial driving member, where FIG. 38C shows the proximal driving member rotated 180° and a first additional medial driving member placed near the proximal driving member and the prior-installed medial driving member, where FIG. 38D shows the first additional medial driving member adjacent and attached to both the prior-installed medial driving member and the proximal driving member, where FIG. 38E shows the overlapping joint driving assembly driven into the ground via the proximal driving member, where FIG. 38F shows the proximal driving member released and raised above the first additional medial driving member, where FIG. 38G shows the proximal driving member rotated 180° and a second additional medial driving member placed near the proximal driving member and the first additional medial driving member, where FIG. 38H shows the second additional medial driving member adjacent and attached to both the first additional medial driving member and the proximal driving member, and where FIG. 38I shows the overlapping joint driving assembly further driven into the ground via the proximal driving member;

FIG. 39 is a broken perspective view and similar to FIG. 21 but with the heat exchanger and sheathes substantially installed with the linear installation system of FIG. 35;

FIG. 40 is a broken perspective view and similar to FIG. 39 but with the overlapping joint driving assembly removed from the ground and a penetrator anchor deployed;

FIG. 41 & enlarged portion thereof, FIG. 42, are perspective views showing the pair of sheaths being removed from the pair of tubes of the installed heat exchanger, where FIG. 41 is a broken view, and where the elongate load-transferring assembly was previously removed;

FIG. 43 & enlarged portions thereof, FIGS. 44-47, are perspective views with FIG. 43 being similar to FIG. 23 but with the heat exchanger and sheathes substantially installed into the ground (not shown) with the linear installation system of FIG. 35, where FIG. 44 shows a first end of the heat exchanger separated from the first sheath, where FIG. 45 shows a tabbed end of a first sheath separated from the first end of the heat exchanger, where FIG. 46 shows a second end of the heat exchanger separated from the second sheath, and where FIG. 47 shows a tabbed end of a second sheath separated from the second end of the heat exchanger;

FIG. 48 is an enlarged partial elevation view of a center-driven helical penetrator with a housing, a nose portion, and a blade portion, a pair of sheaths, and a heat exchanger, suitable for use with the helical driving systems of FIGS. 10A-10R & 11A-11C, and further illustrating a helical spacer/guide between the drill string and the pair of helical sheaths around the pair of helical heat exchanger tubes;

FIG. 49 is a cross-sectional plan view of FIG. 48, as called out at FIG. 48, further illustrating the helical spacer/guide and a joint lock of a coupling joint of the drill string;

FIG. 50 is a partial cross-sectional elevation view of FIG. 48, as called out at FIG. 48, further illustrating the helical spacer/guide and a sheath retainer/releaser;

FIG. 51 is a partial cross-sectional elevation view of FIG. 48, as called out at FIG. 48, further illustrating the helical spacer/guide, the sheath retainer/releaser, a fluid return of the helical heat exchanger, a housing connector of the helical driving system, and a multi-thread-start drive coupling connecting the housing connector to the drill string;

FIG. 52 is an enlarged portion of FIG. 51, as called out at FIG. 51, further illustrating the drive coupling with multi-start threads that facilitate high engagement torque capacity and low-torque disengagement and further clamps/releases the sheath retainer/releaser against the housing and/or the housing connector when coupled/uncoupled (i.e., engaged/disengaged);

FIG. 53 is an enlarged partial perspective view of a first portion (e.g., a male portion) of the multi-thread-start drive coupling of FIG. 51 integrated with the housing connector;

FIG. 54 is an enlarged partial cutaway perspective view of a second portion (e.g., a female portion) of the multi-thread-start coupling of FIG. 51 integrated with the drill rod;

FIG. 55 is an enlarged elevation view of the helical spacer/guide of FIG. 48 integrated with the sheath retainer/releaser of FIG. 50;

FIG. 56 is a cross-sectional plan view of FIG. 55, as called out at FIG. 55, further illustrating the helical spacer/guide of FIG. 48 and the sheath retainer/releaser of FIG. 50;

FIG. 57 is a side elevation view of the center-driven helical penetrator with the housing, the nose portion, and the blade portion and the heat exchanger of FIG. 48, the housing connector of FIG. 51, and a sheath retainer/releaser;

FIGS. 58-60 further illustrate the center-driven helical penetrator assembly of FIG. 57, where FIG. 58 is a front elevation view, FIG. 59 is an enlarged perspective view, and FIG. 60 is an exploded perspective view;

FIG. 61 is a side elevation view of an alternate center-driven helical penetrator assembly (to the center-driven helical penetrator assembly of FIG. 57) with a housing, a nose portion, and a blade portion illustrating a housing connector, housing portions, and sheath retainer/releaser that interlock with each other;

FIGS. 62-64A further illustrate the center-driven helical penetrator assembly of FIG. 61, where FIG. 62 is a rear elevation view, FIG. 63 is an enlarged perspective view, and FIG. 64A is an exploded perspective view;

FIG. 64B is a perspective view of the blade of the penetrator assembly of FIG. 61;

FIGS. 65-67 illustrate a fluid return of a helical heat exchanger suitable for the center-driven helical penetrator assembly of FIG. 61, where FIG. 65 is the side elevation view of FIG. 61, where FIG. 66 is the rear elevation view of FIG. 62, and where FIG. 67 is a cutaway of the side elevation view of FIG. 65;

FIGS. 68-72 further illustrate the sheath retainer/releaser of the center-driven helical penetrator assembly of FIG. 57, where FIG. 68 is a perspective view of the penetrator assembly with a pair of heat exchanger tubes fluidly connected to the fluid return of FIG. 51 and a pair of sheaths positioned over the pair of tubes, where FIG. 69 is an enlarged portion of FIG. 68, as called out at FIG. 68, illustrating a pair of tabs of the pair of sheaths captured by the sheath retainer/releaser, where FIG. 70 is an enlarged replacement portion for FIG. 69, as called out at FIG. 68, illustrating the pair of tabs of the pair of sheaths released by the sheath retainer/releaser, where FIG. 71 is a perspective view of the sheath retainer/releaser, and where FIG. 72 is the perspective view of FIG. 68 but only showing the pair of sheaths;

FIGS. 73-76 illustrate a sheath retainer/releaser, constrained by a pair of guides, for the center-driven linear penetrator assembly of FIGS. 29 & 30, where FIG. 73 is a cutaway side elevation view of the penetrator assembly with a pair of heat exchanger tubes fluidly connected to a fluid return of FIGS. 83-85 and a pair of sheaths positioned over the pair of tubes, where FIG. 74 is an enlarged portion of FIG. 73, as called out at FIG. 73, illustrating a pair of tabs of the pair of sheaths captured (i.e., retained) by a sheath retainer/releaser of FIG. 76 that is held by the multi-thread-start coupling half (shown at FIGS. 32D, 51, & 52), where FIG. 75 is an enlarged replacement portion for FIG. 74, as called out at FIG. 73, illustrating the pair of tabs of the pair of sheaths freed (i.e., released) from the sheath retainer/releaser when the multi-thread-start coupling half is loosened (see FIG. 32E) allowing the sheath retainer/releaser to move along the pair of guides away from a housing connector thereby releasing the tabs, and where FIG. 76 is a perspective view of the sheath retainer/releaser;

FIGS. 77-82 further illustrate the center-driven linear penetrator assembly of FIGS. 29, 30, & 73-75, but without the sheaths and without the extended tubes, where FIG. 77 is a side elevation view, where FIG. 78 is a front elevation view, where FIG. 79 is a top view, where FIG. 80 is a bottom view, where FIG. 81 is an enlarged perspective view schematically illustrating a set of fluid passages, and where FIG. 82 is an exploded perspective view;

FIGS. 83-85 further illustrate and only show the fluid return of FIG. 73 suitable for use with the linear penetrator assembly of FIGS. 29, 30, 73-75, & 77-82, where an outside thickness of a fluid return portion is less than an outside diameter of the extended heat exchanger tubes, where FIG. 83 is the top view of FIG. 79, where FIG. 84 is the bottom view of FIG. 80, and where FIG. 85 is the perspective view of FIG. 82 with the fluid return cutaway;

FIG. 86 is a partial exploded perspective view illustrating a sub-assembly of the dual-tube linear geothermal heat exchanger of FIG. 35, a pair of sheaths positioned over a pair of tubes of the dual-tube heat exchanger with a fluid return fluidly connecting the pair of tubes, a distal driving member of the overlapping joint driving assembly of FIGS. 35-43, and a sheath-retainer/releaser to retain and later facilitate removal of the pair of sheaths;

FIG. 87 is an enlarged portion of FIG. 86, as called out at FIG. 86, illustrating a driving flange of the distal driving member;

FIG. 88 is an enlarged portion of FIG. 86, as called out at FIG. 86, showing a cutout for a fluid return portion of the heat exchanger and a sheath retaining tab of one of the sheaths;

FIG. 89 is an enlarged portion of FIG. 86, as called out at FIG. 86, illustrating the sheath-retainer/releaser;

FIG. 90 is the perspective view of FIG. 86, but with the sub-assembly unexploded;

FIG. 91 is a partial exploded perspective view illustrating a ground loop (e.g., a dual-tube geothermal heat exchanger with a fluid return) with penetrator assembly that includes the sub-assembly of FIG. 86 and the linear penetrator of FIG. 35 with an anchor shown transparently and the penetrator housing suitable for transmitting driving loads between the sub-assembly and the blade portion of the linear penetrator;

FIG. 92 is the partial exploded perspective view of FIG. 91, but cutaway to a thickness-wise center of the linear penetrator and schematically illustrating a pair of fluid passages;

FIG. 93 is the partial perspective view of FIG. 91, but unexploded and with the anchor shown non-transparently;

FIG. 94 is a perspective view of the blade portion of the linear penetrator of FIG. 35 illustrating a driven flange and schematically illustrating the pair of fluid passages of FIG. 92;

FIG. 95 is another perspective view of the blade portion of the linear penetrator of FIG. 35 illustrating a cutting edge of the blade portion of the linear penetrator;

FIG. 96 is an enlarged elevation view of the ground loop with penetrator assembly of FIG. 91 cutaway to a width-wise center of the linear penetrator;

FIG. 97 is an exploded perspective view of a driving assembly with ground loop and penetrator that includes the ground loop with penetrator assembly of FIG. 91 (shown with the anchor deployed), a proximal driving member of the overlapping joint driving assembly of FIG. 35, and a fastener;

FIG. 98 is the perspective view of FIG. 97, but unexploded and shown with the anchor retracted, illustrating the overlapping joint driving assembly of FIG. 35 configured with no medial driving member;

FIG. 99 is a side elevation view of the driving assembly with ground loop and penetrator of FIG. 97 illustrating the overlapping joint driving assembly of FIG. 35 configured with one of the medial driving members of FIG. 38C connected to both the distal driving member of FIG. 86 and the proximal driving member of FIG. 97 thereby lengthening the overlapping joint driving assembly from the configuration shown at FIG. 98;

FIG. 100 is a cross-sectional plan view of the driving assembly with ground loop and penetrator as configured at FIG. 99, as called out at FIG. 99, illustrating the fluid return of FIG. 86 of the dual-tube heat exchanger of FIG. 35, the penetrator housing of FIG. 91, the pair of sheaths of FIG. 86, and fluid passages through the penetrator housing;

FIG. 101 is a cross-sectional plan view of the driving assembly with ground loop and penetrator as configured at FIG. 99, as called out at FIG. 99, illustrating the medial driving member of FIG. 38C engaged with the distal driving member of FIG. 86, the pair of sheaths of FIG. 86, the dual-tube heat exchanger of FIG. 35, the fastener of FIG. 97, and fluid passages through the driving assembly of FIG. 35;

FIG. 102 is a cross-sectional plan view of the driving assembly with ground loop and penetrator as configured at FIG. 99, as called out at FIG. 99, illustrating the medial driving member of FIG. 38C engaged with the proximal driving member of FIG. 97, the pair of sheaths of FIG. 86, the dual-tube heat exchanger of FIG. 35, a fastener, and fluid passages through the driving assembly of FIG. 35;

FIG. 103 is a plan view of the medial driving member of FIG. 38C;

FIG. 104 is a perspective view of the medial driving member of FIG. 38C;

FIG. 105 is a broken perspective view of the proximal driving member of FIG. 97;

FIG. 106 is a partial cutaway perspective view of the proximal driving member of FIG. 97 illustrating fluid passages;

FIG. 107 is a partial perspective view of an alternate driving assembly for an alternate ground loop (e.g., a dual-tube geothermal heat exchanger with a fluid return) and an alternate penetrator and illustrates an alternate linear overlapping joint driving assembly configured with a shortened distal driving member, a transitional driving member, and a series of medial driving members, similar to the medial driving members of FIG. 38C, connected to both the shortened distal driving member and an alternate proximal driving member of FIG. 115 thereby lengthening and shortening the overlapping joint driving assembly as desired, where the view further illustrates an alternate housing connector and an alternate penetrator housing;

FIG. 108 is the partial perspective view of FIG. 107, but cutaway to a thickness-wise center of the penetrator and illustrating an alternate fluid passage arrangement for transferring fluid from the joint driving assembly to the penetrator via the housing connector, with compact passages that cross over the heat exchanger, and to the penetrator housing with outward passages that are positioned outwardly from the heat exchanger;

FIG. 109 is an enlarged portion of FIG. 108, as called out at FIG. 108, further illustrating the fluid passage arrangement including the heat exchanger crossover passages;

FIG. 110 is the partial perspective view of FIG. 107, but with a penetrator anchor retracted and with the view cutaway to a width-wise center of the penetrator thereby illustrating a joint arrangement between the driving members, between the distal driving member and the housing connector, between the housing connector and the penetrator housing, and between the penetrator housing and the blade portion of the penetrator;

FIG. 111 is an enlarged portion of FIG. 110, as called out at FIG. 110, further illustrating the joint arrangement between the driving members;

FIG. 112 is an enlarged portion of FIG. 110, as called out at FIG. 110, further illustrating the joint arrangement between the housing connector and the penetrator housing, and between the penetrator housing and the blade portion of the penetrator;

FIG. 113 is the partial perspective view of FIG. 107, but exploded;

FIG. 114 is a perspective view of the blade portion of the penetrator of FIG. 107;

FIG. 115 is a side elevation view of the driving assembly, ground loop, and penetrator of FIGS. 107-113 further illustrating an alternate driver and an alternate elongate load-transferring arrangement including an alternate proximal driving member integrated with an alternate driver adapter, where the load-transferring arrangement includes the lengthenable/shortenable overlapping joint driving assembly connected between the driver and the penetrator;

FIG. 116 is a cross-sectional plan view of the driving assembly with ground loop and penetrator as configured at FIG. 115, as called out at FIG. 115, illustrating the heat exchanger fluid return and housing of FIG. 107, including fluid passages through the penetrator housing;

FIG. 117 is a cross-sectional plan view of the driving assembly with ground loop and penetrator as configured at FIG. 115, as called out at FIG. 115, illustrating the transitional driving member of FIG. 107 engaged with the distal driving member of FIG. 107, a pair of sheaths, the dual-tube heat exchanger of FIG. 107, a flush-mount fastener pair for connecting the driving members, and fluid passages through the driving assembly of FIG. 107;

FIG. 118 is a cutaway partial perspective view of the driving assembly with ground loop and penetrator as configured at FIG. 115, as called out at FIG. 115, illustrating another (upper) transitional driving member of FIG. 107 engaged with the proximal driving member of FIG. 115, the pair of sheaths of FIG. 117, the dual-tube heat exchanger of FIG. 107, and fluid passages and an inlet port of the fluid passage arrangement of FIG. 108;

FIGS. 119 & 120 are perspective views of a male fastener of the fastener pair of FIG. 117 illustrating a thru-hex-socket for tightening and loosening the fastener pair;

FIGS. 121 & 122 are perspective views of a female fastener of the fastener pair of FIG. 117 illustrating a slidable interface for allowing abutting engagement of the driving members;

FIGS. 123-129 illustrate a tripod used as a base for a preinstallation system preparing an installation site with a center-driven linear penetrator driven by a driver, where the penetrator and driver are positioned at various positions by a winch connected to the tripod, including an above-ground-level service position illustrated at a cutaway side elevation view of FIG. 123, where at least the tripod, the driver, and the winch may further be used to install a dual-tube linear geothermal heat exchanger either at the prepared installation site or at an unprepared installation site, where FIG. 124 is an enlarged portion of FIG. 123, as called out at FIG. 123, illustrating a pivoting mount for mounting a drive-spool and a winch cable of the winch and a cable spool to the tripod, where FIGS. 125 & 126 are cross-sectional elevation views of FIG. 124, as called out at FIG. 124, further illustrating the mounting of a hook hanger, the winch, the cable spool, and the winch cable to the driver base (e.g., the tripod), where FIG. 127 is an enlarged portion of FIG. 123, as called out at FIG. 123, illustrating the driver held by a hook of the winch cable and attached to the penetrator via an injection adapter for injecting fluid through the penetrator and thereby assisting in penetration of the ground (e.g., via fluid jetting), where FIG. 128 is an enlarged cross-sectional elevation view of FIG. 127, as called out at FIG. 127, illustrating a proximal end of a fluid passage within the injection adapter in fluid communication with fluid passages through a driver connector body, a nose cone, and a blade of the penetrator and further illustrating a distal end of the injection adapter connected to a proximal end of the driver connector body (i.e., a penetrator body) at a coupling joint, and where FIG. 129 is an auxiliary view of FIG. 127, as called out at FIG. 127, further illustrating the nose cone, the body, and the blade of the penetrator;

FIG. 130 is a perspective view of the nose cone of FIGS. 128 & 129 of the penetrator;

FIGS. 131-143 are portions of the side elevation view of FIG. 123 or portions and/or cross-sections of these portions but where the winch cable has lowered and raised the driver toward and from the ground-level and where a penetrator position indicator monitors coupling joint(s) (e.g., for loosening), where FIG. 131 illustrates the driver having been lowered (e.g., by the winch cable) thereby bringing the penetrator nose cone into contact with the ground-level, where FIG. 132 illustrates the driver having driven the nose cone and the penetrator blade beneath the ground level via the injection adapter but with the proximal end of the driver connector body remaining above the ground level, where FIG. 133 & enlarged portion thereof, FIG. 134, illustrate the injection adapter separated and raised from the proximal end of the penetrator (e.g., by the winch cable), a drill rod connected to the injection adapter at a coupling joint, and a distal rod of the position indicator extending above the proximal end of the driver connector body, where FIGS. 135 & 136 are cross-sectional elevation views of FIG. 133, as called out at FIG. 133, where FIG. 135 illustrates a proximal end of an extension rod of the position indicator substantially spaced from the proximal end of the fluid passage (e.g., of the injection adapter), where FIG. 136 illustrates a distal end of the extension rod of the position indicator held (e.g., by tape) at a distal end of the drill rod, where FIG. 137 & enlarged portion thereof, FIG. 138, illustrate the distal end of the extension rod dropping from the distal end of the drill rod (e.g., upon the tape being removed) and rotationally and translationally connecting with a proximal end of the distal rod of the position indicator at an indicator joint, where FIG. 139 illustrates the driver, the injection adapter, and the drill rod having been lowered (e.g., by the winch cable) and connected with the proximal end of the penetrator (e.g., the distal end of the drill rod connected to the proximal end of the body of the penetrator at a coupling joint), where FIGS. 140 & 141 are cross-sectional elevation views of FIG. 139, as called out at FIG. 139, where FIG. 140 illustrates the proximal end of the extension rod of the position indicator spaced from the proximal end of the fluid passage by an end clearance, where FIG. 141 illustrates the indicator joint of FIG. 138 at an enlarged bore portion of the drill rod and further illustrates a separating distance of the indicator joint is greater than the end clearance of FIG. 140 thereby keeping the indicator joint from coming apart, even if no fasteners are added at FIG. 138, where FIG. 142 illustrates the driver having been lowered (e.g., by the winch cable) and thereby the penetrator having been driven farther beneath the ground level but with a proximal end of the drill rod remaining above the ground level, where FIG. 143 illustrates the injection adapter having been separated and raised from the proximal end of the drill rod (e.g., by the winch cable) and thereby making way for another drill rod, with another extension rod of the position indicator therein, to be connected to the injection adapter and thereby allowing an extension cycle of an elongate load-transferring arrangement (e.g., drill rod(s), a drill string, etc.) to repeat as desired, and where at least the tripod, the driver, the drill string, and the winch may further be used to install the dual-tube linear geothermal heat exchanger at an installation site;

FIG. 144 is a perspective view of an adapter (e.g., a hex adapter) suitable for use at the proximal end of the distal rod of the position indicator, as shown at FIG. 134, for example;

FIG. 145 is a perspective view of a coupling (e.g., a hex coupling) suitable for use at the distal end of the extension rod(s) of the position indicator, as shown at FIGS. 136 & 141, and joinable to the hex adapter or the hex (male) extension rod for forming the indicator joint;

FIGS. 146-150 illustrate an alternate driver connected to the driver base (e.g., the tripod) via a dynamic suspension, where FIG. 146 is the side elevation view of FIG. 123, but broken and with a tripod leg stabilizer chain partially cutaway instead of one of the tripod's legs partially cutaway and where the penetrator's nose cone has penetrated the ground-level and the penetrator's blade is contacting the ground-level, where FIG. 147 is a broken elevation view projected off of FIG. 146 with all of the tripod's legs hidden and the stabilizer chain partially cutaway and/or hidden, where FIG. 148 is an enlarged partial cutaway perspective view illustrating a spreader bar and rigging connected to a pair of brackets, a pair of weights respectively connected to the pair of brackets, a pair of dynamic driver mounts respectively connected to the pair of brackets, a third weight mounted to the alternate driver by a third bracket, and fluid supply tubing connected to the injection adapter, where FIG. 149 is an enlarged portion of FIG. 148, as called out at FIG. 148, with the tripod's head and two of three legs hidden and illustrating the rigging supported by the winch cable hook, and where FIG. 150 is an enlarged portion of FIG. 148, as called out at FIG. 148, further illustrating the connection between one of the pair of brackets and one of the dynamic driver mounts;

FIG. 151 is a portion of the cutaway side elevation view of FIG. 123, but illustrating another alternate driver connected to the driver base (e.g., the tripod), where the driver includes a compacting plate, a drive cap is mounted to the injection adapter, and the drive cap is driven by the compacting plate of the driver thereby driving the penetrator into the ground;

FIG. 152 is an enlarged portion of FIG. 151, illustrating an operator control interface;

FIG. 153 is an enlarged portion of FIG. 151, as called out at FIG. 151, illustrating the drive cap mounted to the injection adapter and the compacting plate;

FIG. 154 is a perspective view of the drive cap of FIGS. 151 & 153;

FIG. 155 is a cutaway perspective view of the driver connector body of FIG. 128 illustrating a central bore that serves as an internal fluid passage routed length-wise;

FIGS. 156-159 further illustrate the blade of FIG. 128 of the penetrator, where FIG. 156 is a perspective view, where FIG. 157 is a front elevation view, where FIG. 158 is a cross-sectional elevation view of FIG. 157, as called out at FIG. 157, further illustrating the fluid passages of FIG. 128, and where FIG. 159 is a bottom plan view;

FIG. 160 is a perspective view of an alternate blade for the penetrator;

FIG. 161 is a cutaway side elevation view of the nose cone of FIGS. 128-130 of the penetrator illustrating a plurality of spray-nozzle ports and the fluid passages of FIG. 128;

FIGS. 162 & 163 are perspective views of a spray nozzle/orifice suitable for use in the spray-nozzle ports of FIG. 161 of the nose cone of the penetrator;

FIGS. 164-172 illustrate the driver base (e.g., the tripod) and the winch of FIG. 123 used to remove the drill rod(s) of FIG. 133 and the penetrator of FIG. 123 from the ground, where FIG. 164 is a portion of the cutaway side elevation view of FIG. 123, but where FIG. 164 & enlarged portion thereof, FIG. 165, illustrate a pulling adapter connected to the injection adapter and thereby to the penetrator and the drill rod(s), if present, where, for example, the winch cable hook is hooked to a hoist ring of the pulling adapter, where FIG. 166 & enlarged portion thereof, FIG. 167, are respectively duplicates of FIGS. 164 & 165 but with the winch cable, the winch cable hook, the hook hanger of FIG. 126, and an added pulley arranged in a block-and-tackle configuration thereby multiplying a pulling capacity of the winch, where FIG. 168 is an enlarged portion of FIG. 166, as called out at FIG. 166, illustrating the pivoting mount of FIG. 124 self-adjusting to keep a pulling position and direction between the driver base and the pulling adapter the same with or without the use of the block-and-tackle configuration, where FIG. 169 is an enlarged projected partial elevation view of FIG. 166, as called out at FIG. 166, where FIG. 170 is a further enlarged cross-sectional elevation view of FIG. 169, as called out at FIG. 169, where FIG. 171 is a portion of FIG. 148 but illustrating the block-and-tackle pulling configuration of FIGS. 166-170, where FIG. 172 is an enlarged portion of FIG. 171, as called out at FIG. 171, (and similar in perspective to FIG. 149) but with the tripod's head and two of three legs hidden and the third leg shown as transparent further illustrating the self-adjusting pivoting mount of FIG. 124;

FIGS. 173-176 illustrate an alternative penetrator with high-pressure sealing of fluid passages thereof, with a driver connector body and a blade portion of a penetrator pinned together, with a thick wall thickness of the body adjacent a nose cone, and with a proximal end of the body connectable to the distal end of the injection adapter and the distal end of the drill rod to form a coupling joint, where FIG. 173 is an inverted exploded perspective view illustrating a pair of body-mounted obround O-rings as a pair of blade seals, a set of circular O-rings for use as crush seals under heads of a set of flat head screws, a set of hollow spring pins, and a set of clinchable fasteners for securing the set of pins, where FIG. 174 is another inverted perspective view illustrating the obround O-rings (with hidden lines shown dashed) pre-installed in O-ring grooves of the body, and O-ring installation fixtures facilitating installation of the obround O-rings and the blade into the body (with a slot-guiding fixture shown with hidden lines dashed), where FIG. 175 is an auxillary view of FIG. 174, as called out at FIG. 174, illustrating one of the O-ring installation fixtures in an inlet of fluid passages within the blade, and where FIG. 176 is a perspective view of the components shown at FIG. 174 but with the O-ring installation fixtures exploded (i.e., removed) and with a cutaway showing the obround O-rings and blade installed into the body;

FIGS. 177-181 illustrate the alternative penetrator with high-pressure sealing of FIG. 173 but with an alternative pair of inject-in-place seals instead of the pair of obround O-rings, where FIG. 177 is a partial front elevation view of the alternatively sealed penetrator showing a seal injecting tool temporarily installed into a seal injection port of the body, where FIG. 178 is a partial enlarged cross-sectional view of FIG. 177, as called out at FIG. 177, further illustrating the seal injecting tool, the seal injection port, a first seal groove fluidly connected to the seal injecting tool, a second seal groove fluidly connected to a plugged port, and a plug in the plugged port, where FIG. 179 is an enlarged cutaway view of FIG. 177, as called out at FIG. 177, further illustrating the seal injecting tool, the seal injection port, and a portion of the first seal groove, where FIG. 180 is an enlarged cutaway view of FIG. 177, as called out at FIG. 177, further illustrating a portion of the first seal groove fluidly connected to an unplugged port (i.e., a vent), and where FIG. 181 is an enlarged replacement portion for FIG. 180, as called out at FIG. 177, illustrating the vent upon plugging with a plug and the first sealing groove now filled with injected sealing material;

FIGS. 182 & 183 illustrate an alternative penetrator with high-pressure sealing of the fluid passages thereof, with the body and blade of the penetrator pinned together, with a thick wall thickness of the body adjacent the nose cone, with a thick blade, and with a proximal end of the body connectable to the distal end of the injection adapter and the distal end of the drill rod to form a coupling joint, where FIG. 182 is an inverted exploded perspective view illustrating a pair of blade-mounted obround O-rings as a pair of blade seals, a set of circular O-rings for use as crush seals under heads of a set of flat head screws, and a set of hollow spring pins, where FIG. 183 is the inverted perspective view of FIG. 182, but unexploded;

FIG. 184 is an inverted partial front elevation view of a driver connector body of a penetrator illustrating a slot open at a distal end portion of the body, a pair of tips adjacent a distal end of the slot with a set of releasable constraints and a set of driving surfaces, and a set of attachment features adjacent a proximal end of the slot;

FIGS. 185 & 186 each include an inverted perspective view illustrating a reuseable portion of the penetrator, where a driver bar of the penetrator is positioned at the proximal end of the open slot of the body of FIG. 184 and includes driving surfaces, where a pair of connectors join the body and the driver bar, where a jacking/retaining arrangement is constrained by the driver bar, where a proximal end of the body is connectable to the distal end of the injection adapter and the distal end of the drill rod to form a coupling joint, where FIG. 185 is an exploded view, and where FIG. 186 is an unexploded view;

FIG. 187 is an inverted front cutaway elevation view of the reuseable portion of FIGS. 185 & 186 of the penetrator further illustrating the driver bar mounted at the proximal end of the slot, a head of an actuator screw of the jacking/retaining arrangement constrained by a hollow set screw (i.e., a stop) within a counter bore of the driver bar, a pair of retaining slides adjacent the set of releasable constraints, a female coupling half at the proximal end of the body that is connectable to the male coupling half of the distal end of the injection adapter and of the distal end of the drill rod, and a set of fluid passages including a central bore of the body, a pair of branch passages that fork around a central portion of the driver, and a pair of channels that respectively continue from the pair of branch passages to the pair of tips;

FIGS. 188 & 189 each include an inverted perspective view illustrating consumable portions of the penetrator including a mount member including a jacking/retaining interface and a head mount, a first retainer (i.e., a sheath retainer/releaser, holding mechanism, etc.) positioned between the pair of retaining slides at the tips of the body, a second retainer (i.e., a sheath retainer/releaser, holding mechanism, etc.) positioned adjacent a distal end portion of the jacking/retaining arrangement, and a penetrator head with an interior cavity, a plurality of fluid nozzles, and a proximal set and a distal set of driven surfaces, and further illustrating assembly of the consumable portions to the reuseable portion of the placing penetrator further including attaching the penetrator head to the head mount of the mount member, engaging the distal set of driven surfaces with the set of driving surfaces of the tips, engaging the proximal set of driven surfaces with the driving surfaces of the driving bar, and engaging the jacking/retaining arrangement with the second retainer and with the jacking/retaining interface, where the penetrator head includes and integrates a nose portion, a blade portion, and a housing portion of the penetrator with each other, where FIG. 188 is an exploded view, and where FIG. 189 is an unexploded view;

FIGS. 190 & 191 each include an inverted perspective view illustrating an alternate reuseable portion of the penetrator similar to the reuseable portion of FIGS. 185 & 186 but where an alternate driver bar with alternate driving surfaces of the alternate penetrator is joined to an alternate body by a pair of axial fasteners at a proximal end of the open slot, where a proximal end of the body is also connectable to the distal end of the injection adapter and to the distal end of the drill rod to form a coupling joint, where FIG. 190 is an exploded view, and where FIG. 191 is a partial unexploded view;

FIGS. 192 & 193 each include a partial inverted perspective view illustrating consumable portions of the alternate penetrator of FIGS. 190 & 191, similar to or the same as the consumable portions of FIGS. 188 & 189, including an alternate second retainer (i.e., a sheath retainer/releaser) also positioned adjacent the distal end portion of the jacking/retaining arrangement, where FIG. 192 is an exploded view, and where FIG. 193 is an unexploded view;

FIGS. 194 & 195 are enlarged views further illustrating the penetrator head of the penetrators of FIGS. 188 & 189 and FIGS. 192 & 193, where FIG. 194 is an inverted front elevation view illustrating parallel side walls adapted to slide within and out of the open slot of the penetrator bodies of FIGS. 184 & 190, an enlarged integrated tip (i.e., the nose portion) that extends beyond the side walls and engages and is constrained by the set of releasable constraints and the set of driving surfaces of the pair of tips of the body, and an integrated angled pair of angled edges (i.e. the blade portion) with the plurality of fluid nozzles, and where FIG. 195 is a perspective view illustrating the integrated interior cavity (i.e., the housing portion), a pair of restraining pins, a set of fluid passage stops including a pair of tube/sheath cradles, the distal set of driven surfaces at the proximal side of the enlarged tip, the proximal set of driven surfaces at the proximal end of the penetrator head, and the plurality of fluid nozzles;

FIGS. 196 & 197 are perspective views of a weld fixture for the penetrator head of the penetrators of FIGS. 188 & 189 and FIGS. 192 & 193, where FIG. 196 is an exploded view illustrating that the penetrator head includes a sheet metal tip, a pair of duplicate sheet metal sides with the angled edge, and the pair of the retaining pins, and where FIG. 197 is an unexploded view;

FIGS. 198-201 are partial views of a pair of sheaths each having a pair of sheath retaining tabs extending from a tabbed end of the sheath for engaging a sheath holding mechanism, where the sheaths are illustrated in an as-installed shape (when installed over the heat exchanger tubing and in the penetrators of FIGS. 188 & 189 and FIGS. 192 & 193, as further illustrated at FIGS. 202, 205, 207, 209, & 211), where ends of the tabs are thickened (e.g., by sewing or bonding multiple layers of a fabric of the sheath), where the thickened ends of the tabs are selectively trapped by the first retainer or the second retainer of the sheath holding mechanism, where the sheath may be gathered or bunched (as shown) if a larger sheath is desired around a smaller heat exchanger tube (e.g., for more annular area when grout passes between the sheath and the tube), where FIG. 198 is a perspective view of a first sheath, where FIG. 199 is a replacement portion for FIG. 198, as called out at FIG. 198, thereby showing the perspective view of a second sheath, where FIG. 200 is a side elevation view of the first sheath, and where FIG. 201 is a replacement portion for FIG. 200, as called out at FIG. 200, thereby showing the side elevation view of the second sheath;

FIG. 202 is a partial perspective view of the pair of sheaths of FIGS. 198-201 installed over a pair of heat exchanger tube leg portions that are butt-welded (i.e., butt-fused) to a three-fitting heat exchanger fluid return thereby fluidly connecting the pair of tubes, illustrating the sheaths and the heat exchanger in an as-installed shape/configuration (e.g., when installed in the penetrators of FIGS. 188 & 189 or FIGS. 192 & 193, as further illustrated at FIGS. 205, 207, 209, & 211);

FIGS. 203 & 204 each include a partial perspective view illustrating an alternate heat exchanger suitable for use and/or adaptable for use with the penetrators of FIGS. 188 & 189 or FIGS. 192 & 193 with an alternate fluid return (e.g., to the three-fitting return shown at FIGS. 202 & 205-212 and/or the custom-shaped returns herein) formed by bending a piece of the heat exchanger tubing, where the alternate bent return may be joined (e.g., butt-fused) to the heat exchanger tube leg portion(s) and/or where a continuous heat exchanger tube may be bent and thereby the alternate bent return may be formed along the continuous heat exchanger tube along with and/or between a first leg portion and/or a second leg portion (e.g., with no welding to the return), where a thickness of the alternate fluid return may be reduced (e.g., by squeezing) along with or separately from the bending, where FIG. 203 shows most of the leg portions cutaway, and where FIG. 204 further shows half of the thickness cutaway;

FIGS. 205 & 206 each include a partial cutaway side elevation view illustrating a heat exchanger and penetrator assembly including the pair of sheaths of FIGS. 198-201 installed over the pair of heat exchanger tube leg portions of FIG. 202 with at least a portion of the sheaths and a portion of the heat exchanger installed within the interior cavity of the penetrator head of FIGS. 188, 189, & 192-195, where a first tab of the pair of sheath retaining tabs of each of the pair of sheaths of FIGS. 198-201 is routed past the pair of tube/sheath cradles/fluid passage stops of FIG. 195 and constrained/restrained respectively by the pair of restraining pins of the penetrator head of FIGS. 195 & 196, where the set of fluid passage stops close off fluid passages formed between an exterior of the heat exchanger and/or the sheaths and/or the interior of the penetrator head (with sealant/adhesive optionally joining and/or sealing components of the passage) and thereby facilitate providing pressurized flow to the plurality of fluid nozzles of the penetrator head, where the set of tube/sheath cradles (and/or the sealant/adhesive) may cushion the heat exchanger from the penetrator head, where FIG. 205 further shows the first tabs of the sheath retaining tabs routed past (one tab in each direction) the first retainer positioned between the pair of retaining slides (i.e., a pair of guides) at the tips of the body and the thickened ends of these tabs thereby captured (i.e., retained) by the first retainer and further shows the second tabs of the pair of sheath retaining tabs of each of the pair of sheaths routed past (both tabs toward a center) the second retainer positioned adjacent the distal end portion of the jacking/retaining arrangement and the thickened ends of these tabs thereby captured (i.e., retained) by the second retainer and further shows the jacking/retaining arrangement securing the driver bar to the jacking/retaining interface of the mount member and thereby the penetrator head, where the restraining pins, the first retainer, and/or the second retainer retain, constrain, and/or hold the tabs and thereby relieve at least some load(s) carried by the sheaths from being transferred to the heat exchanger, where FIG. 206 further shows the jacking/retaining arrangement releasing the driver bar from the jacking/retaining interface and thereby releasing (i.e., freeing) the first tabs from the first retainer and the second tabs from the second retainer (e.g., by releasing the thickened ends of these tabs) and thereby also allowing the first tabs past the restraining pins and the tube/sheath cradles (e.g., via deformation of the cradles and/or the heat exchanger);

FIGS. 207 & 208 each include a partial perspective view of the heat exchanger and penetrator assembly of FIGS. 205 & 206, but with the driver connector body of the penetrator shown as transparent and with the penetrator head shown as transparent and in dotted line, further illustrating the selective retaining/releasing of the pair of sheaths of FIGS. 198-201 and the set of driving surfaces of the body and of the driver bar of FIGS. 190 & 191 engaging/disengaging the driven surfaces of the penetrator head of FIGS. 188, 189, & 195, where FIG. 207 shows both the proximal set and the distal set of driving surfaces and the driven surfaces engaged and shows the pair of sheaths retained, and where FIG. 208 shows both sets of the driving and driven surfaces disengaged and the pair of sheaths released;

FIGS. 209 & 210 each include a partial perspective view of the heat exchanger and penetrator assembly of FIGS. 205 & 206, but with the driver connector body of the penetrator shown as transparent and with the penetrator head shown as transparent and in dotted line, illustrating a method of actuating the jacking/retaining arrangement of FIGS. 185-187 and further illustrating the selective retaining/releasing of the pair of sheaths of FIGS. 198-201, where FIG. 209 shows a hex drive shaft extending through the hollow set screw of FIG. 187 and engaging the actuator screw, where the hex drive shaft may further perform the function of the distal rod of FIG. 134 and thereby facilitate the use of the penetrator position indicator, especially when the actuator screw is tightened, where FIG. 210 shows the actuator screw having been loosened and unscrewed from threads of the jacking/retaining interface of the mount member by the hex drive shaft (and optionally the extensions of the penetrator position indicator) thereby jacking the driver bar away from the penetrator head and further disengaging the second sheath retainer/releaser from the jacking/retaining interface and freeing the first sheath retainer/releaser to move away from the set of surfaces at the proximal side of the enlarged tip of the penetrator head and thereby release the pair of sheaths;

FIGS. 211 & 212 each include a partial perspective cutaway view of the heat exchanger and penetrator assembly of FIGS. 205 & 206 further illustrating the method of actuating the jacking/retaining arrangement of FIGS. 185-187, the selective retaining/releasing of the pair of sheaths of FIGS. 198-201, the first retainer sliding between the pair of retaining slides (i.e., guides) at the tips of the driver connector body (e.g., the penetrator body), and the second retainer sliding within and between the parallel side walls (i.e., guides) of the penetrator head, where FIG. 211 shows the actuator screw of the jacking/retaining arrangement clamping the driver bar and the mount member together and thereby also clamping (via the head mount) the driving surfaces and the driven surfaces together and thereby further constraining the first retainer to form a small gap with the tip of the penetrator head to retain the pair of first sheath tabs, where the actuator screw further holds (but does not necessarily clamp) the second retainer, where FIG. 212 shows the hex drive shaft unscrewing the actuator screw from the jacking/retaining interface of the mount member and thereby unclamping, releasing, and jacking the driver bar from the mount member, where the hollow set screw (i.e., the head stop) may abut a head of the actuator screw to accomplish the jacking, where releasing and/or jacking facilitates the removal of the reuseable portion of the penetrator from the ground and further allows the first retainer to separate from the tip of the penetrator head to release the pair of first sheath tabs, and where unscrewing the actuator screw further releases the second retainer.

### DETAILED DESCRIPTION

The following detailed description provides illustrative examples of the subject matter, which pertains to geothermal heat exchangers, installation systems, and related methods. These examples are intended to facilitate understanding of the subject matter and its various embodiments but are not intended to limit the scope of the described technology. The described technology broadly encompasses systems, apparatuses, and methods for installing geothermal heat exchangers in a manner that reduces costs, minimizes site disruption, and improves efficiency. The disclosed embodiments may be applied to geothermal ground loop fields, ground-source heat pumps, and other thermal energy transfer applications, including artificial ground freezing, climate control, and snowmelt systems. Certain details, such as conventional components, techniques, or processes, may be omitted where they are well-known to those skilled in the art. The described subject matter is not restricted to the specific configurations, arrangements, or methods outlined herein, as various modifications, substitutions, and rearrangements may be implemented without departing from the scope of the described subject matter. For example, the disclosed systems may be adapted for different types of penetrators, driving assemblies, or heat exchanger configurations, including helical or linear designs, and may incorporate additional features or components as required for specific applications.

Various embodiments will be described in detail with reference to the drawings, wherein like reference numerals represent like parts and assemblies throughout the several views. It is to be understood that this disclosure is not limited to the particular methodology and examples described herein, as such may vary. It is also to be understood that the terminology used herein is for the purpose of describing particular embodiments only and is not intended to limit the scope of the present disclosure or the appended claims.

As used herein and in the appended claims, the singular forms “a”, “an”, and “the” include plural reference unless the context clearly indicates otherwise.

Unless defined otherwise, all technical and scientific terms used herein have the same meaning as commonly understood to one of ordinary skill in the art to which this disclosure belongs.

Terms such as “linear”, “helical”, “double helicoid”, “planar”, “horizontally”, “vertically”, etc. are used herein. Such terms are idealizations, and prototype and commercial physical embodiments may not necessarily conform to such idealizations because of manufacturing methods and/or limitations, tolerances, defects, etc. For example, something “linear” may have a bow, a twist, and/or other non-linear characteristic. In addition, the idealized characterization may not necessarily pertain to the entire feature. For example, a “helical” tube may have non-helical end-features, transitions, etc. Furthermore, negligible and/or second order changes may occur that do not substantially change a characterization. For example, if a relatively slight reverse displacement is needed to set an anchor, an item being anchored may be characterized as “fully installed” even after the reverse displacement has moved the item from its most advanced position. Nonetheless, such idealized terms may be used to generally characterize certain corresponding embodiments in the figures, the specification, the claims, the prototype physical embodiments, and/or the commercial physical embodiments.

According to the principles of the present disclosure, systems, apparatuses, and methods herein are described and illustrated at the figures in the context of geothermal energy and especially to geothermal heat pump installations where thermal energy (i.e., heat energy) is delivered and/or retrieved to/from ground 90 (e.g., a geothermal ground loop field). In particular, a heat exchanging fluid (e.g., a heat exchanging liquid) is circulated through at least one of various heat exchangers 100 that are at least partially installed into the ground 90 (e.g., the ground loop field) and thereby either delivers or retrieves the thermal energy to/from the ground 90 (e.g., depending on which configuration of the geothermal heat pump is selected).

Additional thermal energy transfer applications are contemplated. For example, at least one of such heat exchangers 100 and/or related tools, systems, methods, etc. may be used in artificial ground freezing (i.e., AGF) to freeze ground (i.e., soil) via chilled heat exchanging fluid for various reasons such as containing contamination that may be in and/or adjacent the ground being frozen (e.g., as part of a soil remediation effort), to stabilize the ground via freezing when excavating and/or constructing at and/or adjacent the ground being frozen, etc. For other examples, at least one of such heat exchangers 100 and/or related tools, systems, methods, etc. may be used to indirectly or directly heat and/or cool a building, a driveway, a road, etc. with or without a heat pump. E.g., a warehouse may be kept substantially cooler in the summer and/or warmer in the winter than ambient (i.e., outdoor) temperatures by directly (i.e., without a heat pump) circulating the heat exchanging fluid (e.g., the heat exchanging liquid) between at least one of the various heat exchangers 100 that are thermally coupled to the ground 90 and one or more fluid-to-air (e.g., liquid-to-air) heat exchangers in the warehouse. E.g., a snowmelt system for a road, a driveway, a parking lot, etc. may be used to clear (i.e., melt) snow and/or ice by circulating the heat exchanging fluid (e.g., the heat exchanging liquid) between at least one of the various heat exchangers 100 that are thermally coupled to the ground 90 and one or more heat exchangers (e.g., serpentine tubing heat exchangers, pre-insulated HDPE modular heat exchange thermal panel units, etc.) beneath and generally parallel with a surface of the road, the driveway, the parking lot, etc. Thus, the applications of the systems, apparatuses, and/or methods herein may extend beyond those involving geothermal heat pumps, climate control of buildings, etc. Various applications may be combined in the same system, and valves may be used to selectively isolate (or combine) the applications.

Auxiliary systems, such as the above-mentioned snowmelt system, thermal solar panels, or the like, may be used to collect thermal energy, especially on warm days, and the collected thermal energy may be transferred to the geothermal ground loop field via heat exchanging fluid circulating within the various heat exchangers 100. Such thermal energy transfers may be used to keep overall thermal energy transfers to the geothermal ground loop field balanced in cooler climates where the geothermal ground loop field may otherwise become imbalanced (i.e., lower year-to-year field temperatures). Likewise, in warmer climates, auxiliary systems may be used to dissipate thermal energy from the geothermal ground loop field via heat exchanging fluid circulating within the various heat exchangers 100 and thereby maintain long term geothermal ground loop field seasonal balance (i.e., steady year-to-year field temperatures).

According to the principles of the present disclosure, various installation systems 20, 20H, 20L, 20C, 20O, which may be generically referred to herein as installation system(s) 20, may be used to install various heat exchangers 100, 100H, 100L, 100C, 100O (i.e., heat exchanger tubing, heat exchanger tube pair, heat exchanger tube pair with U-return, heat exchanger loop, etc.), which may be generically referred to herein as heat exchanger(s) 100, in the ground 90 (i.e., soil, earth, dirt, sand, clay, humus, seabed, lakebed, riverbed, pondbed, streambed, subterranean earth, mixtures of ground types, etc.). The installation system(s) 20 may use various penetrators 200, 200H, 200L, 200C, 200O, which may be generically referred to herein as penetrator(s) 200, to install the heat exchanger(s) 100 in the ground 90. The installation system(s) 20 may use various housings 250, 250H, 250L, 250C, 250O, which may be generically referred to herein as housing(s) 250, to install the heat exchanger(s) 100 in the ground 90. The various heat exchangers 100, penetrators 200, and housings 250 are further described hereinafter.

In certain embodiments, the ground 90 is not bored and/or a conventional borehole and/or a conventional casing is not used thereby saving these corresponding labor and material costs. The installation systems 20 may install the heat exchangers 100 in undisturbed ground 90, or a preinstallation systems 10 may be used to prepare the ground 90 before the installation systems 20 install the heat exchangers 100. The installation systems 20 may install the heat exchangers 100 starting at a surface 92 of the ground 90 or in a trench 94 (or other cut) of the ground 90.

Preinstallation penetrators 200, 200P of the preinstallation systems 10 may be used at the surface 92, in the trench 94, and/or otherwise for loosening, cutting, threading, etc. the ground 90. (The various penetrators 200, 200H, 200L, 200C, 200O may be used as preinstallation penetrators if used without the heat exchanger 100 attached.) The preinstallation penetrator 200, 200P may be used for checking for obstacle(s) in the ground 90 (e.g., by being driven through the ground 90 prior to an attempted installation of the heat exchanger 100), for pre-auguring the ground 90, for spudding the ground 90, etc. As used herein, pre-auguring the ground 90 refers to the use of a continuous or non-continuous flight auger, etc. (e.g., of the preinstallation penetrator 200, 200P) to penetrate and/or loosen the ground 90, and the ground 90 may be loosened along an installation path and may not necessarily be substantially removed from the installation path. As used herein, spudding the ground 90 refers to raising and dropping and/or driving the preinstallation penetrator 200, 200P to break through a layer of hard material and/or an obstruction in the ground 90 and/or dropping and/or driving the penetrator 200, 200P into the ground 90 and then removing the penetrator 200, 200P leaving a hole(s), a cut(s), threads, etc. for subsequent insertion of the installing penetrator 200 (that is attached to the heat exchanger 100). The installing penetrator 200 may be subsequently inserted into the hole(s), cut(s), threads, etc. produced by the spudding (e.g., to accommodate an assembly including the installing penetrator 200 that would otherwise be too long to place directly in (or on) the ground 90).

The installing penetrator 200 may follow the installation path (e.g., including the hole(s), cut(s), threads, etc.) formed by the preinstallation penetrator 200, 200P, or the installing penetrator 200 may form an installation path (e.g., including a hole(s), a cut(s), threads, etc.). The strategy of using the preinstallation penetrator 200, 200P or not may depend on the soil conditions, the need to cut and/or break through rocks, tree roots, hard packed soil, and/or other obstacles, adversity to risk of starting an installation of a heat exchanger 100 and meeting an insurmountable obstacle, and/or adversity to risk of unnecessarily using time and/or equipment for preinstallation work.

Additional uses of the various installation systems 20, 20H, 20L, 20C, 20O and/or the various penetrators 200, 200H, 200L, 200C, 200O, 200P are contemplated (in addition to installing the various heat exchangers 100, 100H, 100L, 100C, 100O). For example, the same or similar installation systems 20 and/or penetrators 200 could be used to install (i.e., route, position, etc.) electrical cables (for power and/or communications), optical fibers, tubing (not necessarily for heat exchangers), conduit, anchoring cables, anchoring bars, anchoring bolts, foundation repair components, foundation piles, pile wall components, etc. For another example, applications that conventionally use directional drilling may be adaptable to the systems, apparatuses, and methods disclosed herein.

For geothermal ground loop field installations with more than one heat exchanger 100, one or more trenches 94 (e.g., a network of the trenches 94) in the ground 90 may be used to facilitate fluidly connecting the heat exchangers 100 to each other. Similarly, one or more trenches 94 (e.g., in the network) may be used to facilitate fluidly connecting the heat exchangers 100 to or adjacent a building (e.g., to a geothermal heat pump system within or outside of the building). In particular, one or more conventional connecting manifolds may be fluidly connected to the heat exchanger(s) 100 and/or to the building and/or corresponding components. Thus, the manifold(s) may fluidly connect multiple heat exchangers 100 to each other (e.g., in series and/or in parallel). The connecting manifold(s) may lay at a bottom of the trenches 94. The trenches 94 may be backfilled upon completion of the various fluid connections and any desired testing of the manifold(s), the heat exchanger(s) 100, and/or the building(s) and/or corresponding component(s).

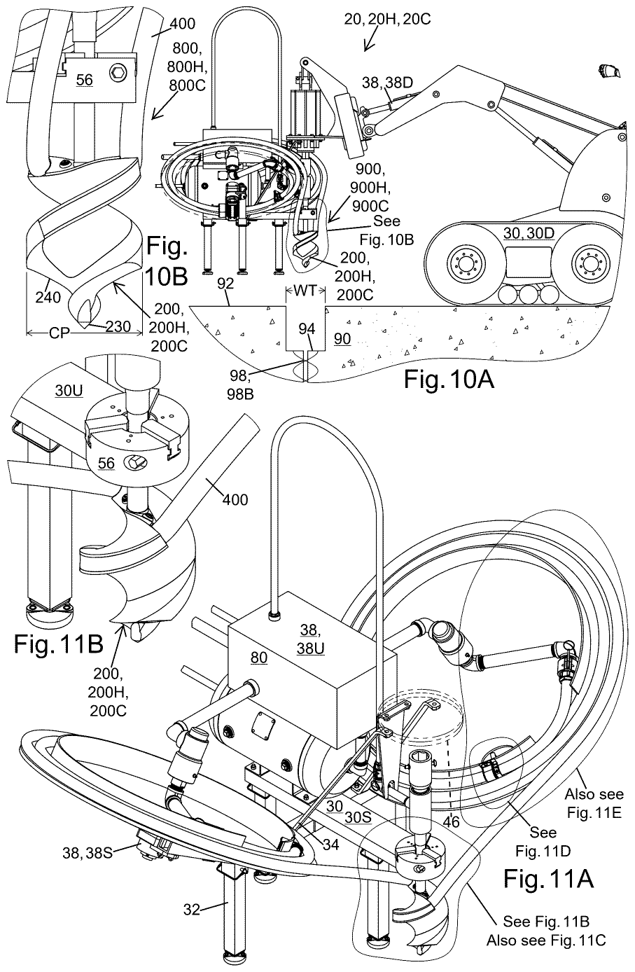

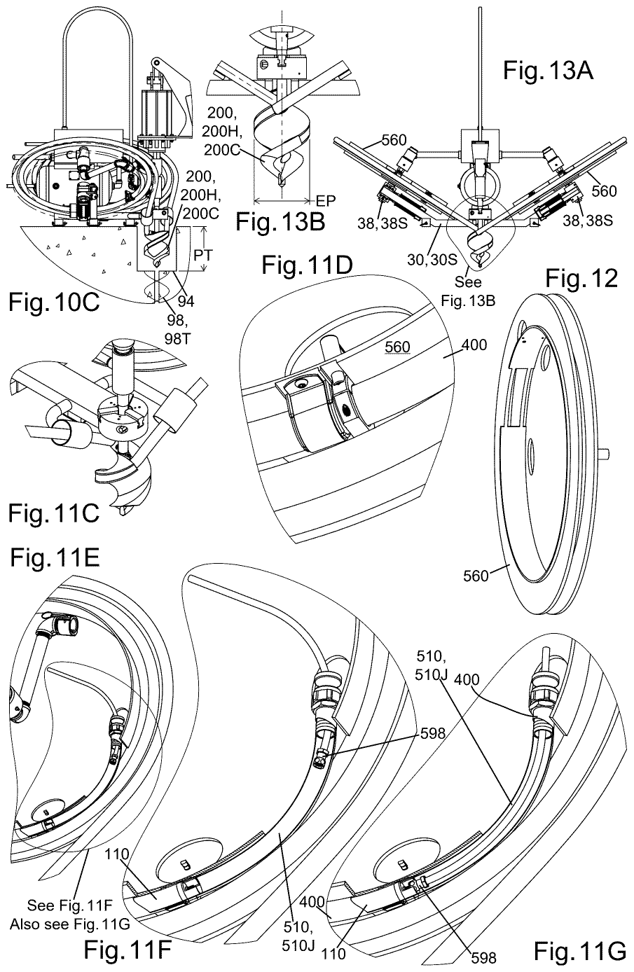

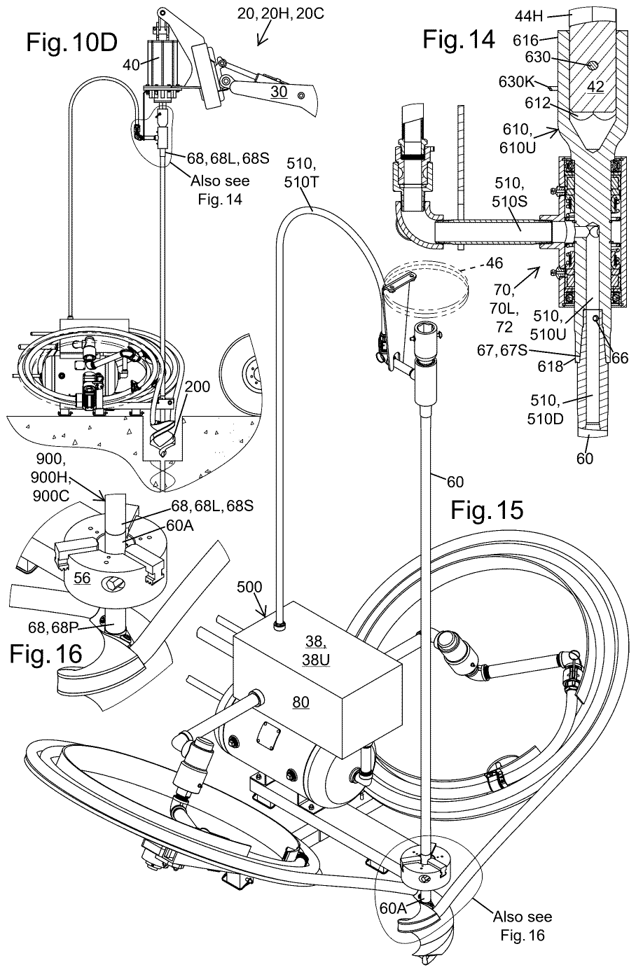

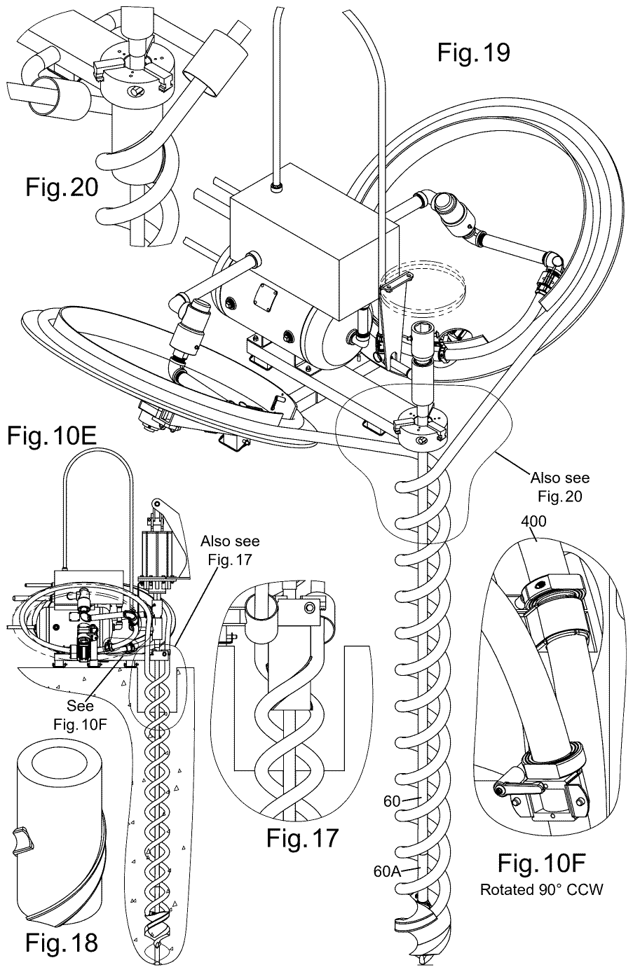

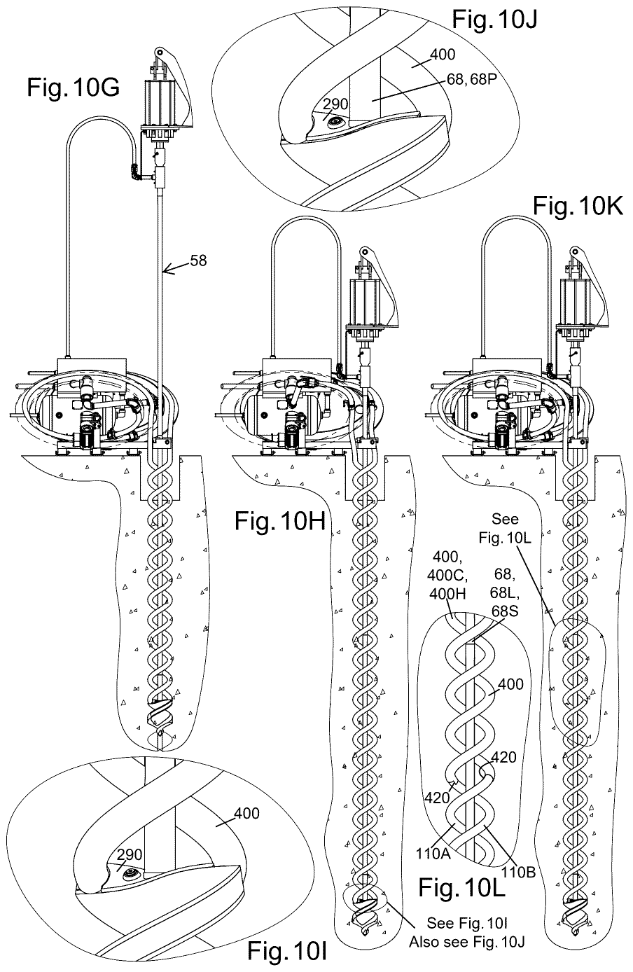

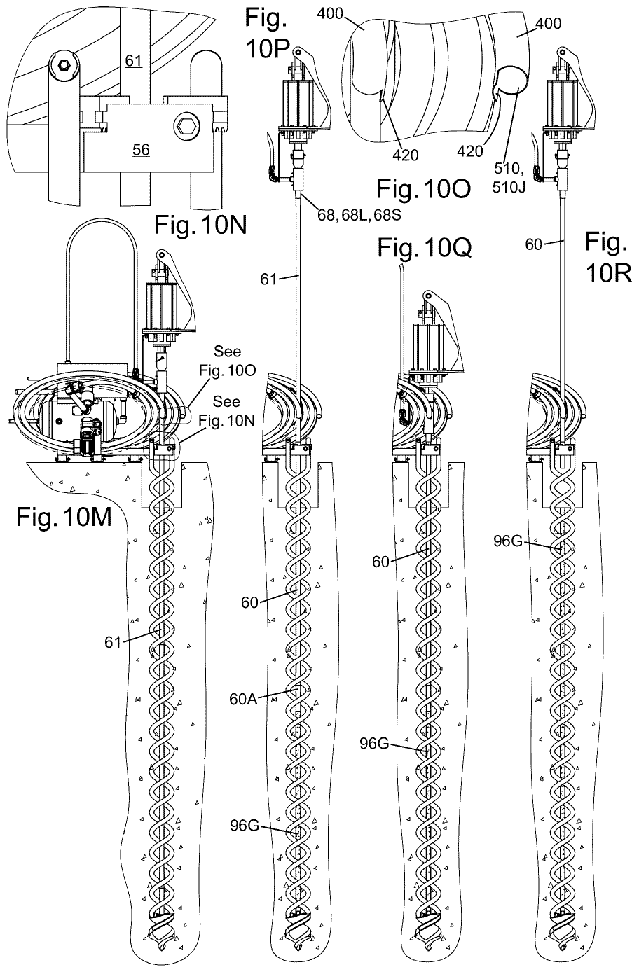

As illustrated at FIGS. 2A, 10A, 10C, 32A, 37A, & 37B, the trench(es) 94 may be a depth PT deep and/or may be a width WT wide. The depth PT of the trench(es) 94 may be selected to be deeper than a maximum annual frost depth of the ground 90 and thereby protect the heat exchanger(s) 100 and/or the connecting manifold(s) from frost damage and/or avoid the use of anti-freeze in the heat exchanging fluid. In the depicted embodiments, the width WT of the trench 94 is selected to be wider than cross-dimension(s) CP, CW, CN (see FIGS. 2B, 6D, 7, 10B, 31, 32A, 37C, 37E, 63, & 77) of the corresponding penetrator(s) 200 and/or cross-dimension(s) EP, EW, EN (see FIGS. 13B, 63, 77, 78, 99, & 100) of the corresponding housing(s) 250 (i.e., encasement(s)) and thereby accommodate placement of the penetrator(s) 200 and/or the housing(s) 250 in the trench 94 prior to driving the penetrator(s) 200 and/or the housing(s) 250 into the ground 90. Upon installation of the heat exchanger 100 (e.g., as illustrated at FIGS. 10R, 24, 34, 37J, & 43), free ends of the heat exchanger 100 may be positioned to be accessible from the trench 94.

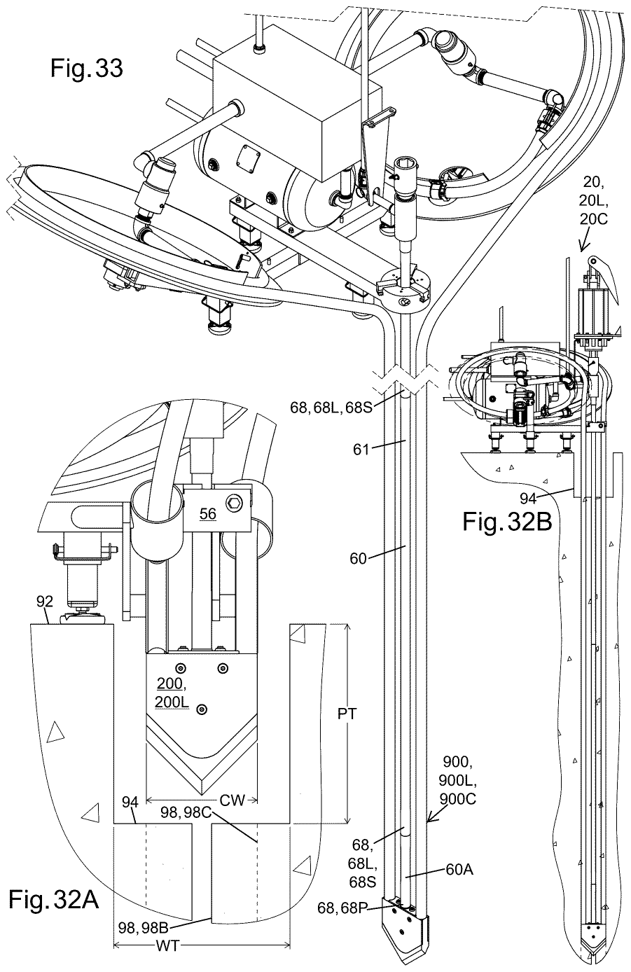

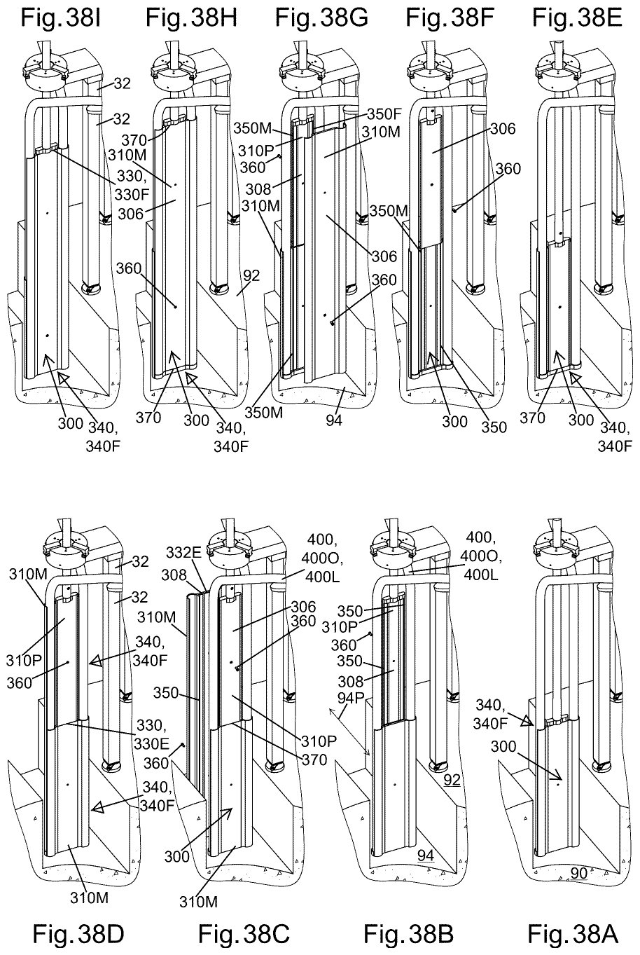

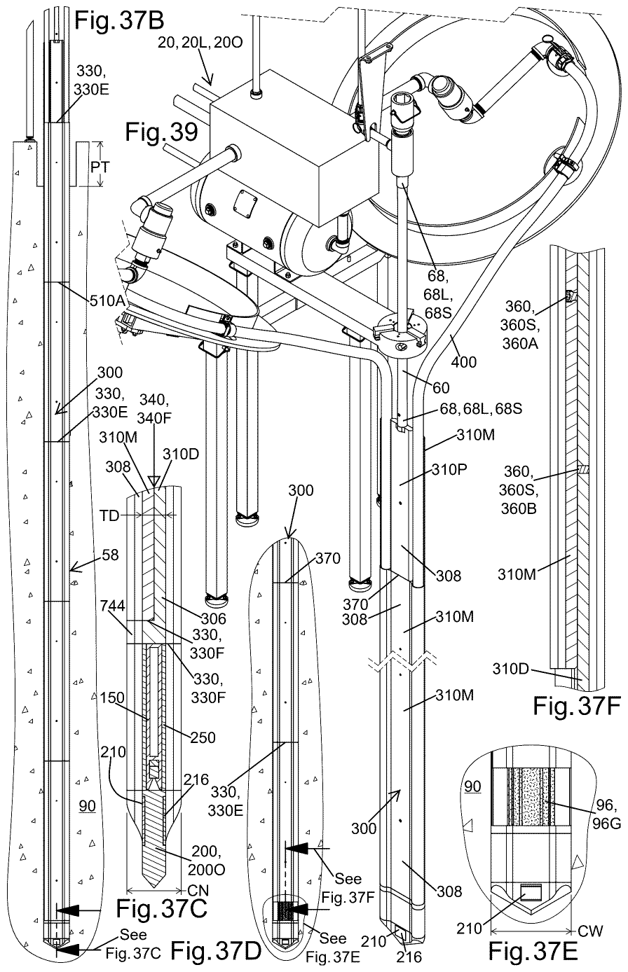

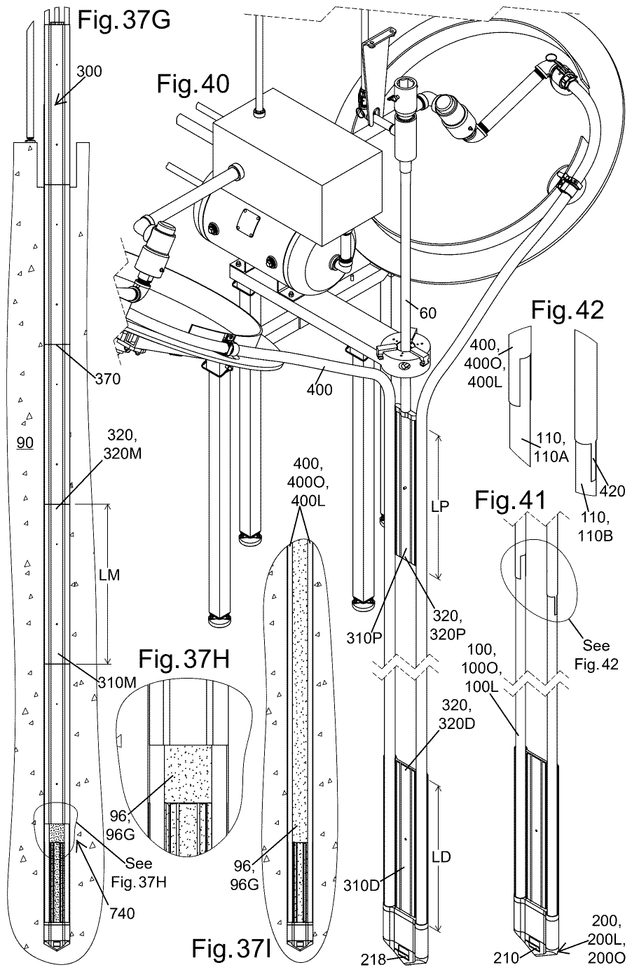

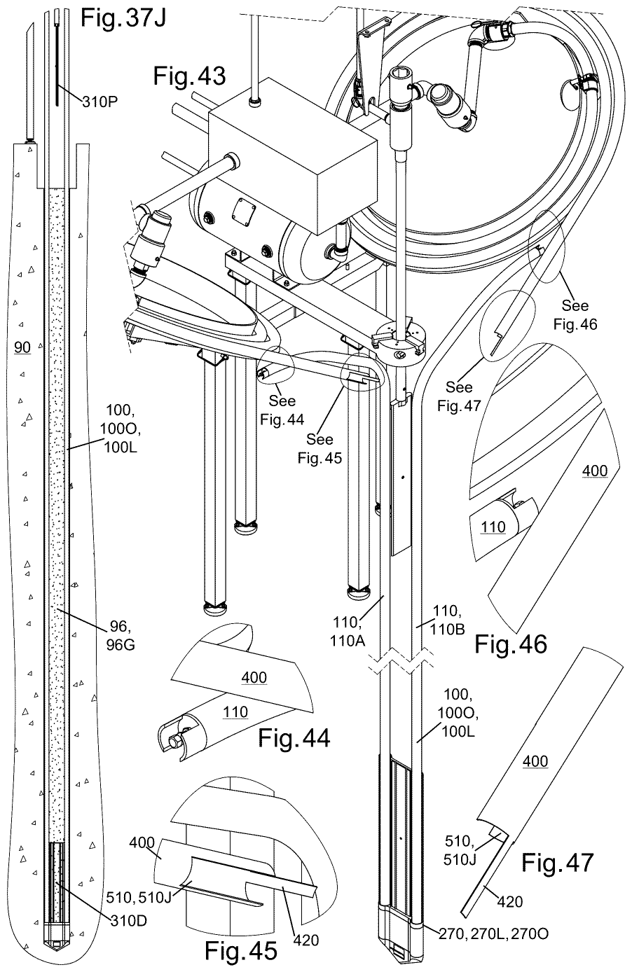

The cross-dimensions CP and EP (see FIGS. 6D, 10B, 13B, & 63) of certain of the penetrators 200H and/or the housings 250H may continue across a range of (if not all) axial orientations of the penetrators 200H and/or the housings 250H, and certain others of the penetrators 200L and/or the housings 250L have wide cross-dimensions CW and EW (see FIGS. 2B, 32A, 37E, 77, & 99) and narrow cross-dimensions CN and EN (see FIGS. 7, 31, 37C, 78, & 100). In the depicted embodiments of FIGS. 32A-32C and FIGS. 37A, 37B, 37G, 37J, & 38A-38I, the cross-dimensions CW and EW extend cross-wise to a path 94P (see FIG. 38B) of the trench 94 (see FIGS. 32A & 37E) and parallel to the width WT of the trench 94 (see FIGS. 32A & 37A), and the cross-dimensions CN and EN extend parallel to the path 94P of the trench 94 (see FIGS. 31, 37C, & 38B) and cross-wise to the width WT of the trench 94.

A cross-dimension HP of certain heat exchangers 100H (see FIGS. 60, 64, & 65) corresponds with the cross-dimensions CP and EP of the penetrators 200H and the housings 250H and may continue across a range of (if not all) axial orientations of the heat exchangers 100H, and certain other heat exchangers 100L have a wide cross-dimension HW (see FIGS. 83 & 100) that corresponds with the cross-dimensions CW and EW and a narrow cross-dimension HN (see FIGS. 84 & 100) that corresponds with the cross-dimensions CN and EN.

In other embodiments not illustrated at the figures, the wide cross-dimensions CW, EW, and HW extend parallel to the path 94P (see FIG. 38B) of the trench 94 and cross-wise to the width WT of the trench 94, and the narrow cross-dimensions CN, EN, and HN extend cross-wise to the path 94P of the trench 94 and parallel to the width WT of the trench 94. As mentioned above, it is typically desirable to minimize the disruption to the area surrounding the installation of the heat exchanger(s) 100 and related components, such as the connecting manifold(s). Minimizing the width WT of the trench 94 helps to minimize the disruption to the installation area, and orienting the wide cross-dimensions CW, EW, and HW parallel to the path 94P of the trench 94 may facilitate minimizing the width WT of the trench 94. Upon installation of the heat exchanger 100 (e.g., as illustrated at FIGS. 34 & 43), free ends of the heat exchanger 100 may be positioned to be accessible from the trench 94.

The width WT of the trench 94 may also be minimized in the embodiments with the cross-dimensions CP, EP, and/or HP (see FIGS. 6D, 10A, 10B, & 63) by forming a narrow trench 94 with a narrow width WT that is sufficient, e.g., for the installation of the manifold(s) but is narrower than the cross-dimensions CP, EP, and/or HP. Instead of the penetrator 200 being started in the narrow trench 94 (in which it does not fit), the penetrator 200 may be started at the surface 92 of the ground 90 and driven through (and beyond) the depth PT of the trench 94 and thereby form, e.g., a hole, a cut, threads, etc. that intersect the narrow trench 94. The installing penetrator 200 may pass the heat exchanger 100 through (and beyond) the depth PT of the trench 94. Upon installation of the heat exchanger 100 (e.g., as illustrated at FIG. 24), free ends of the heat exchanger 100 may be positioned to be accessible from the trench 94 and/or moved to be accessible from the trench 94.

The width WT of the trench 94 may also be minimized in the embodiments with the cross-dimensions CW, EW, and HW positioned cross-wise to the path 94P of the trench 94 (see FIGS. 2A, 32A, 37A, & 38B) by forming a narrow trench 94 with a narrow width WT that is sufficient, e.g., for the installation of the manifold(s) but is narrower than the cross-dimensions CW, EW, and/or HW. Instead of the penetrator 200 being started in the narrow trench 94 (in which it does not fit cross-wise), the penetrator 200 may be started at the surface 92 of the ground 90 and driven through (and beyond) the depth PT of the trench 94 and thereby form, e.g., a hole, a cut, etc. that intersects the narrow trench 94. The installing penetrator 200 may pass the heat exchanger 100 through (and beyond) the depth PT of the trench 94. Upon installation of the heat exchanger 100 (e.g., as illustrated at FIG. 34), free ends of the heat exchanger 100 may be positioned to be accessible from the trench 94 and/or moved to be accessible from the trench 94.

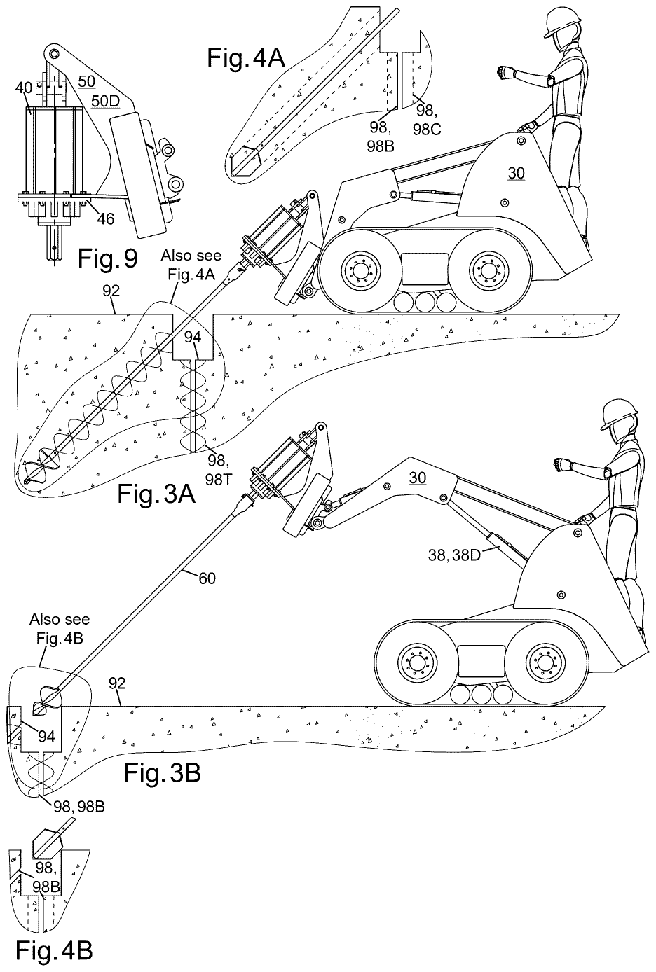

In certain embodiments, the wide cross-dimensions CW, EW, and HW and/or the narrow cross-dimensions CN, EN, and HN may be oriented at an angle to the trench 94 (of various widths). The installation systems 20 may install at least some of the heat exchangers 100 at an angle (see related FIGS. 3A & 4A) to the surface 92 of the ground 90, vertically (see, e.g., FIG. 10R), or horizontally (not shown) in the ground 90 in various combinations with the various other installation orientations and/or with trenches 94 of various widths.

The connecting manifold(s) may be placed in the trench 94 and thus may at least partially determine the minimum width WT of the trench 94. In addition, as the connecting manifold(s) often carry the heat exchanging fluid to/from several of the heat exchangers 100, a cross-sectional area of a fluid carrying passage of the connecting manifold(s) may be sized substantially larger than a cross-sectional area of a fluid carrying passage of the heat exchangers 100. To facilitate a narrow trench 94 and a large cross-sectional area of the fluid carrying passage of the connecting manifold(s), a non-circular cross-section (e.g., an obround, oblong, rectangular, or oval shape) may be selected for the connecting manifold(s), and a narrow cross-dimension of the non-circular cross-section may be aligned with the width WT of the trench 94. To facilitate a narrow trench 94 and a large total cross-sectional area of the fluid carrying passage(s) of the connecting manifold(s), multiple tubes may be used (commonly joined or unjoined to each other).

In certain embodiments, it may be desired to have a trench 94 with a shallow depth PT for easy and convenient installation, and it may also be desired to have a trench 94 with a deep depth PT to space the connecting manifold(s) and/or an upper portion of the heat exchangers 100 away from the surface 92 of the ground 90 for isolation from undesired temperatures (including transient temperatures) at or near the surface 92. To at least partially accommodate both desires, thermal insulation may be applied to the connecting manifold(s) and/or to the upper portion of the heat exchangers 100 and thereby at least partially avoid unwanted thermal connection and thermal energy transfer to, e.g., soil near the surface 92.

The preinstallation systems 10 and/or the installation systems 20 may include a base 30 (i.e., base equipment) and/or a driver 40, and the base 30 and/or the driver 40 may be common between the preinstallation systems 10 and the installation systems 20, or they may be different.

Various equipment may serve as the base 30, including conventional equipment used for installing conventional heat exchangers. However, as mentioned above, certain embodiments of the present disclosure may use equipment that is substantially lower cost than the conventional equipment. In the figures, a mini skid steer is illustrated as the base 30. In other embodiments, a compact pile driver or other mobile equipment may serve as the base 30. In still other embodiments, the base 30 may be non-mobile, may attach to a building and/or a structure, etc. Certain embodiments of the present disclosure may use equipment for the base 30 that is substantially lighter in weight and/or less damaging to an installation area than the conventional equipment. Certain embodiments of the present disclosure may use equipment for the base 30 that requires a substantially smaller staging area and/or lower headroom than the conventional equipment.

The preinstallation systems 10 and/or the installation systems 20 may include a mount 50 that attaches the base 30 (and the corresponding building, structure, related equipment, etc.) to the driver 40. The driver 40 may directly or indirectly drive the penetrator 200 into the ground 90 and thereby prepare the ground and/or install the heat exchangers 100, or a portion thereof, into the ground 90. Driving components such as drill rod(s) 60, adapting drill rod(s) 60A and/or other adapter(s), drill string(s) 61, coupling(s), housing(s) 250, driver connector body(s) 270 (e.g., housing connector(s)), driving assembly(s) 300, and/or driving member(s) 310 (and related fasteners, etc.) may directly or indirectly connect the driver 40 to the penetrator 200.

A supply system(s) 500 of the preinstallation systems 10 and/or the installation systems 20 may receive and distribute power supplies, utility supplies, fluid supplies (including combining and/or mixing fluid supplies), etc. The supply system(s) 500 may include a supply dispenser(s) 80. The supply dispenser(s) 80 may include a pump, valve(s), pressure source(s), etc.

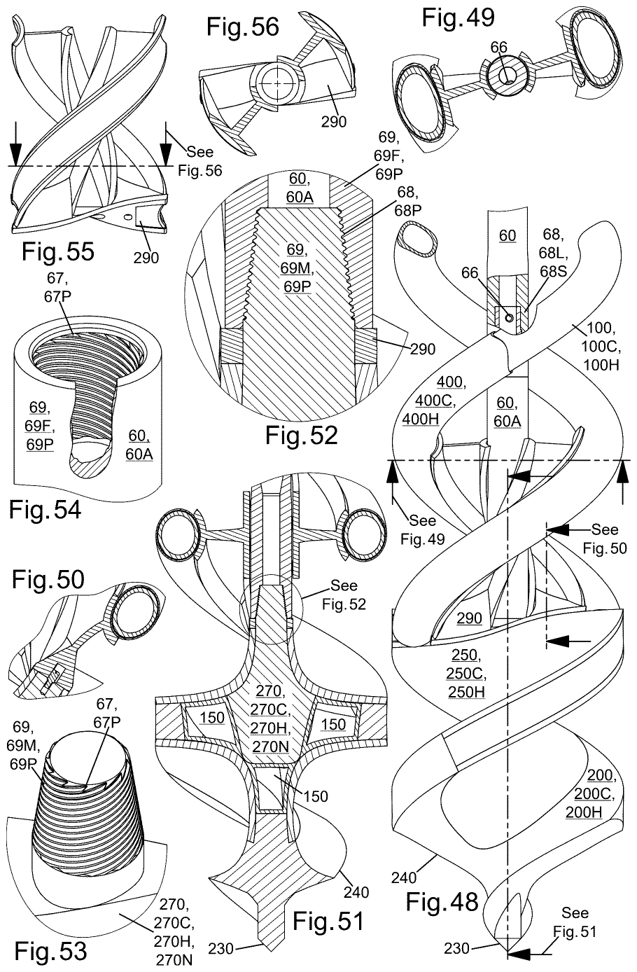

In certain embodiments, fluid 96 is injected into the penetrator 200 (e.g., via the driving components) to facilitate preparing the ground 90 (e.g., with the penetrator 200P) and/or installing the heat exchanger 100 in the ground 90 using the penetrator 200. A rotary union 70, 70L (i.e., a rotary injection adapter 72) may be used, at least in part, to transfer the fluid 96 to the penetrator 200 via a rotary union fluid passage 510U, especially where the penetrator 200 rotates relative to the mount 50 (either for rotational driving purposes and/or for orientation and/or reorientation purposes). A load-carrying rotary union 70L may be used, at least in part, to transmit forces, torques, moments, movements, vibrations, etc. from the driver 40 to the penetrator 200, and thus a load carrying component of the load-carrying rotary union 70L may be a component of the driving components. As illustrated at FIG. 14, the load-carrying rotary union 70L is connected to a second (proximal) end 64 of a proximal one of the drill rods 60 of the drill string 61 (i.e., a second (proximal) end 65 of the drill string 61). As further illustrated at FIGS. 48, 51, & 81, a first (distal) end 62 of a distal one of the drill rods 60, 60A of the drill string 61 (i.e., a first (distal) end 63 of the drill string 61) is connected to the penetrator 200.

The fluid(s) 96 may include air, water, cutting fluid, lubricant, thermal conduction enhancers, sodium polyacrylate, sodium polyacrylate solution, waterlock, superabsorbent polymer, fiber-based absorbents, absorbents, backfill, tailings, grout 96G, etc. and thereby facilitate preparing the ground 90 and/or installing the heat exchanger 100 into the ground 90. The fluid(s) 96 may be individually injected and at different times. The fluid(s) 96 may be mixed together in various mixtures and injected. The various mixtures may be injected at different times. The fluid(s) 96 may be (or become) mixed together with the ground 90 (e.g., by the penetrator 200).

Various fluid passage(s) 510 may be interconnected and transfer the fluid(s) 96 from the supply system(s) 500 to and/or through the driving components, sheathing 400 around tubing 110 of the heat exchangers 100, and/or the penetrator 200. The fluid passage(s) 510 may include the rotary union fluid passage 510U, a drill rod fluid passage 510D through the drill rod(s) 60, 60A, a driving member fluid passage 510D through and/or partially through the driving member(s) 310, a driving assembly fluid passage 510D through the driving assembly(s) 300, a fluid supply system fluid passage 510S through tubing, valve(s), port(s), hose(s), tank(s), etc. of the supply system(s) 500, penetrator fluid passage(s) 510P through the penetrator 200, tube jacket fluid passage(s) 510J through the sheathing(s) 400, housing fluid passage(s) 510H through the housing 250, and/or abutting interface fluid passage 510A between ends of the drill rod(s) 60, 60A and/or between ends of the driving member(s) 310.

When air or other gas is used as the fluid 96 and injected though one or more of the fluid passages 510, the ground 90 may be loosened, decompacted, aerated, fluidized, etc. and thereby aid in the installation of the heat exchanger 100 in the ground 90 and/or in injection of other fluids 96 (e.g., sodium polyacrylate solution, grout 96G, thermal conduction enhancers, etc.) into the ground 90. The gas (e.g., air) may be injected at high pressure, an air tank(s) may be used to accumulate the pressurized gas, and the gas may be blasted into the ground 90. A loosening, decompacting, and/or aerating effect may be obtained by an EarthBuster product(s) and method(s) shown at https://www.earthbuster.com/ of K&P Enterprises, LLC dba EarthBuster of Laurel, MT 59044. U.S. Pat. No. 6,939,085 B1, incorporated herein by reference, appears to further illustrate the EarthBuster product. The EarthBuster product's feature(s) and method(s) do not necessarily produce a desired and/or compatible effect with respect to some or all of the embodiments of the present disclosure. Some of the EarthBuster product's feature(s) and method(s) may be related to the present disclosure, while others may not be.

When air, water, and/or other fluid is used as the fluid 96 and injected though one or more of the fluid passages 510, the ground 90 may be eroded (e.g., slightly eroded), entrained, and/or lubricated by the fluid 96 and thereby aid in the installation of the heat exchanger 100 in the ground 90. As used herein, the term “jetting” typically generically refers to forcing fluid around and/or under the penetrator 200 (and/or one or more of the driving components) to loosen and/or displace the surrounding ground 90.

When air, water, and/or other fluid is used as the fluid 96 and injected though one or more of the fluid passages 510, the fluid 96 may act to urge the driving components (e.g., drill rod(s) 60, adapting drill rod(s) 60A and/or other adapter(s), drill string(s) 61, coupling(s), housing(s) 250, driving assembly(s) 300, driving member(s) 310, related fasteners, etc.) from the ground 90. The action may be piston-like and operate by generating an unbalanced pressure at a distal end of one or more of the driving components and/or may act by fluid flowing past one or more of the driving components as the fluid exits the ground 90 and thereby urge (e.g., by fluid friction) the driving components out of the ground. The action of the fluid 96 alone may or may not be sufficient to remove the driving components from the ground 90, and the driver 40 and/or movement of the base 30 may provide at least a portion of the removing action. The fluid 96 flowing past the driving components may substantially lubricate (i.e., reduce friction) the driving components with respect to the ground 90 and thereby assist or further assist the removing action. The driver 40 and/or movement of the base 30 may regulate the removing action (e.g., prevent uncontrolled ejection of the driving components from the ground 90).

The sheathing(s) 400 may be made of permeable or semi-permeable material (e.g., fabric) and thereby facilitate the fluid 96 passing through the sheathing(s) 400. The fluid 96 may thereby lubricate, entrain, erode (e.g., slightly erode) the ground 90 adjacent the sheathing(s) 400 and/or otherwise facilitate the installation of the heat exchanger 100 in the ground 90 and may further facilitate the removal of the sheathing(s) 400 from the ground 90 (while leaving the heat exchanger 100 substantially in the ground 90). The sheathing(s) 400 may selectively allow some fluid(s) 96 to pass through at different (e.g., lower) rates (including no passage) and thereby direct the fluid 96 (e.g., grout 96G) out of a distal end of the sheathing(s) 400 while allowing other fluids 96 (e.g., lubricant, air, etc.) to pass through at different (e.g., higher) rates and thereby more readily pass through the permeable or semi-permeable material.

The sheathing(s) 400 may be prepositioned around the tubing 110 of the heat exchangers 100 (e.g., at a factory). The sheathing(s) 400 and the tubing 110 may be wrapped around one or more spools (e.g., at the factory). The sheathing(s) 400 are optional, and the tubing 110 of the heat exchangers 100 may be used without the sheathing(s) 400. The tubing 110 may be similarly wrapped around the spool with or without the sheathing(s) 400 applied.

The spool(s) and/or related features may constrain the tubing 110 (and the sheathing(s) 400, if applied). For example, clamp(s) may constrain the tubing 110 at one or more locations (see FIGS. 10E, 10F, 11A, & 11D), and motor(s) (and/or other rotary actuators, brakes, etc.) may control rotation of the spools and thereby constrain the tubing 110. Constraining the tubing 110 (and optionally the sheathing(s) 400) may be desired, for example, if the tubing 110 (and/or the sheathing(s) 400) is/are pressurized. The tubing 110 and the sheathing(s) 400 may be independently pressurized. As illustrated in the figures, the sheathing(s) 400 are pressurized via rotary unions and may further be supplied with fluid 96 via the rotary unions. The tubing 110 may be pressurized at the factory and/or by a conventional air chuck, as shown at FIGS. 11A & 11E-11G. Alternatively, the rotary unions may be multi-channel (e.g., dual channel) rotary unions and thereby independently pressurize the tubing 110 and the sheathing(s) 400, and the pressurization(s) may be varied, as desired. Fluid may further be passed through the tubing 110 via such rotary unions (e.g., with warm or hot water to control material properties and/or temperature of the tubing 110). By pressurizing the tubing 110, the sheathing(s) 400 may be pressurized at a high pressure without the tubing 110 collapsing (e.g., imploding).

Other constraints may guide and/or otherwise control the tubing 110 and the sheathing(s) 400 (if present), as shown at FIGS. 17, 20, 30, 31, 32A, 36, 48-51, 55, & 56. These include guides (e.g., roller guides, guide spools, spools, etc.), a rotational orientation of the penetrator 200, a depth of the penetrator 200, a vise die 56 for maintaining rotational and depth control of the penetrator 200 when disconnected from the driver 40 (e.g., when adding/removing drill rods 60, transporting the system 10, 20, etc.), a guide (e.g., a helical guide), spacers (e.g., a helical spacer) positioned with the tubing 110 and/or the sheathing(s) 400 and/or the penetrator 200, external heaters and/or coolers, and the ground 90 (including pre-applied features 98, such as bores 98B, threads 98T, and/or cuts 98C, in the ground 90). The various controls, constraints, etc. may be coordinated with each other by a control system.

By pressurizing the tubing 110 and/or the sheathing(s) 400 a shape (e.g., a helical shape) of the tubing 110 and/or the sheathing(s) 400 may be maintained in the presence of loading (e.g., by installation torque, loads imposed by the ground 90, etc.), the tubing 110 and/or the sheathing(s) 400 may be stiffened, damage resistance of the tubing 110 and/or the sheathing(s) 400 may be increased, and/or damage detection (e.g., if a leak is present, the pressure and/or fluid flow would indicate such) of the tubing 110 and/or the sheathing(s) 400 may be provided.

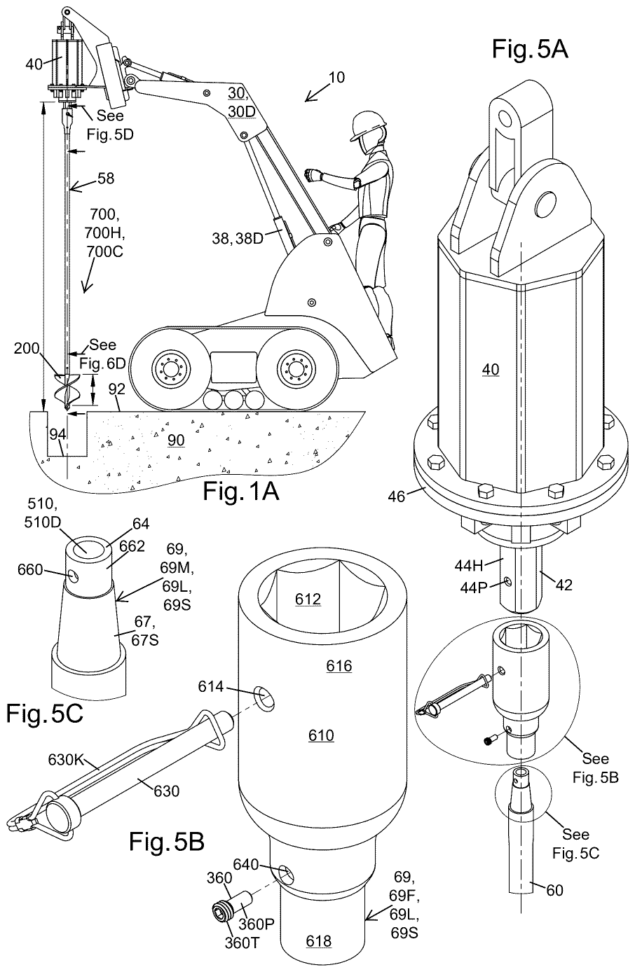

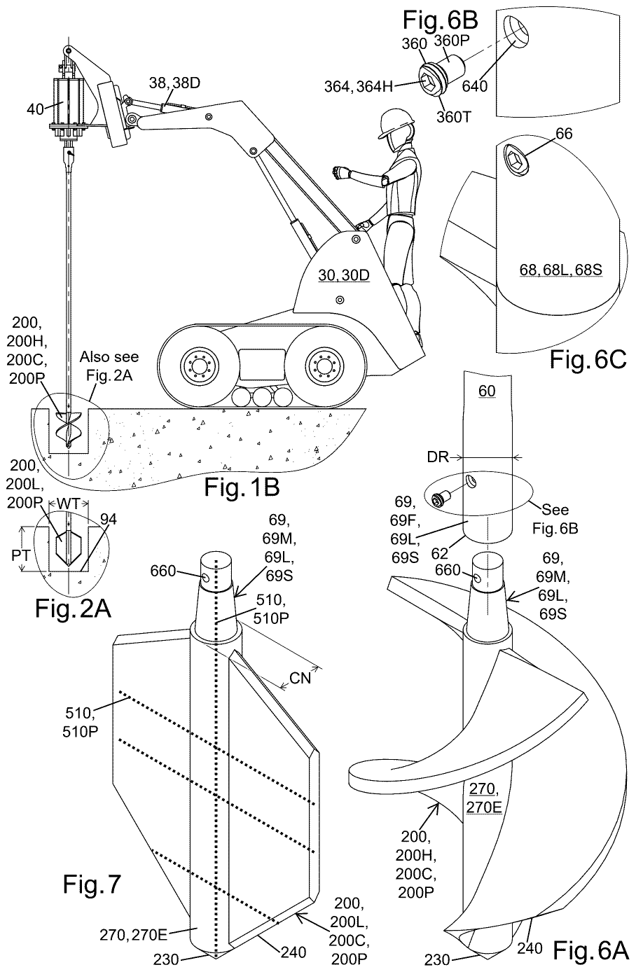

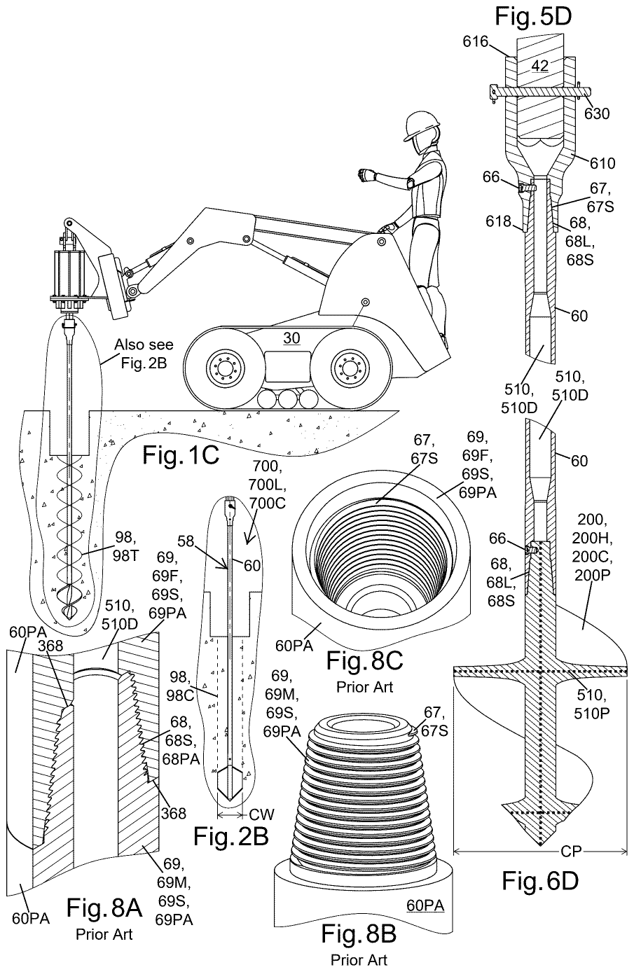

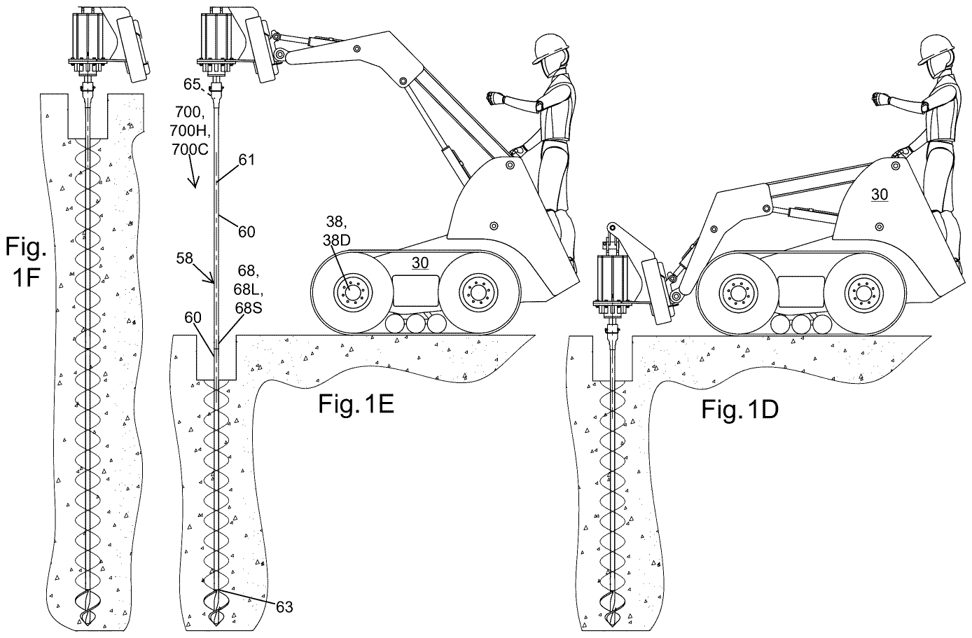

An example preinstallation system 10 is depicted at FIGS. 1A-4B where the base equipment 30, illustrated as a mini skid steer, is equipped with a driver 40. The driver 40 is connected to an elongate load-transferring assembly 58, which in turn couples to a penetrator 200. A position of the penetrator 200 is determined, at least in part, by the configuration of the base equipment 30 and is illustrated varying between FIGS. 1A-4B. Various actuators of the base equipment 30, including a wheel drive system may be used for this and may be coordinated by, for example, a computerized control system. In this way, the installation site may be prepared. The same or similar system 10 may be used in whole or in part for or with example installation systems 20, described herein.

The installation site is shown with a trench 94 cut into the ground 90. The trench 94 is located below a surface 92 of the ground 90. One or more drill rods 60 form at least a portion of the elongate load-transferring assembly 58 in the illustrated example. Drill rods 60 may be added, as desired, to position the penetrator 200 deeper into the ground 90 (see FIGS. 1D-1F). An example drill string 61 includes one or more drill rods 60. A proximal end 65, a distal end 63, and coupling joints 68 of the drill string 61 are illustrated at FIG. 1E. The coupling joints 68 may include locking coupling joint(s) 68L and typically are single-start coupling joint(s) 68S. The penetrator 200 may be configured as a helical penetrator 200H or a linear penetrator 200L.

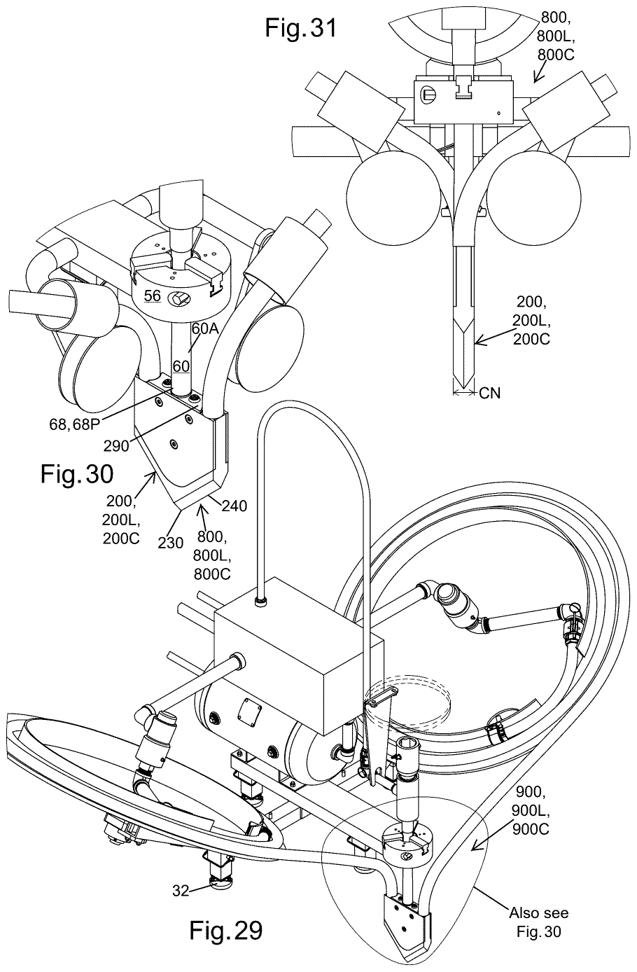

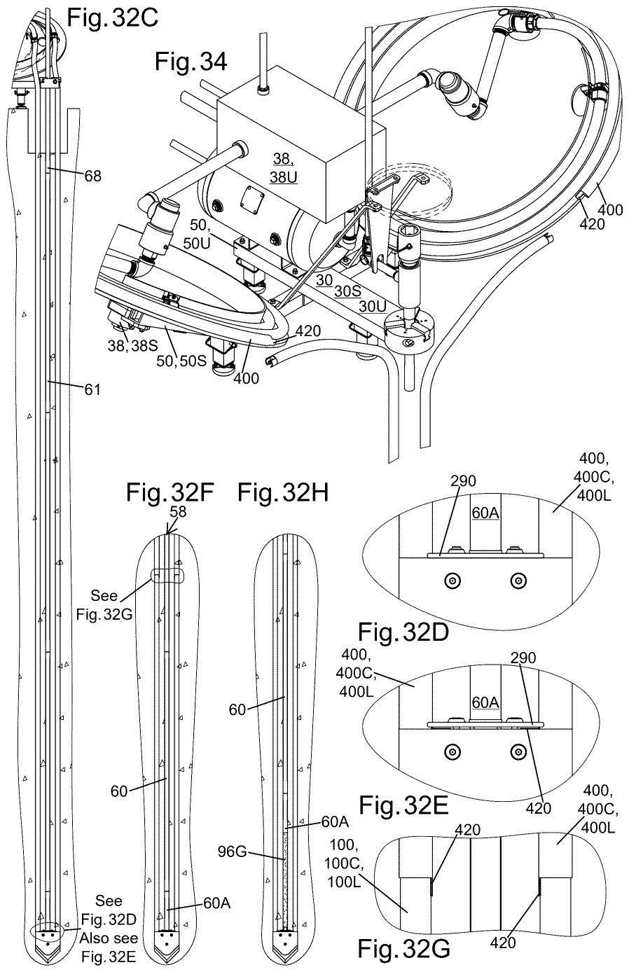

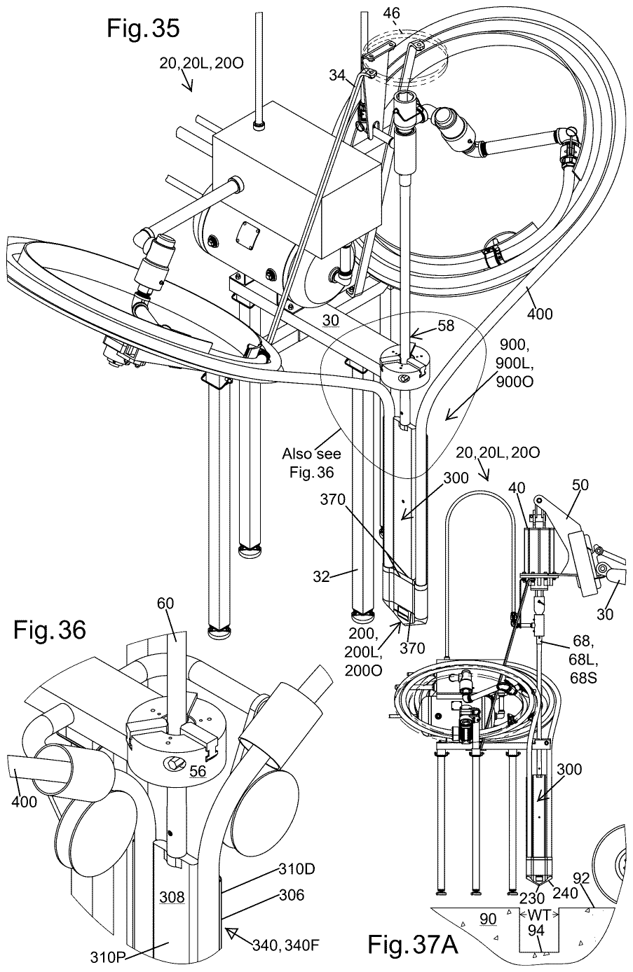

In the depicted embodiments of FIGS. 1A-7, center-driven (e.g., drill rod-driven) preinstallation systems 10 connect the driver 40 and a penetrator 200, 200C, 200P via a drill string 61. The depicted embodiment of FIGS. 1B & 1C is also a helical preinstallation system 10 with a helical penetrator 200, 200H. The depicted embodiment of FIGS. 2A & 2B is also a linear preinstallation system 10 with a linear penetrator 200, 200L. In the depicted embodiment of FIGS. 10A-28, a center-driven (e.g., a drill rod-driven) installation system 20, 20C connects the driver 40 and the penetrator 200, 200C, 200H via a drill string 61. The depicted embodiment of FIGS. 10A-28 is also a helical installation system 20, 20H. The depicted embodiment of FIGS. 29-34 illustrates a center-driven (e.g., a drill rod-driven) installation system 20, 20C that connects the driver 40 and the penetrator 200, 200C, 200L via a drill string 61. The depicted embodiment of FIGS. 29-34 is also a linear installation system 20, 20L. The depicted embodiment of FIGS. 35-47 illustrates an overlapping joint-driven (e.g., a driving member driven) installation system 20, 20O that connects the driver 40 and the penetrator 200, 200O, 200L via a driving assembly 300. The depicted embodiment of FIGS. 35-47 is also a linear installation system 20, 20L.

According to the principles of the present disclosure, other variations of preinstallation systems 10 and/or installation systems 20 are possible. For example, a helical (e.g., double helicoid) overlapping joint-driven variation is not shown at the figures but may be derived/constructed by one of skill in the art, in view of the teachings of the present disclosure, by axially twisting a blade 240 of the penetrator 200L, a retainer/releaser 290 (e.g., a sheath-retainer/releaser), a housing 250L, a driver connector body 270L (e.g., a housing connector), a heat exchanger 100L, and the driving assembly 300 of the overlapping joint-driven installation system 20O of FIGS. 39, 86, 93, & 99 in a similar transformation as axially twisting a blade 240 of the penetrator 200L, a housing 250L, a driver connector body 270L, and a heat exchanger 100L of FIGS. 81 & 82 into the penetrator 200H, a housing 250H, a driver connector body 270H (e.g., a housing connector), and a heat exchanger 100H of FIGS. 59 & 60.

For another example, preinstallation overlapping joint-driven variations are not shown at the figures but may be derived/constructed by one of skill in the art, in view of the teachings of the present disclosure, by applying the disclosures of the penetrators 200, 200H, 200L, 200C, 200O, 200P, the driving members 310, the driving assemblies 300, the overlapping joint-driven installation systems 20O, and the preinstallation systems 10 to variations of the preinstallation systems 10 where penetrators 200P and driving members 310 are adapted to connect to each other. Features that interface with the heat exchangers 100 may be discarded, and/or the penetrator 200P may be configured to be removed from the ground by the driving assembly 300 upon completion of the preparation and/or the checking (e.g., for insurmountable obstacles along a test installation path) of the ground 90.

According to the principles of the present disclosure, the driver 40 is connected to the penetrator 200 via an elongate load-transferring device 58 (e.g., depicted as an elongate load-transferring assembly, an elongate load-transferring apparatus, a drill rod 60, a drill string 61, a driving member 310, a driving assembly 300, etc.). In the depicted embodiments, an output 42 (e.g., an output shaft) of the driver 40 includes connecting features 44H, 44P, and an adapter 610, 610U (i.e., a second adapter) connects a proximal end of the elongate assembly 58 to the output 42 of the driver 40. In other embodiments, the proximal end of the elongate assembly 58 may be directly connected to the driver 40 (e.g., at the output 42). In still other embodiments, the proximal end of the elongate assembly 58 may be at least partially included with the driver 40 (e.g., with the output 42). In the depicted embodiments, the connecting feature 44H is a male hexagon (i.e., a hex), and the connecting feature 44P is a hole (e.g., a cross-pin hole).

A proximal end portion 616 of the depicted adapters 610, 610U includes a female hexagon 612 (i.e., a hex) and a hole 614 (e.g., a cross-pin hole), and a cross-pin 630 secures the adapters 610, 610U and the driver 40 to each other. The cross-pin 630 may include an attached tool-less keeper 630K. When assembled, the male hex 44H and the female hex 612 engage and thereby may transfer loads (e.g., rotational loads, lateral loads, bending loads), and the cross-pin 630 engages each of the cross-pin holes 44P, 614 and thereby may transfer loads (e.g., axial loads). The depicted embodiments may be especially adapted for transferring loads where steady rotational loads dominate. In the depicted embodiment and in embodiments where other loads dominate, other connecting features, including those that are known in the art, may be used.

In the depicted embodiment of FIGS. 1A-5B, the adapter 610 does not include fluid passages, however fluid passages 510 could be added along with the rotary union 70, 70L, as suggested at FIGS. 6D & 7. In the other depicted embodiments (e.g., of FIGS. 10D & 14), the adapter 610, 610U includes the fluid passage(s) 510, 510U and is incorporated into the rotary union 70, 70L and is further a load carrying component of the rotary union 70L. In other heat exchanger 100 installing embodiments, the fluid passage(s) 510, 510U and/or the rotary union 70, 70L may not necessarily be included.

In the depicted embodiments, a distal end portion 618 of the adapter 610, 610U connects to the proximal end of the elongate assembly 58. As depicted, the distal end portion 618 of the adapter 610, 610U includes a female coupling-half 69, 69F, 69L, 69S. The female coupling-half 69, 69F, 69L, 69S includes female tapered thread(s) 67 (see FIGS. 5D & 14), a first shoulder, a second shoulder, an end face, and/or a locking feature 640 (see FIG. 5B). The female tapered thread(s) 67 may be similar to or the same as those used in prior art coupling halves 69PA (i.e., coupling ends) of prior art drill rods 60PA (see FIGS. 8A & 8C). In other embodiments, the distal end portion 618 of the adapter 610, 610U may include a male coupling-half 69, 69M, 69L, 69S, and the male coupling-half 69, 69M, 69L, 69S (similar to or the same as shown at FIG. 5C) may include male tapered thread(s) 67, a first shoulder, a second shoulder, an end face, and/or a locking feature 660. The male tapered thread(s) 67 may be similar to or the same as those used in the prior art coupling halves 69PA (i.e., coupling ends) of the prior art drill rods 60PA (see FIGS. 8A & 8B).

As illustrated at the depicted embodiments, the proximal end of the elongate assembly 58 may include a male coupling-half 69, 69M, 69L, 69S similar to or the same as described above (see FIG. 5C). In other embodiments, the proximal end of the elongate assembly 58 may include a female coupling-half 69, 69F, 69L, 69S similar to or the same as those described above.

As depicted in certain embodiments, the threads 67 of the coupling-halves 69, 69F, 69M, 69L, 69S are single-start threads 67S. In other embodiments, the threads 67 of the coupling-halves 69, 69F, 69M, 69L, 69P are multi-start threads 67P. When the threads 67 of the male coupling-half 69, 69M, 69L are engaged with the threads 67 of the female coupling-half 69, 69F, 69L, a coupling joint 68 is formed. The formed coupling joint 68 may transfer loads (e.g., rotational loads, lateral loads, bending loads, axial loads, etc.) between the components connected thereby. As depicted, the threads 67 are right-hand threads, and the helical penetrators 200H are also right-handed. Thus, in typical use as a right-hand torque is applied by the driver 40, the right-hand threads 67 are tightened and the right-hand helical penetrator 200H is driven into the ground 90. In other embodiments, one or both of a pair of the threads 67 and the helical penetrators 200H may be left-handed.

In certain operations, a loosening torque (e.g., a left-hand torque on the right-hand threads) may be applied across the coupling joint 68. For example, the helical penetrator 200H, 200P may be unscrewed from the ground 90 and thereby removed from the ground 90. Use of prior art coupling joints 68PA (see FIG. 8A) may employ high-torque tightening (e.g., using hydraulic vises or other vices 56 and high-torque from the driver 40, using breakout tongs, etc.) to tighten the prior art coupling joints 68PA with a higher torque than is likely to be applied (in one or both directions) across the joint 68PA during other operations. Such high-torque tightening may be used with certain embodiments of the present disclosure and thereby keep the prior art coupling joint 68PA from being loosened when subjected to applied torques in the loosening direction. When it is desired to disconnect the prior art coupling joint 68PA, the hydraulic vises or the other vises 56 and high-torque from the driver 40, using breakout tongs, etc. may be used to overcome the high-torque tightening and thereby decouple the prior art coupling joint 68PA.

According to the principles of the present disclosure, the coupling joint 68 may be a locking coupling joint 68L. The locking coupling joint 68L may include locking features that may be selectively engaged and disengaged to lock and unlock the locking coupling joint 68L. In the example embodiments, a female locking coupling-half 69, 69F, 69L, 69S includes the locking feature 640 (see FIGS. 5B & 6B), and a male locking coupling-half 69, 69M, 69L, 69S includes the locking feature 660. In the depicted embodiments, the locking features 640, 660 and a locking member 360 are included in a set of locking features 66 (i.e., thread locking features) that keeps the male-female pair of threads 67 from rotating relative to each other when the set of locking features 66 is engaged and thereby locks the locking coupling joint 68L and thereby keeps the locked joint 68L from being decoupled (even under a loosening torque). In the depicted embodiments, a single set of the locking features 66 is used per locking coupling joint 68L. In other embodiments, multiple sets of the locking features 66 may be used per locking joint 68L. In other embodiments, other locking features and/or other combinations of locking features may be used. The set of locking features 66 may allow loosening torques to be applied across the locked locking coupling joint 68L without decoupling the joint 68L and thereby avoid needing the above-described high-torque tightening (and any related equipment and issues).

In the depicted embodiments (see FIGS. 5B, 5D, 6B, & 6D), the locking member 360 includes an alignment taper, a pin portion 360P, a threaded portion 360T, a tapered seat between the pin portion 360P and the threaded portion 360T, and a tool interface (e.g., a hex-socket). The locking feature 640 includes a pin hole portion, a threaded portion, and a tapered seat between the pin hole portion and the threaded portion. The locking feature 660 includes at least a pin hole portion. By inserting the pin portion 360P into the pin hole portions of the locking features 640 and 660 (see FIGS. 6B & 6C) of the otherwise assembled locking coupling joint 68L and then tightening the threaded portion 360T in the threaded portion of the locking feature 640 and thereby seating the tapered seats, the locking coupling joint 68L is locked. To unlock the locking coupling joint 68L, the locking member 360 can be removed.

As mentioned above, the depicted embodiments of FIGS. 1A-7, FIGS. 10A-28, and FIGS. 29-34 are center-driven. These center-driven embodiments are depicted with drill rod(s) 60 (that may be combined into a drill string 61) serving as the elongate load-transferring device/assembly 58. As illustrated at FIGS. 5C & 6A, the first end 62 (i.e., the distal end) of the drill rod 60, and thereby the first end 63 (i.e., the distal end) of the drill string 61, includes the female coupling-half 69, 69F, 69L, 69S, and the second end 64 (i.e., the proximal end) of the drill rod 60, and thereby the second end 65 (i.e., the proximal end) of the drill string 61, includes the male coupling-half 69, 69M, 69L, 69S. In certain embodiments, the locking coupling-halves 69L, depicted at the figures, may be replaced with coupling-halves 69 that are not necessarily locking. In certain embodiments, the coupling-halves 69S with single-start threads 67S, depicted at the figures, may be replaced with coupling-halves 69P with multi-start threads 67P or with another coupling method. The female coupling-halves 69F and the male coupling-halves 69M may readily be combined (i.e., coupled) to form a coupling joint 68 and thereby join a pair of drill rods 60 (and thereby may start or extend a drill string 61), join a drill rod 60 (and thereby may join a drill string 61) to a penetrator 200 (see FIG. 6A), join a drill rod 60 (and thereby may join a drill string 61) to an adaptor 610 (see FIG. 5A), and/or join a drill rod 60 (and thereby may join a drill string 61) to a driver 40.

The vise 56 may clamp the drill rod 60, as shown at FIG. 11B, and the driver 40 may either tighten or loosen the male-female pair of threads 67 of the coupling joint 68 (e.g., between the vise 56 and the driver 40) and thereby correspondingly facilitate either making or breaking the coupling joint 68 (in addition to keeping positional control of the clamped drill rod 60/drill string 61 (or portion thereof) especially while disconnected from the driver 40). The vise 56 may clamp the drill rod 60, as shown at FIGS. 10A, 10B, 11A, 11B, 27, 28, & 34-37A during transportation of the installation systems 20 and/or the preinstallation systems 10. The vise 56 may release the drill rod 60, as shown at FIG. 16 (e.g., when the penetrator 200 is being driven).

A drill rod magazine (not shown) may automate or semi-automate a process of adding and/or removing the drill rod(s) 60 to and/or from the drill string 61 and/or to and/or from the preinstallation systems 10 and/or the installation systems 20. The drill rod magazine or other apparatus (not shown) may automate or semi-automate a process of locking and/or unlocking the coupling joint(s) 68L.

In certain embodiments, the penetrator 200, or portions thereof, remains in the ground 90 after the installation of the heat exchangers 100, and the housing 250 and the driver connector body 270 (e.g., the housing connector) are removed with the elongate load-transferring device/assembly 58. In certain depicted embodiments (see FIGS. 10P & 32H), the penetrator 200 (including the housing 250 and the driver connector body 270) remain in the ground 90 after the installation of the heat exchangers 100 and/or after the elongate load-transferring device/assembly 58 is removed from the ground 90. To accommodate embodiments where a coupling-half 69, 69M, 69F remains in the ground 90 (e.g., with the driver connector body 270), a decoupling method and/or a coupling joint 68 that does not require direct access to the corresponding coupling joint 68 (e.g., for unlocking purposes) and/or does not require high loosening torques be applied (e.g., that may urge unscrewing of the penetrator 200H from the ground 90 and/or may apply undesired loads on the heat exchanger 100) may be used. For example, a remotely unlockable coupling joint 68, 68L (not shown) may be used. In certain depicted embodiments, a coupling joint 68, 68P with multi-start threads may be used (see FIGS. 51-54). The multi-start threaded coupling joint 68, 68P may include coupling halves 69, 69M, 69F, 69P with multi-start threads 67P with at least 2, 3, 4, 5, 6, 7, 8, 9, 10 or more thread-starts, may have high torque carrying capacity in the tightening direction, and/or low decoupling torque (even after exposure to a high tightening and/or installing torque). In certain center-driven linear installations (see FIGS. 29-34) that do not use an installing driving torque that is also a thread tightening torque, the coupling joint 68, 68S, 68P, 68PA may be coupled with a sufficiently low torque and thereby avoid undesirably high decoupling torques.

To accommodate connecting coupling halves 69, 69M, 69F, 69P with multi-start threads 67P to a drill rod 60 and/or a drill string 61 with single-start threads 67S, an adapting drill rod 60A may be used (see FIGS. 16, 48, & 52). The adapting drill rod 60A may include a coupling-half 69, 69M, 69F, 69P with multi-start threads 67P on one end and a coupling-half 69, 69M, 69F, 69S with single-start threads 67S on an opposite end, and may thereby serve as an adaptor (i.e., a first adapter).

As mentioned above, the depicted embodiment of FIGS. 35-47 & 97-102 is driven via a driving assembly 300, that includes one or more overlapping joints 340, serving in an elongate load-transferring device/assembly 58. This overlapping joint-driven embodiment is depicted with a drill rod 60 (that may be extended, e.g., into a drill string 61) at a proximal end of the elongate assembly 58. Thus, connection to the driver 40, the adapter 610, 610U, the rotary union 70, 70L, etc. may be similar to or the same as describe above in the depicted embodiments of FIGS. 1A-7, FIGS. 10A-28, and FIGS. 29-34. In other embodiments, the connection of a proximal end of the elongate assembly 58 (e.g., the driving assembly 300) to a driver, an adapter, a rotary union, etc. may include overlapping joints 340 and/or be direct (e.g., without a drill rod 60). Provisions for supplying fluid to the penetrator 200 via the elongate assembly 58 (e.g., the driving assembly 300) may be included in the driver 40 or via other means.

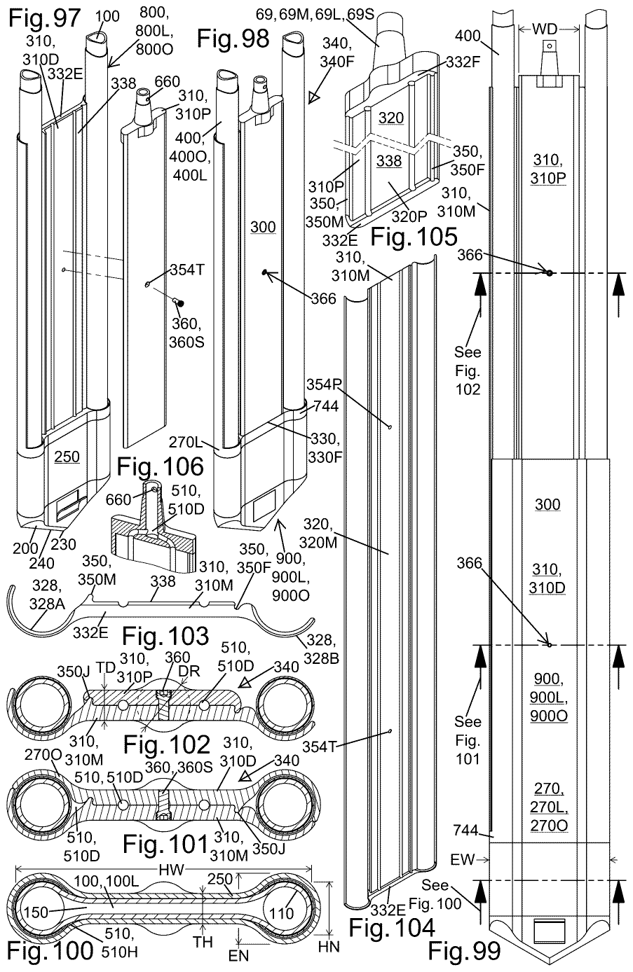

In the depicted embodiment, the driving assembly 300 is formed (and may be extended), at least in part, by assembling a plurality of driving members 310 together and thereby forming one or more lap joints 340 (i.e., overlapping joints) including at least portions of an interface 338 (see FIGS. 97, 103, & 105) of mating pairs of the driving members 310. Such driving members 310 may extend from a first end to a second end along an axial length, include at least a substantially rectangular cross-sectional portion (see FIGS. 99, 101, & 102) that extends a width WD (see FIG. 99) generally locally parallel with the interface 338 and generally perpendicular to the axial length. The mating pairs, when mated, may have a combined thickness TD (see FIGS. 37C & 102) generally perpendicular to the interface 338 and generally perpendicular to the axial length.

In the depicted embodiment, a shape of the interface 338, or portion(s) thereof, is generally planar. In the helical (e.g., double helicoid) overlapping joint-driven embodiment, mentioned above (but not shown), the interface shape may include a circular helicoid, a double helicoid, a helicoid, etc. or portion(s) thereof. In other embodiments, the interface may not necessarily be planar, generally planar, and/or helicoidal.

In the depicted embodiment, the mating pairs of the driving members 310 may connect with each other by interfacing feature(s) 350. The interfacing feature(s) 350 may be integrated with the interface 338. As illustrated at FIGS. 97, 103, & 105, the interfacing features 350 include a female interfacing feature 350F and a male interfacing feature 350M. As depicted, the female interfacing feature 350F (e.g., a groove) and the male interfacing feature 350M (e.g., a tongue) form a tongue and grove joint 350J when connected together (see FIGS. 101 & 102). As illustrated at FIGS. 38A-38I, the interfacing features 350, 350F, 350M may be assembled (i.e., connected, etc.) together and disassembled (i.e., disconnected, etc.) by laterally moving the driving members 310 toward and away from each other (see FIGS. 38C & 38D and FIGS. 38G & 38H) and also may be assembled together and disassembled by axially moving the driving members 310 toward and away from each other (see FIGS. 38A & 38B and FIGS. 38E & 38F). In other embodiments, the interfacing features 350, 350F, 350M may connect to each other via an interlocking joint 350J (e.g., an extruded jigsaw puzzle joint) and thereby may be assembled together and disassembled by axially moving the driving members 310 toward and away from each other, similar to the relative movements between FIGS. 38A & 38B and FIGS. 38E & 38F (and not by lateral movements). In other embodiments, other interfacing features 350 may be used. For example, the interfacing features 350 may connect to each other via a joint 350J and thereby may be assembled together and disassembled only by laterally moving the driving members 310 toward and away from each other, similar to the relative movements between FIGS. 38C & 38D and FIGS. 38G & 38H.

As illustrated at FIGS. 97-99, 101, & 102, the driving members 310 may be connected with each other via an attachment joint 366 (e.g., a joint lock, a joint, etc.). In the depicted embodiment, the attachment joint 366 includes: a) a connector 360, 360S (e.g., a fastener, a locking member, an interconnecting member, a camlock fastener, an axial camlock fastener, a radial camlock fastener, a tangential camlock fastener, a pin, a threaded pin, a shoulder bolt, a headless shoulder bolt, etc.) similar to or the same as the locking member 360, 360S, described above; b) a first connector interface 354T; and c) a second connector interface 354P. The example connector 360, 360S includes an alignment taper, a pin portion 360P, a threaded portion 360T, a tapered seat between the pin portion 360P and the threaded portion 360T, and a tool interface (e.g., a hex-socket). The first connector interface 354T is similar to the locking feature 640, described above, and includes a pin hole portion, a threaded portion, and a tapered seat between the pin hole portion and the threaded portion. The second connector interface 354P is similar to the locking feature 660, described above, and includes at least a pin hole portion.

To activate (i.e., create) the attachment joint 366, the pin portion 360P is inserted into the pin hole portions of the first connector interface 354T and the corresponding second connector interface 354P of an otherwise assembled mating pair of the driving members 310, and then the threaded portion 360T is tightened in the threaded portion of the first connector interface 354T, and thereby the tapered seats are seated and the mating pair of the driving members 310 are attached to each other. To detach the mating pair of the driving members 310 from each other, the connector 360, 360S can be removed (and reused), and the mating pair of the driving members 310 can be separated from each other.

As illustrated at FIGS. 97, 99, & 101, the connector 360 may be a releasing connector 360S (e.g., a shearable connector) and release (e.g., shear) at a predetermined load (see FIGS. 37D-37F). As depicted, upon exposure to the predetermined load, the releasing connector 360S is sheared into a first sheared portion 360A and a second sheared portion 360B and thereby releases the attachment joint 366 and thereby may release the mating pair of the driving members 310 from each other (e.g., at least in the axial direction). The releasing connector 360S allows the mating pair of the driving members 310 to be released from each other while in the ground 90 (and not readily accessible by connector removing tools). The ground 90 and/or the interfacing features 350 may constrain the driving members 310 to move predominantly in the axial direction. To facilitate the shearing and/or releasing, the releasing connector 360S may a) be made of a plastic material or other suitable material; b) include a notch, a shear point, and/or a fracture point to facilitate the shearing; and/or c) use other means known in the art of mechanically fused connectors/fasteners including remotely triggered or timed released.

In the depicted embodiment, a single attachment joint 366 is used between each of the mating pairs of the driving members 310. In other embodiments, multiple attachment joints 366 may be used (e.g., for increasing load transfer capacity between the mating pairs of the driving members 310). The attachment joint(s) 366 may work together with the interfacing features 350 and/or the interface 338 to a) orient, align, and/or retain the mating pairs of the driving members 310 with respect to each other; and/or b) transfer loads between the mating pairs of the driving members 310 and thereby through the driving assembly 300. The driving members 310 may be selectively hardened (e.g., induction hardened) around the area of the connector interfaces 354T, 354P and thereby reduce wear and tear and/or increase strength of the attachment joint 366.

In typical environments, the highest loads of the linear installation systems 20, 20L and/or preinstallation systems 10 may be axial loads generated by the driver 40 and transmitted to the penetrator 200, 200O, 200L, 200C, 200P via the elongate assembly 58 when penetrating the ground 90 (e.g., to install the heat exchanger 100, 100L and/or to drive the penetrator 200, 200P into the ground). These axial loads may be carried as axial compressive loads by the driving assembly 300 and may include vibration and/or impact loads. In certain environments and/or embodiments, axial loads, generated by the driver 40, may withdraw the elongate assembly 58 (and optionally other components) from the ground 90. These axial loads may be carried as axial tensile loads by the driving assembly 300 and a maximum axial tensile load may be considerably lower than a maximum axial compressive load. The attachment joint(s) 366 may carry both the axial tensile loads and the axial compressive loads of the driving assembly 300 across the mating pairs of the driving members 310. In the depicted embodiment, the connector 360 may carry these loads in shear.

As depicted, the driving assembly 300 is connected to the driver 40 via an adapter 610, 610U (with optional fluid passages 510, 510U and optionally incorporated into the rotary union 70, 70L) and a drill rod 60. In particular, the male hex 44H of the output shaft 42 of the driver 40 rotationally connects to the female hex 612 of the adapter 610, 610U, and the cross-pin 630 secures the cross-pin hole 44P of the output shaft 42 and the cross-pin holes 614 of the adapter 610, 610U together. A first coupling joint 68, 68L, 68S connects the drill rod 60 (or alternatively a drill string 61) to the driving assembly 300, and a second coupling joint 68, 68L, 68S connects the adapter 610, 610U to the drill rod 60 (or alternatively to a drill string 61). As depicted, a proximal driving member 310, 310P is at a proximal end of the driving assembly 300 and includes a coupling-half 69, 69M, 69L, 69S to complete the first coupling joint 68, 68L, 68S. In other embodiments, the proximal driving member 310, 310P may connect directly to the driver 40 or be included/integrated with the driver 40. (A rotary union may be integrated into the driver 40, and the driver 40 may thereby pass fluid to the driving assembly 300, directly or indirectly.) Loads, optionally including the axial loads, the axial compressive loads, and/or the axial tensile loads (each optionally including vibration and/or impact), may thereby be transmitted between the driver 40 and the driving assembly 300.

In certain environments and/or embodiments (e.g., with high maximum axial compressive loads), the axial compressive loads may be transferred via abutting joints 370 (i.e., compressive contact joints, bearing joints, etc.). Such abutting joints 370 may transfer the axial compressive loads between the driver 40 and component(s) adjacent thereto, the penetrator 200 and component(s) adjacent thereto, and/or any intermediate components between the driver 40 and the penetrator 200. For example, such abutting joints 370 may transfer the axial compressive loads between a) the output 42 of the driver 40 and an adapter (not shown), b) the output 42 and a rotary union (not shown), c) the output 42 and the driving assembly 300 (not shown), d) the adapter and the driving assembly 300 (not shown), e) the rotary union and the adapter 300 (not shown), f) the rotary union and the driving assembly 300 (not shown), g) various driving members 310 of the driving assembly 300 (described in detail below), h) the driving assembly 300 and the penetrator 200 (not shown), i) the driving assembly 300 and the housing 250 (described in detail below), and/or j) the housing 250 and the penetrator 200 (described in detail below). Thus, in certain embodiments, the coupling-half 69, 69M, 69L, 69S of the proximal end of the proximal driving member 310, 310P (and thereby the proximal end of the driving assembly 300) may be replaced by or supplemented by attachment component(s) (e.g., heavier attachment component(s)) that attach the driving assembly 300 directly or indirectly to the driver 40. The attachment component(s) may include abutting joint(s) 370.

As illustrated at the example embodiment of FIGS. 37C, 37G, 38A-38I, 40, & 97-99, the driving assembly 300 includes the distal driving member 310D with an elongated portion 320D of length LD and a proximal driving member 310P with an elongated portion 320P of length LP. To increase (i.e., extend) an overall length of the driving assembly 300, one or more medial driving members 310M with an elongated portion 320M of length LM may be added. In the depicted embodiment, the elongated portions 320, 320D, 320M, 320P each have the same or a similar extruded shape that is generally half of the thickness TD (see FIG. 37C). In other embodiments, elongated portions with dissimilar extruded shapes and/or thicknesses may be used. In the depicted embodiment, the overall length of the driving assembly 300 increases by LM/2 for each of the medial driving members 310M that are added (described in detail below). In the depicted embodiment, LD=LP=LM/2, and the length LM is consistent among the medial driving members 310M. In other embodiments, the lengths of the elongated portions 320, 320D, 320M, 320P may vary among driving members 310, 310M and/or between driving members 310, 310D, 310P.

For example, in the depicted embodiment (see FIG. 37J), the distal driving member 310D is left in the ground 90. Reducing the length LD of the elongated portion 320, 320D would reduce the amount of material that remains in the ground 90 and thereby may save material costs. If the length LD is reduced, other transitional features, components, and/or lengths could be introduced to compensate. In other embodiments, the distal driving member 310D is removed from the ground 90 and may be reused (along with the reuse of other driving members 310) and thereby removes the material cost incentive for reducing the length LD.

Turning now to FIGS. 35-37J, 38A-38I, 97, & 98, an example assembly and disassembly method including the driving assembly 300 will be described in detail in the context of installing the heat exchanger 100 into the ground 90. FIG. 97 illustrates the distal driving member 310, 310D, the housing 250, 250O, 250L, and the penetrator 200, 200O, 200L preassembled with the heat exchanger 100 (among other components) thereby forming an example linear (e.g., double linear, substantially linear, etc.) ground loop with penetrator assembly 800, 800L, 800O. The assembly 800 may be assembled at a factory, in the field, or other place. As depicted, a fluid return portion 150 of the heat exchanger 100 is substantially covered (and thereby protected) by the assembly 800. At FIG. 98, the proximal driving member 310, 310P has been added and secured with the connector 360, 360S, thereby forming an example linear (e.g., double linear, substantially linear) driving assembly with ground loop and penetrator 900, 900L, 900O. The assembly of the proximal driving member 310, 310P may occur at a factory, in the field, or other place.

FIGS. 35-37A illustrate the linear overlapping joint-driven installation system 20, 20L, 20O which includes the driving assembly with ground loop and penetrator 900, 900L, 900O. A vise 56 is clamped to the drill rod 60, and transport braces are installed thereby facilitating transportation of the installation system 20 by the base equipment 30 (e.g., a mini skid steer). The tubing 110 of the heat exchanger 100 extends from the fluid return portion 150 and is wrapped around a pair of motor-controlled spools (e.g., a first tube, a first tube leg, a first tube portion, etc. 110A is wrapped around a first spool and a second tube, a second tube leg, a second tube portion, etc. 110B is wrapped around a second spool). In other embodiments, the tubing 110 may be wrapped around a common spool or otherwise held and stored. The tubing 110 may be stored (e.g., on the pair of spools) at a factory, in the field, or other place. As depicted, the pair of spools are mounted on a stand.

Upon placing the stand on a surface 92 of the ground 90, the penetrator 200 (and thereby the heat exchanger 100 may be driven into the ground 90 by the driver 40 and/or the base equipment 30. As depicted, the proximal driving member 310, 310P does not fully protect the tubing 110, and thus the initial penetration of the ground 90 may be limited to keep the proximal driving member 310, 310P from penetrating (i.e., entering) the ground 90. (Entering the trench 94 with the proximal driving member 310, 310P may be possible, in certain embodiments.) As mentioned above, the medial driving members 310M may be added to extend the driving assembly 300.

Turning to FIGS. 38A-38I, an example method of adding the driving members 310M and thereby extending the driving assembly with ground loop and penetrator 900, 900L, 900O and thereby further installing the heat exchanger 100 into the ground 90 will be described in detail. At FIG. 38A, the driving assembly 300 has been driven into the ground 90, and the proximal driving member 310, 310P is near, but not in, the ground 90. To insert one of the medial driving members 310M: a) the connector 360, 360S is removed from the mating pair of the driving members 310 that includes the proximal driving member 310, 310P, b) the base equipment 30 moves (e.g., raises) the proximal driving member 310, 310P away (e.g., up) from its mated pair, as illustrated at FIG. 38B, c) the driver 40 (or other means) reverses an initial orientation 308 of the proximal driving member 310, 310P to an opposite orientation 306, as illustrated at FIG. 38C, (in other embodiments, the proximal driving member may be engageable from both sides, and orientation reversal may not be needed), d) the medial driving member 310M is provided at the orientation 308 (as illustrated at FIG. 38C) and mated to the proximal driving member 310, 310P (as illustrated at FIG. 38D), e) the connectors 360, 360S are installed to secure the newly added medial driving member 310M to the proximal driving member 310, 310P and the driving member 310 axially adjacent to the proximal driving member 310, 310P (the releasing connector 360S may be used to secure the distal driving member 310D in embodiments where the distal driving member 310D remains in the ground 90), f) the driving assembly 300 is driven into the ground 90 by the base equipment 30 and/or the driver 40, as illustrated at FIG. 38E, g) the connector 360 is removed from the mating pair of the driving members 310 that includes the proximal driving member 310, 310P, h) the base equipment 30 moves (e.g., raises) the proximal driving member 310, 310P away (e.g., up) from its mated pair, as illustrated at FIG. 38F, i) the driver 40 (or other means) reverses the orientation 306 of the proximal driving member 310, 310P to the opposite orientation 308, as illustrated at FIG. 38G, (in other embodiments, the proximal driving member may be engageable from both sides, and orientation reversal may not be needed), j) the medial driving member 310M is provided at the orientation 306 (as illustrated at FIG. 38G) and mated to the proximal driving member 310, 310P (as illustrated at FIG. 38H), k) the connectors 360 are installed to secure the newly added medial driving member 310M to the proximal driving member 310, 310P and the driving member 310 axially adjacent to the proximal driving member 310, 310P (as illustrated at FIG. 38H), l) the driving assembly 300 is driven into the ground 90 by the base equipment 30 and/or the driver 40, as illustrated at FIG. 38I, m) the above steps a-m are repeated, as desired. As mentioned above, fluid may be injected during installation (e.g., air may be injected to locally fluidize the ground 90).

The tubing 110 of the heat exchanger 100 may be protected from the ground 90 (e.g., during installation) by the sheathing 400 and/or by protective guards 328, 328A, 328B (i.e., shields) of the driving members 310. In the depicted embodiment, the proximal driving member 310P rotates between orientations 306 and 308 and is not inserted into the ground 90. Thus, the proximal driving member 310P does not include the protective guards 328, 328A, 328B (e.g. to avoid interfering with the tubing 110 while rotating). In other embodiments, the proximal driving member 310P may include the protective guards 328, 328A, 328B or equivalents.

Upon reaching a desired installation length, an anchor 210 may be deployed to keep the heat exchanger 100 substantially installed in the ground 90. As depicted, the anchor 210 is mounted to the penetrator 200, and the penetrator 200 is engaged to the heat exchanger 100. In other embodiments, the anchor 200 may be otherwise connected to the heat exchanger 100. As depicted, the anchor 210 may allow for some reverse axial movement to engaged/deploy anchoring means. In other embodiments, the anchor may be non-slipping or not depend on reverse axial motion to engage.

Removal of the driving assembly 300 (without the heat exchanger 100) may be substantially done by performing and repeating the above steps a-m in reverse. Differences between the removal and the installation of the driving assembly 300 include: a) the distal driving member 310, 310D, the housing 250, 250O, 250L, and/or the penetrator 200, 200O, 200L may be left in the ground 90, b) grout 96G and/or other fluid 96 may be injected into the ground 90 (e.g., via the driving assembly 300), and c) pressurized grout 96G and/or other pressurized fluid 96 may assist in expelling the driving assembly 300 from the ground 90.

Various fastening methods may be used to join the distal driving member 310, 310D, the housing 250, 250O, 250L, and/or the penetrator 200, 200O, 200L. In embodiments where the distal driving member 310, 310D, the housing 250, 250O, 250L, and the penetrator 200, 200O, 200L are all left in the ground 90, the fastening method may be permanent (e.g., welding, permanent bonding, integrated together, cast together as one piece, formed as a monolithic piece, etc.). In embodiments where the distal driving member 310, 310D and/or the housing 250, 250O, 250L, are removed from the ground 90, bonding with a predetermined releasing load, electrically released bonding, time released bonding, etc. may be used.

As depicted at FIGS. 91 & 94, the penetrator 200, 200O, 200L includes a piloting portion 220 and an abutting flange 332F. The piloting portion 220 may enter and pilot an interior of the housing 250, and the abutting flange 332F may abut an abutting end 332E of the housing 250. A similar piloting portion may be included at a distal end of the distal driving member 310, 310D, and an abutting flange 332F of the distal driving member 310, 310D may abut an opposite abutting end 332E of the housing 250.

The proximal driving member 310, 310P includes an abutting flange 332F at, adjacent, or near its proximal end. The abutting flange 332F of the driving member 310P abuts, contacts, etc. an abutting end 332E of the mating driving member 310, 310M, when the driving assembly 300 is functionally assembled with at least one medial driving members 310M (see FIG. 99). The distal driving member 310, 310D includes an abutting flange 332F at, adjacent, or near its distal end. The abutting flange 332F of the driving member 310D abuts, contacts, etc. an abutting end 332E of the mating driving member 310, 310M, when the driving assembly 300 is functionally assembled with at least one medial driving members 310M (see FIG. 99). The abutting flange 332F of the proximal driving member 310P abuts, contacts, etc. an abutting end 332E of the mating driving member 310, 310D, when the driving assembly 300 is functionally assembled without a medial driving member 310M (i.e., when the driving members 310P and 310D are assembled together, as shown at FIG. 98). The abutting flange 332F of the distal driving member 310D abuts, contacts, etc. an abutting end 332E of the mating driving member 310, 310P, when the driving assembly 300 is functionally assembled without a medial driving members 310M (i.e., when the driving members 310P and 310D are assembled together, as shown at FIG. 98). When multiple medial driving members 310M are functionally assembled into the driving assembly 300 (e.g., see FIG. 37B), adjacent abutting ends 332E of adjacent medial driving members 310M abut each other. The driving assembly 300 may transfer the axial compressive loads via the above-mentioned abutting interfaces. The above interfaces may be locally hardened to increase load capacity, increase load transmission, and/or decrease wear.

A driving member magazine (not shown) may automate or semi-automate a process of adding and/or removing the driving members 310 to and/or from the driving assembly 300 and/or to and/or from the preinstallation systems 10 and/or the installation systems 20. The driving member magazine or other apparatus (not shown) may automate or semi-automate a process of locking and/or unlocking the attachment joint(s) 366.

It may be desired to reduce a thickness TH of the housing 250 and thereby reduce an overall cross-section of the housing 250 and corresponding shape of the penetrator 200, 200O. To accommodate the reduced thickness TH of the housing 250, a thickness TR of the fluid return portion 150 may also be reduced. A flow area of a fluid passage of the fluid return portion 150 may be sufficiently sized by extending the axial length, as shown at FIG. 96.

The drill string 61 is made by assembling several drill rods 60 together. Such drill rods 60 extend from a first end 62 to a second end 64 along an axial length, have a substantially axisymmetric, cylindrical shape, are readily available, and have an established manufacturing base, which may be advantageous.

As mentioned above and/or illustrated at the figures, the drill string 61 and/or the driving assembly 300 may form at least part of the connection between the various drivers 40 and the various penetrators 200, and both the drill string 61 and/or the driving assembly (i.e., overlapping joint driving assembly) 300 may be used in various configurations of the preinstallation systems 10 and/or the installation systems 20. For example, the various preinstallation systems 10 and/or the various installation systems 20 may include the rotary union(s) 70, 70L and/or other methods/components to fluidly connect the supply system(s) 500 to the drill string 61 and/or the driving assembly 300 and thereby supply fluid to, e.g., the various penetrators 200. For another example, the systems 10 and/or 20 may be configured to use the drill string 61 and/or the driving assembly 300 to prepare to install or install a helical (e.g., double helical, substantially helical) geothermal heat exchanger 100, 100H and/or a linear (e.g., double linear, substantially linear) geothermal heat exchanger 100, 100L.

Configuring the systems 10 and/or 20 with a drill string 61, a driving assembly 300 or a combination of both may consider environmental factors (e.g., ground conditions, installation site constraints, regulatory constraints, etc.), equipment availability, equipment cost, equipment productivity, equipment efficiency, equipment logistics, heat exchanger lengths, heat exchanger tube size, etc. For example, where the ground 90 (i.e., soil) is cohesionless, sandy, etc., the drill string 61 may be preferred. For another example, where the ground 90 is clay, rocky, hard-packed, etc., the driving assembly 300 may be preferred. For yet another example, where the ground 90 has layers with different characteristics, a combination of both the drill string 61 and the driving assembly 300 may be used.

According to the principles of the present disclosure, a minimization of a transverse cross-sectional area(s) of the driving components that are driven into the ground 90 is desired. The transverse cross-sectional area×a driven length in the ground=a displaced volume of the ground 90 for each of the driving components. By minimizing the transverse cross-sectional area(s), the displaced volume is thereby also minimized. The displaced volume(s) may be accommodated by the ground 90 compacting (i.e., increasing in density adjacent the displaced volume), the ground 90 heaving (i.e., ground movement opposite a driving direction that at least partially accumulates at or beyond the surface 92 of the ground 90), and/or the ground 90 reflowing (i.e., ground movement opposite the driving direction that at least partially accumulates adjacent certain of the driving component(s) with a reduced cross-sectional area).

In applications/environments where compacting fully or near-fully accommodates the displaced volume(s), grout 96G (or other make-up material) may be applied to fill a void created when withdrawing any of the driving components (less a volume of the heat exchanger 100 and/or other components left in the ground 90). Thus, an amount of the grout 96G required may be reduced by minimizing the corresponding transverse cross-sectional area(s).

The drill string 61 has an outer diameter DR (see FIG. 6A) that may be significantly greater than the thickness TD of a pair of combined elongated portions 320 of driving members 310 of the driving assembly 300 (see FIG. 102). Thus, the additional cross-sectional area that must be driven into the ground 90 may be a disadvantage for drill string 61 driven embodiments. In addition, the drill rods 60 typically have a substantial hollow area (e.g., the drill rod fluid passage 510D) that reduces the cross-section of the driving material. The driving assembly 300, and corresponding penetrator 200O may have a smaller cross-sectional area to drive through the ground 90 than the drill string 61 and corresponding penetrator 200C (of comparable size) and/or an increased cross-section of the driving material. The driving assembly 300, and corresponding penetrator 200O may have a larger driving material cross-sectional area than the drill string 61 and corresponding penetrator 200C (of comparable size). The relatively smaller penetrating cross-sectional area is advantageous and may become relatively even smaller and thus more advantageous as a spacing ST between the tubes 110, 110A, 110B (see FIGS. 83 & 86) becomes larger.

Pressurized heat exchanger tubes (with liquid and/or gas as the pressurizing medium) could be used to assist in spreading or keeping the tubes spread apart when installing, especially in a helical configuration. Pressurized heat exchanger tubes could further be used to make the tubes more damage resistant (e.g., avoid buckling). Allow pressurization of the sheathing without collapsing.

The various components and methods disclosed herein may seek to reduce thermal short circuiting (i.e., thermal interference). The tubes of the HEx may be installed in loops thus forming one or more pairs of the tubes. The drawings illustrate a single pair of tubes per HEx, but multiple pairs per HEx could be used. (Odd numbers of tubes could also be used.)

A locating device may be used in any of the components herein. Such locating devices are well known in the art of drilling/boring (e.g., horizontal and vertical drilling/boring). The locating device may be battery powered or have power supplied by tension members, tremie tubes, separate electrical cables, etc. Signals may be sent wirelessly or via conductors similar to the power conductors or even sharing the power conductors.

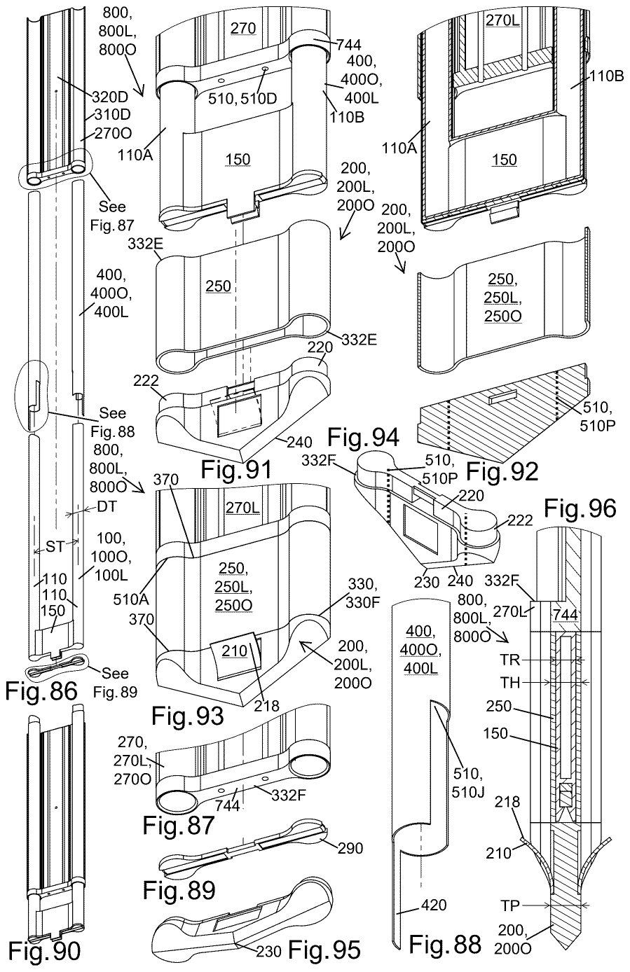

The tubes and/or tube portions may have extended tube-to-tube spacing ST (see FIG. 86) in comparison with conventional methods (e.g., placing one or more heat exchanger loop in a borehole). Such extended tube spacing ST reduces tube-to-tube thermal conduction (i.e., thermal interference or thermal short-circuiting) and increases tube-to-soil thermal conduction and thereby increases the efficiency, effectivity, etc. of the geothermal heat exchanger. The tubes of the geothermal heat exchanger may be installed in a helical configuration.

According to the principles of the present disclosure, the parts and/or features below may be used in various combinations to form additional embodiments that may or may not be illustrated in the figures.

This disclosure relates to installing geothermal heat exchangers 100 into ground 90. In examples herein, the heat exchanger 100 includes heat exchanger tubing 110 with a first tube leg 110A and a second tube leg 110B. A fluid return 150 (i.e., U-return) is between and fluidly connects the legs 110A and 110B to each other. In certain embodiments, the legs 110A and 110B and the fluid return 150 are formed of a single tube, and the fluid return 150 is bent ≈180° and thereby forms a U-loop. In other embodiments, one or both legs 110A, 110B are joined to the fluid return 150, and the fluid return 150 may be custom-molded or otherwise formed to provide ≈180° changed to fluid flowing within the heat exchanger 100. Thus, for example, fluid flows down tube leg 110A and back up tube leg 110B.

FIGS. 1A-1F illustrate an example preinstallation system 10 configured to prepare an installation site for subsequent installation of the heat exchanger 100 into the ground 90. As shown, the ground 90 defines a surface 92, and a trench 94 may be formed below the surface 92 for later manifold placement and/or for keeping the surface 92 free of the geothermal heat exchanger 100 after installation is complete.

In the example of FIGS. 1A-1F, base equipment 30 includes a driver base 30D illustrated as a mini skid steer and configured to position and support a driver 40. In other embodiments, other base equipment 30 and/or another driver base 30D (e.g., a tripod, a building, other mobile equipment, etc.) may be used. The driver 40 includes an output 42 (e.g., an output shaft) configured to transmit rotational and/or axial loads to an elongate load-transferring assembly 58. As shown at FIGS. 1A-1F, the elongate load-transferring assembly 58 includes one or more drill rods 60 connectable to each other as a drill string 61. By adding and removing the drill rods 60, the drill string 61 can be lengthened and shortened. Each drill rod 60 includes a first end 62 (e.g., a distal end) and a second end 64 (e.g., a proximal end) and further includes a passage that can carry pressurized fluid and/or mechanical components, further described hereinafter. The drill string 61 includes a first end 63 (e.g., a distal end) and a second end 65 (e.g., a proximal end), and the drill rod passages collectively form a passage of the drill string 61. As further shown, the drill rods 60 are connectable to each other at coupling joints 68 formed by corresponding coupling-halves 69.

In the example of FIGS. 1A-1F, the driver 40 is coupled to a drill rod 60 by an adapter 610. As illustrated, the adapter 610 may include a female hexagon 612 configured to receive a male hexagon connecting feature 44H of the output 42 and a cross-pin hole connecting feature 44P configured to receive a cross pin 630. In certain embodiments, the cross pin 630 includes a keeper 630K. The adapter 610 further includes a coupling-half 69 configured to couple to a coupling half 69 of a drill rod 60 to form a coupling joint 68.

In the example of FIGS. 1A-1F, the drill string 61 is coupled at its distal end 63 to a penetrator 200. In a helical preinstallation configuration, the penetrator 200 comprises a helical penetrator 200H. In a linear preinstallation configuration, the penetrator 200 comprises a linear penetrator 200L. In certain embodiments, the penetrator 200 comprises a center-driven penetrator 200C configured to be driven via the drill string 61 as the elongate load-transferring assembly 58. In other embodiments, the elongate load-transferring assembly 58 may include other components in other configurations (e.g., plate portions connected to each other by lap joints).

FIGS. 1A-1F further illustrate example positional stages of the penetrator 200 during preinstallation. At FIG. 1A, the penetrator 200 is positioned above the surface 92. At FIG. 1B, the penetrator 200 is positioned within the trench 94. At FIG. 1C, the penetrator 200 is partially advanced into the ground 90. At FIGS. 1D & 1E, the penetrator 200 is advanced farther into the ground 90, and an additional drill rod 60 is added to extend the drill string 61 at FIG. 1E. At FIG. 1F, the penetrator 200 is advanced farther into the ground 90 using the extended drill string 61 (with the additional drill rod 60).

The helical penetrator 200H may leave a cut 98 in a form of a helical cut 98T (i.e., a double-start thread) that a helical (i.e., double helical) geothermal heat exchanger 100H can follow while being installed.

FIG. 2A illustrates a linear preinstallation configuration in which the penetrator 200 comprises a linear penetrator 200L shown positioned in the trench 94 to prepare the ground 90 for subsequent installation of a linear geothermal heat exchanger 100L. FIG. 2B illustrates the linear penetrator 200L advanced into the ground 90. The linear penetrator 200L may leave a cut 98 in a form of a linear cut 98C that the linear geothermal heat exchanger 100L can follow while being installed.

FIGS. 3A & 3B illustrate a helical preinstallation configuration similar to FIGS. 1A-1F but with the penetrator 200 (e.g., the helical penetrator 200H) oriented at an angle relative to vertical to prepare for angular installation. FIG. 3A illustrates the penetrator 200 positioned into the ground 90, and FIG. 3B illustrates the penetrator 200 substantially removed from the ground 90.

FIGS. 4A & 4B illustrate a linear preinstallation configuration similar to FIGS. 3A & 3B but with the penetrator 200 comprising the linear penetrator 200L oriented at an angle relative to the surface 92. FIG. 4A illustrates the penetrator 200 positioned into the ground 90 preparing for angular installation of the heat exchanger 100L, and FIG. 4B illustrates the penetrator 200 substantially removed from the ground 90.

FIGS. 5A-5D illustrate example components at and adjacent the driver 40. FIG. 5A illustrates the driver 40, the adapter 610, and a drill rod 60 in a partially exploded arrangement. FIGS. 5B & 5C illustrate enlarged portions of FIG. 5A showing coupling-halves 69 and associated thread features 67. In certain embodiments, the thread features 67 include single-start threads 67S.

FIG. 5D illustrates the driver 40 (i.e., the output 42), the adapter 610, and the drill rod 60 in an enlarged partial cross-sectional elevation view and further illustrates an example joint lock 66 used with a locking coupling joint 68L. In certain embodiments, the joint lock 66 includes one or more locking features 640, 660 and a locking member 360 configured to inhibit relative rotation between coupling-halves 69 when coupled as a joint 68 and locked.

FIGS. 6A-6D illustrate an example coupling between the helical penetrator 200H and a drill rod 60 and further illustrate an example joint lock 66. FIG. 6A illustrates an enlarged exploded view of the penetrator 200 and the drill rod 60 with the joint lock 66 configured to selectively lock the coupling joint 68 between the penetrator 200 and the drill rod 60. FIGS. 6B & 6C illustrate enlarged views of the joint lock 66 and associated locking features. FIG. 6D illustrates an enlarged cross-sectional elevation view of the penetrator 200 and drill rod 60 locked by the joint lock 66 and further schematically illustrates optional fluid passages 510 including a drill rod fluid passage 510D and a penetrator fluid passage 510P to inject fluid 96.

FIG. 7 illustrates an enlarged perspective view of the linear penetrator 200L and further schematically illustrates optional fluid passages 510P through the penetrator 200L configured to inject fluid 96 into the ground 90 to facilitate ground preparation.

FIGS. 8A-8C illustrate a prior art coupling joint 68PA between prior art drill rods 60PA. FIG. 8A illustrates a cutaway view of the prior art coupling joint 68PA and further illustrates a prior art drill rod double-shoulder coupling interface 368. FIG. 8B illustrates a male end portion of the prior art drill rod 60PA, and FIG. 8C illustrates a female end portion of the prior art drill rod 60PA.

FIG. 9 illustrates an example mount 50 configured to mount the driver 40 to the base equipment 30. In certain embodiments, the mount 50 comprises a driver mount 50D configured to couple the driver 40 to the driver base 30D.

FIGS. 10A-10R illustrate an example installation system 20 configured to install a geothermal heat exchanger 100 into the ground 90. In the example of FIGS. 10A-10R, the installation system 20 is a center-driven installation system 20C and a helical installation system 20H that drives a penetrator 200 (e.g., a helical penetrator 200H) via a drill string 61 (i.e., an elongate load-transferring assembly 58) formed by one or more drill rods 60.

As shown at FIG. 10A, a driver base 30D (e.g., a mini skid steer) supports and positions the driver 40 for transporting the installation system 20 and for applying driving loads to the penetrator 200 via the drill string 61. In certain embodiments, the driver 40 applies rotary loads, axial loads, impact loads, vibratory loads, or combinations thereof to advance the penetrator 200 into the ground 90. As further shown at FIG. 10A, a spool base 30S and a utility base 30U may be provided as a frame that supports the above-ground portions of the installation system 20. In the depicted embodiment, the frame includes legs 32 and transport straps 34 (see FIG. 11A) that facilitate handling, staging, and transport of the frame and associated components. In other embodiments, the mini skid steer (and/or other mobile equipment) may optionally serve as the spool base 30S and/or the utility base 30U.

As shown at FIGS. 10A & 10B, a vise 56 (e.g., a clamp) may be configured to selectively clamp the drill string 61 (i.e., or a drill rod 60 thereof) to maintain position control of the drill string 61 when the drill string 61 is disconnected from the driver 40 (e.g., during drill rod addition/removal) and/or during transport of the installation system 20. The vise 56 may be actuated manually and/or by a driver actuator set 38D. The driver base 30D may position the driver 40 relative to the drill string 61 to make or break coupling joints 68 between coupling-halves 69.

As shown at FIGS. 10A-10D, heat exchanger tubing 110 of the heat exchanger 100 is stored on one or more spools 560 supported by the spool base 30S. In the depicted embodiment, the heat exchanger tubing 110 includes a first tube leg 110A and a second tube leg 110B (e.g., routed from a fluid return 150 positioned at a distal portion of the heat exchanger 100). In certain embodiments, the spools 560 are controlled by a spool actuator set 38S (e.g., motors and/or brakes) to dispense and/or constrain the tubing 110 during installation and to retrieve associated components during removal operations (e.g., sheaths 400). In certain embodiments, a utility actuator set 38U (e.g., pressurized air and/or water sources, flow control components, pumps, and/or valves) is supported by the utility base 30U to support one or more operations described herein.

As further shown at FIGS. 10A-10I, one or more sheaths 400 may be positioned around the heat exchanger tubing 110 to protect the heat exchanger tubing 110 during installation. In certain embodiments, the sheaths 400 are stored on the spools 560 with the heat exchanger tubing 110 substantially therein and are dispensed concurrently with the tubing 110. In certain embodiments, the sheaths 400 include sheath retaining tabs 420 configured to engage a holding mechanism (e.g., a retainer/releaser 290) to selectively retain and release the sheaths 400, further described below.

As shown at FIGS. 10A-10D, the installation system 20 may be transported to an installation site and positioned so that the penetrator 200 is aligned with a desired installation location. In certain embodiments, the penetrator 200 is positioned above and then in a trench 94 such that, after installation, portions of the heat exchanger 100 remain accessible from the trench 94 for fluid connection to one or more manifolds but remain below the surface of the ground (e.g., for burial upon completion of the installation).

As shown at FIGS. 10D-10G, a drill rod 60 may be connected to the drill string 61 to extend the drill string 61 and thereby allow the penetrator 200 to be driven deeper into the ground 90. The drill rods 60 may be connected by coupling joints 68 formed by coupling-halves 69. In certain embodiments, the coupling joints 68 include locking coupling joints 68L (e.g., using a joint lock 66 as described above with respect to FIGS. 5D & 6A-6D).

As shown at FIGS. 10E-10I, the driver 40 drives the drill string 61 and thereby drives the penetrator 200 into the ground 90, while the tubing 110 and the sheaths 400 are dispensed from the spools 560. In the depicted embodiment, the penetrator 200 advances to approximately one drill rod length at FIG. 10E and to approximately two drill rod lengths at FIG. 10H, with a second drill rod 60 added at FIG. 10G. During such advancement, the spool actuator set 38S may control and/or coordinate payout of the tubing 110 and the sheaths 400 to reduce unwanted tension and/or twisting and impose constraints in coordination with the driver 40 and or the driver base 30D and/or to otherwise maintain desired tube configuration.

As shown at FIGS. 10I & 10J, a sheath holding mechanism (e.g., a retainer/releaser 290) may retain the sheaths 400 during at least a portion of installation and may be actuated to release the sheaths 400 at a desired stage. In certain embodiments, release occurs by separating a component of the holding mechanism from the sheath retaining tabs 420, thereby allowing the sheaths 400 to be removed while leaving the heat exchanger tubing 110 substantially installed in the ground 90.

In the illustrated embodiment of FIGS. 10I & 10J, the sheaths 400 are released by the retainer/releaser 290 unclamping the sheath retaining tabs 420. As this occurs below the surface 92 of the ground 90 (e.g., at a finished installation depth), a remote release mechanism is provided. For example, upon the driver 40 rotating in a rotational direction opposite from an installation rotational direction, the drill string 61 begins to uncouple (e.g., unscrew) from, e.g., a driver connector body 270 (e.g., a housing connector) of the penetrator 200. In the illustrated embodiment, the uncoupling further allows the unclamping of the retainer/releaser 290 and the release of the sheaths (in addition to the retrieval of the drill string 61). As illustrated at FIGS. 48-54, a multi-thread-start coupling 68P may be used between the drill string 61 and the penetrator 200. The multi-thread-start coupling 68P may have sufficient torque (and other loads) capacity but may beneficially have a lower uncoupling torque in comparison with the other (e.g., single-thread-start) couplings 68S. An adapter drill rod 60A (of the same or a different length from the other drill rods 60) may have a multi-start coupling half 69P at its distal end and a single-start coupling half 69S at its proximal end. By partially decoupling the multi-thread-start coupling 68P, the penetrator 200, and thereby the heat exchanger tubing 110, may be held at an installed position while the sheaths 400 are being retrieved. As shown at FIGS. 10J-10O, after release of the sheaths 400, the sheaths 400 may be retrieved from the ground 90 and rewound onto the spools 560 and thereby be reused. In the depicted embodiment, the sheath retaining tabs 420 remain visible (in the figures) during retrieval (e.g., at FIGS. 10L & 10O). Upon the retrieval of the sheaths 400, the multi-thread-start coupling 68P may be fully decoupled, and the drill string 61 retrieved from the ground 90.

As shown at FIGS. 10J-10M, grout 96G may be placed into the ground 90, and especially around the installed heat exchanger tubing 110, via the sheaths 400 as they are removed from the ground 90. The grout 96G may be pumped through the sheaths 400, as will be further described hereinafter. As shown at FIGS. 10P-10R, grout 96G may be placed into the ground 90 via the drill string 96G as one or more drill rods 60 of the drill string 61 are withdrawn from the ground 90. The grout 96G may be pumped through the drill string 61, as will be further described hereinafter. In certain embodiments, grout 96G (and/or other fluids 96) is supplied by a supply system 500 including a supply dispenser 80 and delivered through one or more fluid passages 510. For example, grout 96G may be delivered through a drill rod fluid passage 510D of the drill string 61 and discharged adjacent a distal portion of the installation path as the drill string 61 is retracted, thereby backfilling void(s) created by withdrawal of the drill string 61. The grout 96G and/or other fluids 96 may improve thermal coupling between the heat exchanger tubing 110 and the ground 90. As illustrated in the depicted embodiment, a second drill rod 60 is withdrawn while grout 96G is placed at FIG. 10P, and a first drill rod 60 is subsequently withdrawn while additional grout 96G is placed at FIG. 10R.

Upon completion of the sequence of FIGS. 10A-10R, the heat exchanger tubing 110 is left installed in the ground 90, the sheaths 400 are removed and retrieved to the spools 560, and at least portions of the drill string 61 and the installation system 20 are removed from the installation site. In certain embodiments, the free ends of the heat exchanger tubing 110 are positioned to remain accessible from the trench 94 for subsequent connection to one or more manifolds and/or related components. Upon completion of the installation, the trench 94 may be filled, and the installation site may be used for general purposes (e.g., a lawn, etc.).

FIGS. 11A-11G illustrate example above-ground components of the installation system 20 of FIGS. 10A-10R with the driver base 30D hidden and only a driver attachment flange 46 of the driver 40 shown in dashed line. As shown, a frame may serve as the spool base 30S and as the utility base 30U for supporting, transporting, and/or organizing the above-ground components used during installation and retrieval operations.

As shown at FIG. 11A, the spool base 30S supports one or more spools 560 that store heat exchanger tubing 110 and, in certain embodiments, one or more sheaths 400 positioned around the tubing 110. The frame further includes legs 32 that support the frame at the ground surface 92 and transport straps 34 that facilitate handling, staging, and transportation of the frame.

As shown at FIG. 11A and enlarged at FIG. 11B, the frame may include one or more mounts 50 for supporting and positioning components relative to the spools 560. In certain embodiments, the mounts 50 include a spool mount 50S and a utilities mount 50U. The spool mount 50S may support a spool axle, a spool bearing arrangement, and/or a spool actuator set 38S (e.g., brake(s), motor(s), clutch(es), or combinations thereof) configured to control payout, retrieval, and/or constraining/positioning of the tubing 110 and/or the sheaths 400.

As shown at FIG. 11A, the utility base 30U may support at least a portion of a supply system 500. The supply system 500 may include one or more fluid sources (e.g., air and/or liquid sources), one or more pumps, and one or more valves, and may receive and distribute power and utility supplies. In certain embodiments, the supply system 500 includes a supply dispenser 80 that controls delivery of one or more fluids 96 (including grout 96G) to one or more components of the installation system 20 via one or more fluid passages 510.

As shown at FIG. 11C, the installation system 20 may include one or more tube/sheath conditioners/processors positioned adjacent the spools 560. The tube/sheath conditioners/processors may be configured to condition, guide, align, straighten, clean, lubricate, heat, cool, and/or otherwise prepare the tubing 110 and/or the sheaths 400 for installation and/or retrieval and may reduce friction and/or snagging during payout/retrieval.

As shown at FIG. 11D, the installation system 20 may include one or more clamps/constraints configured to selectively constrain the tubing 110 and/or the sheaths 400 relative to a corresponding spool 560. Such constraints may assist in controlling tension, preventing uncontrolled payout, maintaining desired configuration, and/or resisting axial and/or other forces associated with pressurization of the tubing 110 and/or the sheaths 400.

As shown at FIG. 11E, the sheath 400 may define an interior region and may be positioned around the tubing 110 such that the sheath 400 functions as a protective jacket, a damage indicating jacket, a witness jacket, and/or as a conduit for conveying fluid 96 along the tubing 110 and within the interior region. For example, the jacket/sheath 400 may show that a damage event may have occurred to the tubing 110 during installation. As the jacket/sheath 400 may be withdrawn after the installation of the tubing 110, inspection (visual, pressure testing, leak testing, etc.) may be performed on the jacket/sheath 400. Evidence on the withdrawn jacket/sheath 400 may indicate what the tubing 110 may have experienced during the installation and how the tubing 110 may perform post-installation. In certain embodiments, fluid 96 is conveyed through a tube jacket fluid passage 510J that extends within and/or along the sheath 400 to deliver fluid 96 to a distal region of the sheath 400 (e.g., to facilitate lubrication, jetting, and/or grout 96G placement around the tubing 110).

As shown at FIGS. 11E-11G, the tubing 110 may be pressurized and/or tested while positioned within the sheath 400. In certain embodiments, an air chuck 598 is coupled to the tubing 110 to provide pressurized air and/or to perform a pressure test. Pressurization may stiffen the tubing 110, facilitate maintaining a desired shape (e.g., a helical shape), increase damage resistance during installation, and/or provide leak detection.

FIG. 12 illustrates an enlarged view of one spool 560 (e.g., of the spool base 30S). The spool 560 may include a hub, a rim, clamps/constraints, and one or more flanges configured to retain the tubing 110 and/or the sheath 400. In certain embodiments, the spool 560 is driven by the spool actuator set 38S and thereby controlled and/or coordinated.

FIGS. 13A & 13B further illustrate the spool base 30S and the utility base 30U and further illustrate the spool actuator set 38S. In certain embodiments, the spool actuator set 38S includes a motor configured to rotate the spool 560 and/or a brake configured to resist rotation of the spool 560, thereby controlling tension, speed, etc. during payout/retrieval.

FIG. 14 illustrates an enlarged cutaway portion of FIG. 10D showing a load-carrying/transferring rotary union 70L positioned adjacent the driver 40 and configured to transmit one or more loads (e.g., axial force and/or torque) while also transferring fluid 96 through a rotary union fluid passage 510U. In certain embodiments, the rotary union 70L includes an adapter 610U integrated with the union 70L configured to couple to the driver output 42 and to a drill rod 60 and thereby to the drill string 61. The rotary union 70, 70L allows the transferring of fluid 96 while the elongate load-transferring assembly 58 rotates, translates, and/or oscillates (including while under vibratory and/or impacting loading).

As shown at FIG. 14, the rotary union 70L may receive fluid 96 from the supply system 500 via a fluid supply system fluid passage 510S and transfer the fluid 96 through the rotary union fluid passage 510U into a drill rod fluid passage 510D of the drill rod 60. The drill rod fluid passage 510D may continue through the drill string 61 to convey the fluid 96 to a distal region adjacent the penetrator 200 and/or to convey the fluid 96 to other passages 510 including, for example, a penetrator fluid passage 510P and/or a housing fluid passage 510H.

FIGS. 15 & 16 illustrate the installation system 20 with a drill rod 60 added between an adapting drill rod 60A and the rotary union 70L. The adapting drill rod 60A may include a coupling-half 69P with multi-start threads 67P at one end and a coupling-half 69S with single-start threads 67S at an opposite end, thereby facilitating interfacing between coupling joints 68 of different thread configurations. In certain embodiments, the drill rod 60 is selectively clamped by the vise 56 to maintain position control during coupling and decoupling operations.

FIG. 15 illustrates the vise 56 in a clamped state constraining the drill rod 60, and FIG. 16 illustrates the vise 56 in an unclamped state allowing movement and driving of the drill string 61. Clamping by the vise 56 may facilitate making and breaking coupling joints 68 while maintaining alignment and preventing unintended rotation and/or dropping of the drill string 61.

FIG. 17 illustrates a helical guide configured to guide the tubing 110 and/or the sheaths 400 into a helical configuration during installation. FIG. 18 illustrates an enlarged perspective view of the helical guide. In certain embodiments, the helical guide constrains a pitch and/or radius of the helical tubing configuration and assists in maintaining a desired spacing between the tube legs 110A, 110B as the tubing 110 is driven into the ground 90.

FIGS. 19 & 20 illustrate the installation system 20 with the drill rod 60 extended into the ground 90 and portions of the heat exchanger tubing 110 and sheaths 400 installed. In certain embodiments, the helical guide of FIG. 17 is positioned adjacent the tubing 110 and operates in coordination with the spool actuator set 38S, the driver 40, the driver base 30D, and/or the tube/sheath conditioners/processors to control payout and maintain the tubing configuration as the penetrator 200 advances.

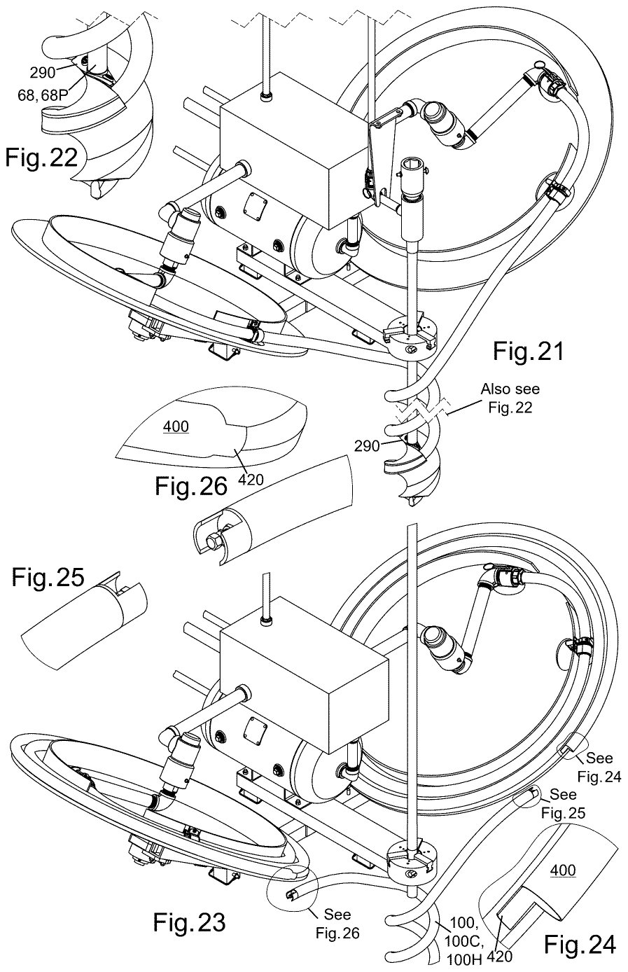

FIGS. 21 & 22 illustrate a sheath retainer/releaser 290 positioned adjacent the penetrator 200 and configured to retain and later release the sheaths 400. In certain embodiments, the sheath retainer/releaser 290 engages the sheath retaining tabs 420 and constrains the sheaths 400 during at least a portion of the installation. In certain embodiments, the sheath retainer/releaser 290 is actuated by relative motion between components adjacent the penetrator 200 (e.g., by partial decoupling of a coupling joint 68, including a coupling joint 68P with multi-start threads 67P).

FIG. 21 illustrates the sheath retainer/releaser 290 retaining the sheaths 400 to the penetrator 200, and FIG. 22 illustrates the sheath retainer/releaser 290 releasing the sheaths 400 from the penetrator 200. Upon release, the sheaths 400 may be withdrawn from the ground 90 while the tubing 110 remains substantially installed.

FIG. 23 illustrates the installation system 20 after the sheaths 400 have been substantially retrieved onto the spools 560, the drill rods 60 have been retrieved from the ground 90, and the heat exchanger 100 is substantially installed in the ground 90. In certain embodiments, the free ends of the tube legs 110A, 110B are positioned near and accessible from the trench 94 for subsequent connection to one or more manifolds.

FIG. 24 illustrates a tabbed end of a first sheath 400 including one or more sheath retaining tabs 420. In certain embodiments, the sheath retaining tabs 420 include thickened end portions configured to be captured by the sheath retainer/releaser 290 upon installation and configured to be removed (e.g., pulled out) from the retainer/releaser 290 upon retrieval.

FIG. 25 illustrates a first end of the installed heat exchanger 100 separated from the first sheath 400 after retrieval of the sheath 400. FIG. 26 illustrates a tabbed end of a second sheath 400 separated from a second end of the installed heat exchanger 100. In certain embodiments, the sheaths 400 are reusable and are retrieved to the spools 560.

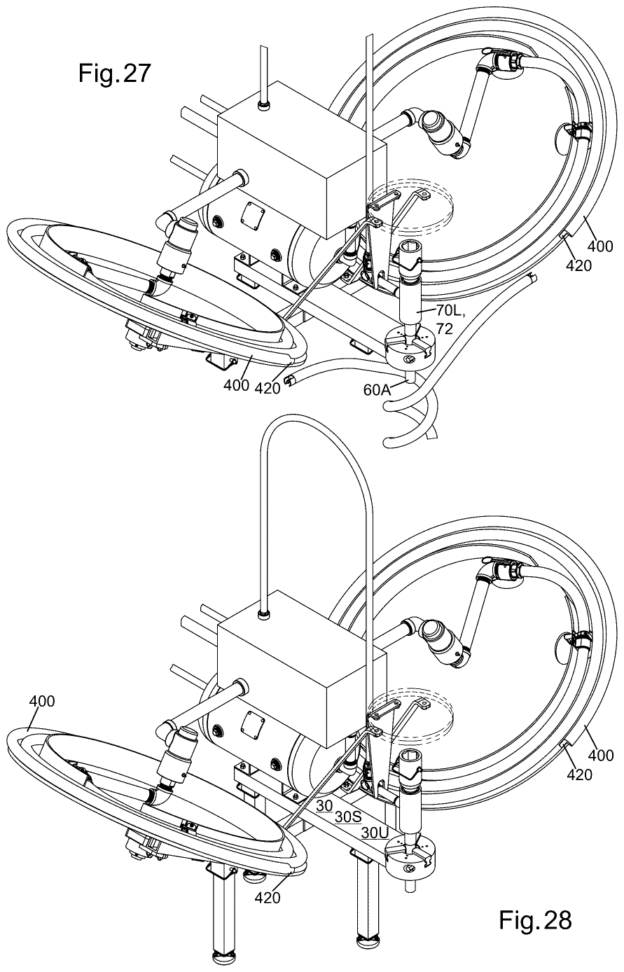

FIG. 27 illustrates the installation system 20 with the adapting drill rod 60A connected to the rotary union 70L. In certain embodiments, the adapting drill rod 60A is a distal-most drill rod in the drill string 61 during at least a portion of installation and retrieval operations and facilitates coupling/decoupling at the penetrator 200, e.g., at a driver connector body 270 (e.g., a housing connector).

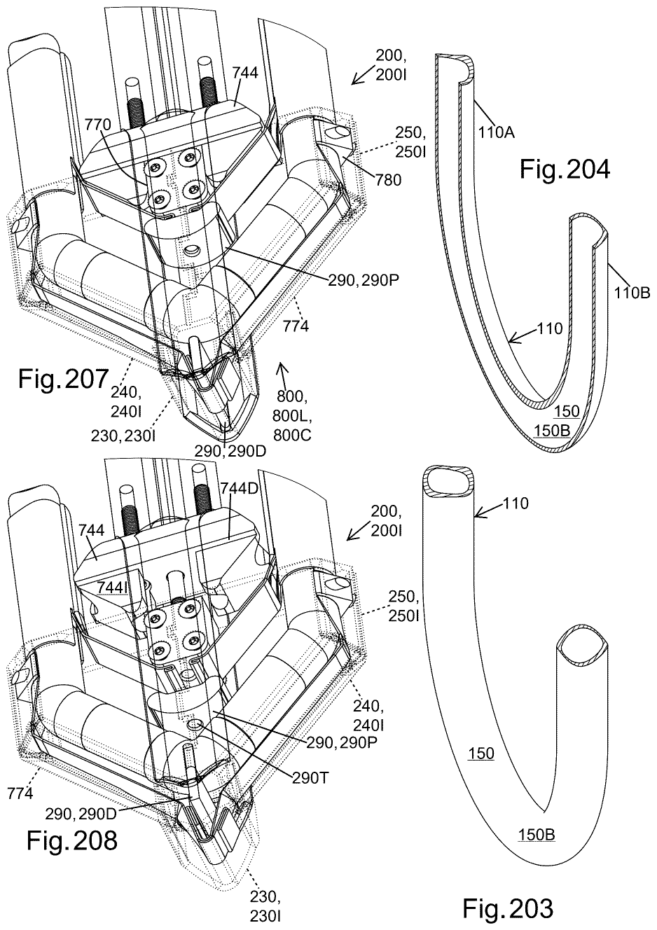

FIG. 28 illustrates the installation system 20, optionally without the driver base 30D, after removal (i.e., transport) from an installation site. In the depicted embodiment, legs 32 are reinstalled on the frame such that the spool base 30S and utility base 30U provide a service position. In such a service position, maintenance, coupling preparation, testing (including pressure testing), reloading of tubing 110, bending a fluid return 150B (see FIGS. 203 & 204) along the tubing 110, installing a fluid return 150 between legs 110A and 110B of the tubing 110, and/or reloading of sheaths 400 on the spools 560 may be performed.

FIGS. 29-34 illustrate an example installation system 20 configured for installing a dual-tube linear geothermal heat exchanger 100L into the ground 90. In the example of FIGS. 29-34, the installation system 20 is a linear installation system 20L and, in certain embodiments, is a center-driven installation system 20C that drives a center-driven linear penetrator 200 (e.g., a linear penetrator 200L and/or a center-driven penetrator 200C) via a drill string 61 (i.e., an elongate load-transferring assembly 58) formed by one or more drill rods 60.

As shown at FIG. 29, the installation system 20 includes a spool base 30S and a utility base 30U provided as a frame supporting spools 560 and at least a portion of a supply system 500. In certain embodiments, the spools 560 store and dispense heat exchanger tubing 110, including a first tube leg 110A and a second tube leg 110B. In certain embodiments, one or more sheaths 400 are positioned around the tube legs 110A, 110B and are stored on the spools 560 with the heat exchanger tubing 110 positioned therein.

As shown at FIG. 30, which is an enlarged replacement portion of FIG. 29, the installation system 20 includes one or more tube/sheath conditioners/processors positioned adjacent the spools 560. The tube/sheath conditioners/processors may be configured to guide the tubing 110 and/or the sheaths 400, to reduce snagging during payout and retrieval, and to facilitate maintaining a desired tube configuration during installation. FIG. 30 further illustrates a pair of heat exchanger tube guides positioned to guide the tube legs 110A, 110B during payout and installation.

As shown at FIG. 31, which is an enlarged partial rear elevation view, the tube/sheath conditioners/processors and the tube guides may be positioned relative to the spools 560 and relative to each other to establish a controlled payout path for the tubing 110 and the sheaths 400. In certain embodiments, a spool actuator set 38S is configured to dispense and/or constrain the tubing 110 and/or the sheaths 400, including by controlling spool rotation and/or tension.

As shown at FIG. 32A, the center-driven linear penetrator 200L is positioned within a trench 94 at an installation site. In certain embodiments, the trench 94 provides access to the tube legs 110A, 110B for subsequent connection to a manifold and provides installation depth below the surface 92 of the ground 90. In certain embodiments, the installation system 20 positions the penetrator 200L within the trench 94 and aligns the penetrator 200L with a desired installation location.

As shown at FIG. 32B, the driver base 30D (e.g., a mini skid steer) supports and positions the driver 40 for applying driving loads to the penetrator 200L via the drill string 61. In certain embodiments, the driver 40 applies axial loads, impact loads, vibratory loads, and/or combinations thereof to advance the penetrator 200L into the ground 90. In certain embodiments, the driver 40 additionally applies rotary loads (e.g., to align and/or reorient the penetrator 200L, to keep joints 68 along the drill string 61 tight, and/or to assist penetration).

As shown at FIG. 32C and enlarged at FIG. 32D, the heat exchanger 100L may be substantially installed into the ground 90 while the drill string 61 remains coupled to the penetrator 200L. During installation, the spools 560 may dispense the tube legs 110A, 110B and the sheaths 400, and the tube guides and tube/sheath conditioners/processors may guide and constrain the tube legs 110A, 110B and the sheaths 400 to reduce twisting and/or to maintain a desired tube spacing and tube routing.

As shown at FIG. 32D, a sheath holding mechanism may retain the sheaths 400 during at least a portion of installation. In certain embodiments, the sheath holding mechanism includes a retainer/releaser 290 configured to engage sheath retaining tabs 420 positioned at ends of the sheaths 400. In certain embodiments, the retainer/releaser 290 retains the tabs 420 to prevent the sheaths 400 from being withdrawn during installation and/or to relieve loads carried by the sheaths 400 from being transferred to the tubing 110.

As shown at FIG. 32E, the retainer/releaser 290 may be actuated to release the sheaths 400, thereby allowing withdrawal of the sheaths 400 while leaving the tubing 110 substantially installed in the ground 90. In certain embodiments, release is facilitated by loosening and/or partially decoupling a coupling joint 68 between the drill string 61 and a driver connector body 270 (e.g., a housing connector or other component of the penetrator 200L), including loosening a coupling joint 68P having multi-start threads 67P, thereby allowing relative motion that unclamps the retainer/releaser 290 and frees the tabs 420.

As shown at FIGS. 32F & 32G, after release of the sheaths 400, the sheaths 400 may be withdrawn from the ground 90 and retrieved to the spools 560. In certain embodiments, the sheath retaining tabs 420 follow the overall sheaths 400 back onto the spool and may be reused. In other embodiments, especially when the tabs 420 are impacted by being retained and/or pulled upon, the old tabs 420 may be cut off from the overall sheaths 400, and new tabs 420 may be formed by cutting from the sheaths 400. The tabs 420 may also be sewn onto the overall sheaths 400. In certain embodiments, the spools 560 are driven in reverse by the spool actuator set 38S to rewind the sheaths 400 onto the spools 560. As previously mentioned with respect to other embodiments, grout 96G and/or other fluids 96 may be injected into the ground 90 via the sheaths 400 (e.g., while being withdrawn).

As shown at FIG. 32H, grout 96G may be placed into the ground 90 while the drill string 61 is withdrawn from the ground 90 before or after the sheaths 400 have been withdrawn. In certain embodiments, the grout 96G is supplied by the supply system 500 via a supply dispenser 80 and delivered through one or more fluid passages 510, including through a drill rod fluid passage 510D of the drill string 61, to backfill void(s) created by withdrawal of the drill string 61. The grout 96G and/or other fluids 96 may improve thermal coupling between the heat exchanger tubing 110 and the ground 90.

FIG. 33 is a broken perspective view illustrating the installation system 20 installing the linear geothermal heat exchanger 100L, including the payout of the tube legs 110A, 110B from the spools 560 and the advancement of the penetrator 200L into the ground 90 via driving loads transmitted through the drill string 61.

FIG. 34 is a partial perspective view illustrating the installation system 20 and the linear geothermal heat exchanger 100L upon installation. In certain embodiments, free end portions of the tube legs 110A, 110B remain accessible from the trench 94 for subsequent connection to a manifold and for subsequent backfilling of the trench 94.

FIGS. 35 & 36 illustrate an example installation system 20 configured for installing a dual-tube linear geothermal heat exchanger 100L into the ground 90 with an overlapping joint driven installation approach. In the depicted embodiment, the installation system 20 is a linear installation system 20L and an overlapping joint driven installation system 20O and includes a driving assembly with ground loop and penetrator 900 (e.g., 900L, 900O). As depicted, the installation system 20 is supported by a driver base 30D, a spool base 30S, and a utility base 30U. As shown, the spool base 30S and the utility base 30U may be implemented as a frame having legs 32 and removable transport straps 34 to facilitate moving and staging the installation system 20.

As shown at FIGS. 35 & 36, the driving assembly with ground loop and penetrator 900 includes heat exchanger tubing 110 extending from a fluid return 150 and stored on one or more spools 560. In the depicted embodiment, the tubing 110 includes a first tube leg 110A and a second tube leg 110B. In certain embodiments, one or more sheaths 400 are positioned around the tube legs 110A, 110B and are dispensed from the spools 560 with the tubing 110. The spools 560 may be controlled by a spool actuator set 38S to dispense and/or constrain the tubing 110 and/or the sheaths 400. In certain embodiments, a supply system 500 supported by the utility base 30U includes a supply dispenser 80 configured to provide fluid 96 (including grout 96G) via one or more fluid passages 510.

As shown at FIGS. 35 & 36, the installation system 20 may include one or more tube/sheath conditioners/processors positioned adjacent the spools 560 to guide and condition the tubing 110 and/or the sheaths 400 during payout and/or retrieval. In certain embodiments, the tube/sheath conditioners/processors cooperate with tube guides and/or other constraints to reduce snagging, reduce twisting/bending, and maintain a desired spacing and routing of the tube legs 110A, 110B during installation.

FIG. 37A illustrates the installation system 20 positioned at a service position above ground level 92 and/or above a trench 94 at an installation site. In certain embodiments, the driver base 30D (e.g., a mini skid steer, a tripod, etc.) positions a driver 40 of the driving assembly with ground loop and penetrator 900. In certain embodiments, a vise 56 selectively clamps a drill rod 60 and thereby maintains position control of an elongate load-transferring assembly 58 of the driving assembly with ground loop and penetrator 900 during transport, coupling, and decoupling operations. In other embodiments, the elongate load-transferring assembly 58 does not include drill rods 60 nor a drill string 61. Instead, as illustrated at FIG. 115, the elongate load-transferring assembly 58 includes a driving assembly 300 that extends from the output 42 of the driver 40 to the penetrator 200 and/or a housing 250. In other embodiments, the output 42 of the driver 40 may not necessarily be connected to the driving assembly 300 and instead may hammer on a cap of the driving assembly (similar to the illustrations at FIGS. 151 & 153). To accommodate driving assemblies 300 that are non-circular, at least at positions of the vise 56, a vise 56 with non-circular clamping can be used.

FIG. 37B illustrates the heat exchanger 100L substantially installed into the ground 90. In the depicted embodiment, the heat exchanger tubing 110 extends upward from the fluid return, at an installed depth, and proximal ends of the heat exchanger tubing 110 are accessible (e.g., from the trench 94) for subsequent connection to one or more manifolds.

FIG. 37C is an enlarged cross-sectional view of FIG. 37B illustrating internal components of the overlapping joint-driven system. As shown, a penetrator 200 (e.g., a linear penetrator 200L and/or an overlapping driven penetrator 200O) is positioned at a distal portion of the installation and is configured to penetrate the ground 90. In certain embodiments, the penetrator 200 includes an anchor 210 configured to move between a retracted orientation 216 and a deployed orientation 218 to retain the installed heat exchanger 100L in the ground 90. In the depicted embodiment, a housing 250 (e.g., a linear housing 250L and/or an overlapping driven housing 250O) is connected to and abuts the penetrator 200 and substantially encloses at least a portion of the fluid return 150. In certain embodiments, the housing 250 protects the fluid return 150 and provides a load path for transmitting axial driving loads between the driving assembly 300 and the penetrator 200. In certain embodiments, the housing 250 is combined (i.e., integrated) with the penetrator 200.

As shown at FIG. 37C, the driving assembly 300 includes a distal driving member 310D and a medial driving member 310M. In certain embodiments, the distal driving member 310D connects to and abuts the housing 250 and overlaps the medial driving member 310M to form a lap joint 340. In certain embodiments, the driving members 310 include elongated portions 320 (e.g., 320D, 320M, 320P, 320T) that extend along a driving direction and transmit axial loads between the driver 40 and the penetrator 200 through the driving assembly 300. In certain embodiments, adjacent driving members 310 include abutting ends 332E and/or abutting flanges 332F that form abutting joints 370 to transmit axial compressive (i.e., contact) loads. In certain embodiments, protective guards 328 (e.g., 328A, 328B) of one or more driving members 310 shield portions of the tubing 110 and/or the sheaths 400 from ground contact during driving.

In certain embodiments, adjoining driving members 310 include interfacing features 350 along an interface 338 to orient the driving members 310 relative to each other and to transfer loads between overlapping portions of the driving members 310. In certain embodiments, the interfacing features 350 include a female interfacing feature 350F and a male interfacing feature 350M that form a tongue and groove joint 350J. The tongue and groove joint 350J may allow controlled sliding movement during assembly and disassembly while maintaining lateral alignment and load transfer.

In certain embodiments, the driving members 310 are arranged in a first column 318A and a second column 318B (see FIGS. 110 & 117) and are longitudinally offset relative to each other. In certain embodiments, the abutting joints 370 alternate along the driving assembly 300 between the first column 318A and the second column 318B, thereby providing a distributed set of abutting joints 370. The abutting joints 370 primarily transfer compressive loads. (The neighboring elongated portion 320 also transfers compressive loads.) The neighboring elongated portion 320 thus transfers other loads (e.g., bending loads, side loads, etc.) through the driving assembly 300 at the abutting joint 370. Axial compressive loads are the dominant load of the driving assembly 300, and the other loads can readily be handled by the neighboring elongated portion 320 to the abutting joint 370.

FIGS. 38A-38I illustrate an example method of lengthening the driving assembly 300 by installing additional medial driving members 310M. (Eventually resulting in the heat exchanger 100L being substantially installed into the ground 90, as illustrated at FIG. 37B.) As shown at FIG. 38A, a proximal driving member 310P is positioned adjacent and attached to a previously installed medial driving member 310M. As shown at FIG. 38B, the proximal driving member 310P may be released and raised away from the previously installed medial driving member 310M to create space for insertion of an additional medial driving member 310M.

As shown at FIG. 38C, the proximal driving member 310P may be reoriented from an orientation A 306 to an orientation B 308 (or from orientation B 308 to orientation A 306). In certain embodiments, the reorientation comprises rotating the proximal driving member 310P approximately 180° so that an opposite face is presented for lap joint formation with an adjoining driving member 310. As shown at FIG. 38D, a first additional medial driving member 310M may be positioned adjacent and attached to both the previously installed medial driving member 310M and the proximal driving member 310P, thereby lengthening the driving assembly 300. As shown at FIG. 38E, the lengthened driving assembly 300 is driven further into the ground 90 by applying driving loads through the proximal driving member 310P (and thereby through the driving assembly 300).

As shown at FIGS. 38F-38I, the steps of releasing, raising, reorienting, adding another medial driving member 310M, and driving may be repeated to incrementally lengthen the driving assembly 300 and to advance the penetrator 200 and the heat exchanger 100L to a desired installation depth. For removal of the driving assembly 300, the above-mentioned steps may be performed in reverse order, and the proximal driving member 310P may be pulled by the driver base 30D (instead of pushed by the driver base 30D). An impacting reverse driver may further be used to remove the driving assembly 300 from the ground 90.

FIGS. 37D-37J illustrate additional aspects of an example removal sequence after installation of the heat exchanger 100L. In the depicted embodiment, the driving assembly 300 functions as the elongate load-transferring assembly 58 during withdrawal and may be withdrawn in stages while grout 96G is placed into the ground 90. As shown at FIGS. 37D and 37E, grout 96G (and/or other fluids 96) may be supplied by the supply system 500 and delivered through one or more fluid passages 510 (e.g., a driving assembly fluid passage 510D) to backfill any void created by withdrawal and/or to improve thermal coupling between the installed tubing 110 and the ground 90.

FIG. 37F illustrates an example release mechanism that may be used during withdrawal. In certain embodiments, a shearable fastener 360S is configured to shear at a predetermined load to allow separation of a reusable portion 740 (see FIG. 37G) of the driving assembly 300 from a distal portion that remains with the penetrator 200 and/or the housing 250. In the depicted embodiment, shearing facilitates removal of the elongate load-transferring assembly 58 (or a majority thereof) without requiring access to the separated joint within the ground 90.

As shown at FIGS. 37G & 37H, after shearing and separation, a medial driving member 310M and/or other reusable driving members 310 may be separated and spaced from the distal driving member 310D and/or the penetrator 200, while the distal driving member 310D and/or the penetrator 200 may remain in the ground 90 with the heat exchanger 100L. As shown at FIGS. 37I & 37J, the reusable portion of the driving assembly 300 may be fully withdrawn from the ground 90. In certain embodiments, the anchor 210 is deployed to the deployed orientation 218 before, during, and/or after withdrawal to retain the installed heat exchanger 100L in the ground 90.

FIG. 39 illustrates the heat exchanger 100L and sheaths 400 substantially installed with the installation system 20 and the anchor 210 retracted. FIG. 40 illustrates the driving assembly 300 removed and the anchor 210 deployed, thereby retaining the heat exchanger 100L in the ground 90.

FIGS. 41 & 42 illustrate removal of the sheaths 400 from the tube legs 110A, 110B after installation. In the depicted embodiment, the sheaths 400 are removed while leaving the tubing 110 installed, and the removed sheaths 400 may be inspected as a witness jacket and/or damage indicating jacket, as described above. In certain embodiments, the sheaths 400 are retrieved to spools 560 for reuse or disposal. The sheaths 400 may be removed before or after the driving assembly 300. If the sheaths 400 are removed after the driving assembly 300, the driving assembly 300 may be used to keep the tube legs 110A, 110B installed (in the presence of lifting friction from the sheaths 400 as they are withdrawn).

FIG. 43 illustrates the heat exchanger 100L installed with the sheaths 400 substantially retrieved. FIGS. 44-47 illustrate example separation of ends of the heat exchanger 100L from corresponding sheaths 400. In certain embodiments, sheath retaining tabs 420 are removed from engagement with a sheath holding mechanism (e.g., a retainer/releaser 290) and remain with the sheaths 400 during retrieval and may be reused or replaced, as described above.

FIGS. 48-56 illustrate example components and operations for a center-driven helical installation system 20H, including a penetrator 200H with a nose portion 230, a blade portion 240, a housing 250H, and a driver connector body 270H (e.g., a housing connector), sheathing 400H positioned around heat exchanger tubing 110 (including tube legs 110A and 110B), a sheath retainer/releaser 290, and/or a guide 292 configured as a spacer and/or guide (e.g., a helical spacer/guide) positioned between the drill string 61 and the sheathing 400H. As illustrated, the guide 292 may support and/or maintain a desired spacing ST and/or a desired helical pitch and/or radius of the tube legs 110A, 110B during installation by constraining the relative position of the drill string 61 and the sheathing 400H. In certain embodiments, the guide 292 reduces contact and abrasion between the drill string 61 and the sheathing 400H during driving and thereby supports reuse of the sheathing 400H.

As shown at FIG. 48, the penetrator 200H is positioned at a distal end of an elongate load-transferring assembly 58 that includes the drill string 61 and is configured to be driven into the ground 90 to install the heat exchanger tubing 110. In certain embodiments, the penetrator 200H and/or the housing 250H are configured to protect a fluid return 150 at a distal end portion of the heat exchanger 100H while the tube legs 110A and 110B extend proximally from the fluid return 150 and are paid out from one or more spools 560.

FIG. 49 is a cross-sectional plan view of FIG. 48 and further illustrates the guide 292 positioned between the drill string 61 and the sheathing 400H. FIG. 49 further illustrates a coupling joint 68 of the drill string 61 and a joint lock 66 configured to inhibit loosening of the coupling joint 68 during driving. In certain embodiments, the joint lock 66 is used to maintain coupling integrity while torque, vibration, and/or impact loads are transmitted through the drill string 61.

FIG. 50 is a partial cross-sectional elevation view of FIG. 48 and further illustrates the sheath retainer/releaser 290 configured to retain one or more sheath retaining tabs 420 (not shown at FIG. 50) of the sheathing 400H during installation. In certain embodiments, the sheath retainer/releaser 290 restrains the sheathing 400H relative to the housing 250H and/or the driver connector body 270H (e.g., the housing connector) to allow the tubing 110 to be installed while maintaining the sheathing 400H positioned around the tubing 110.

FIG. 51 is a partial cross-sectional elevation view of FIG. 48 and further illustrates a multi-thread-start coupling joint 68P (i.e., a multi-thread-start drive coupling) connecting the drill string 61 to the driver connector body 270H (e.g., the housing connector). In certain embodiments, the multi-thread-start coupling joint 68P includes coupling-halves 69P and is configured to provide high torque carrying capacity in a tightening direction and lower decoupling torque in a loosening direction to facilitate controlled partial and full decoupling at an installed depth. The multi-thread-start coupling joint 68P is mentioned above used in linear installation configurations.

FIG. 52 is an enlarged portion of FIG. 51 and further illustrates the multi-thread-start coupling joint 68P configured to clamp and/or release the sheath retainer/releaser 290 against the housing 250H and/or the driver connector body 270H (e.g., the housing connector) when the coupling joint 68P is respectively tightened and loosened. In certain embodiments, the coupling joint 68P is loosened (e.g., by reverse rotation of the driver 40) to cause relative movement that releases the sheath retainer/releaser 290 and thereby releases the sheath retaining tabs 420 to allow retrieval of the sheathing 400H while leaving the tubing 110 installed in the ground 90.

FIG. 53 is an enlarged partial perspective view illustrating a first portion (e.g., a male portion) of the multi-thread-start coupling joint 68P integrated with the driver connector body 270H (e.g., the housing connector). FIG. 54 is an enlarged partial cutaway perspective view illustrating a second portion (e.g., a female portion) of the multi-thread-start coupling joint 68P integrated with a drill rod 60. In certain embodiments, an adapting drill rod 60A includes a coupling-half 69P at a distal end portion and a coupling-half 69S at a proximal end portion and thereby adapts between multi-start threads 67P and single-start threads 67S along the drill string 61.

FIG. 55 is an enlarged elevation view of the guide 292 integrated with the sheath retainer/releaser 290. FIG. 56 is a cross-sectional plan view of FIG. 55 and further illustrates the guide 292 configured to maintain relative spacing between the drill string 61 and the sheathing 400H and to provide a clearance for the sheath retainer/releaser 290 to retain and release sheath retaining tabs 420 during installation and retrieval operations.

FIG. 57 is a side elevation view of an example center-driven helical penetrator assembly including the penetrator 200H with a nose portion 230, a blade portion 240, a housing 250H, and a driver connector body 270H (e.g., the housing connector) and the sheath retainer/releaser 290. In certain embodiments, the driver connector body 270H provides a load path for transmitting driving loads between the drill string 61 and the housing 250H and thereby to the blade portion 240 and/or the nose portion 230 of the penetrator 200H while also providing an interface to facilitate release of the sheath retainer/releaser 290, as described above.

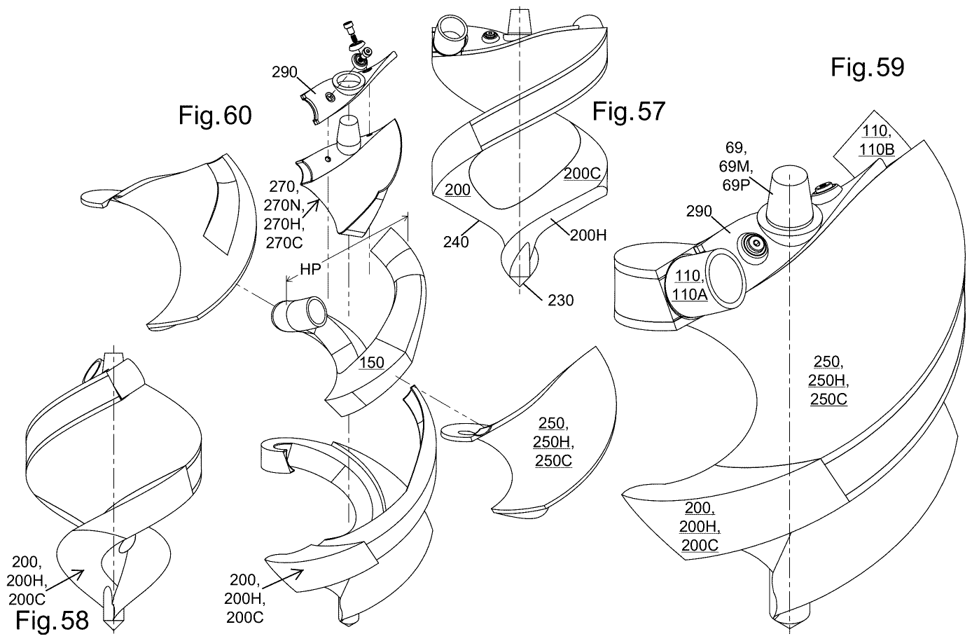

FIGS. 58-60 further illustrate the penetrator assembly of FIG. 57. FIG. 58 is a front elevation view, FIG. 59 is an enlarged perspective view, and FIG. 60 is an exploded perspective view. As shown, the penetrator 200H, including the blade portion 240, the housing 250H, and the driver connector body 270H (e.g., housing connector), and the sheath retainer/releaser 290 are configured to assemble together to protect the tubing 110 and/or the fluid return 150 during driving, to retain sheathing 400H during installation, and to permit release and removal of the sheathing 400H after installation.

FIG. 61 is a side elevation view of an alternate center-driven helical penetrator assembly illustrating an interlocking arrangement between the driver connector body 270H (e.g., the housing connector), one or more housing portions of the housing 250H, and the sheath retainer/releaser 290. In certain embodiments, the interlocking arrangement facilitates assembly, reduces relative rotation between components during driving, and/or provides a controlled axial movement used to clamp and release the sheath retainer/releaser 290.

FIGS. 62-64B further illustrate the alternate penetrator assembly of FIG. 61. FIG. 62 is a rear elevation view, FIG. 63 is an enlarged perspective view, FIG. 64A is an exploded perspective view, and FIG. 64B is a perspective view of the penetrator 200H of the assembly. In certain embodiments, the penetrator 200H is configured to cut and/or displace the ground 90 while being driven by the drill string 61 and while supporting a desired spacing between tube legs 110A and 110B.

FIGS. 65-67 illustrate an example fluid return 150 of a helical heat exchanger 100H suitable for use with the alternate penetrator assembly of FIG. 61. FIG. 65 is a side elevation view, FIG. 66 is a rear elevation view, and FIG. 67 is a cutaway view of FIG. 65. In certain embodiments, the fluid return 150 is configured to provide a flow path between tube legs 110A and 110B while maintaining a reduced thickness TR relative to a tube diameter DT to facilitate a reduced housing thickness TH and a reduced overall driven cross-sectional area.

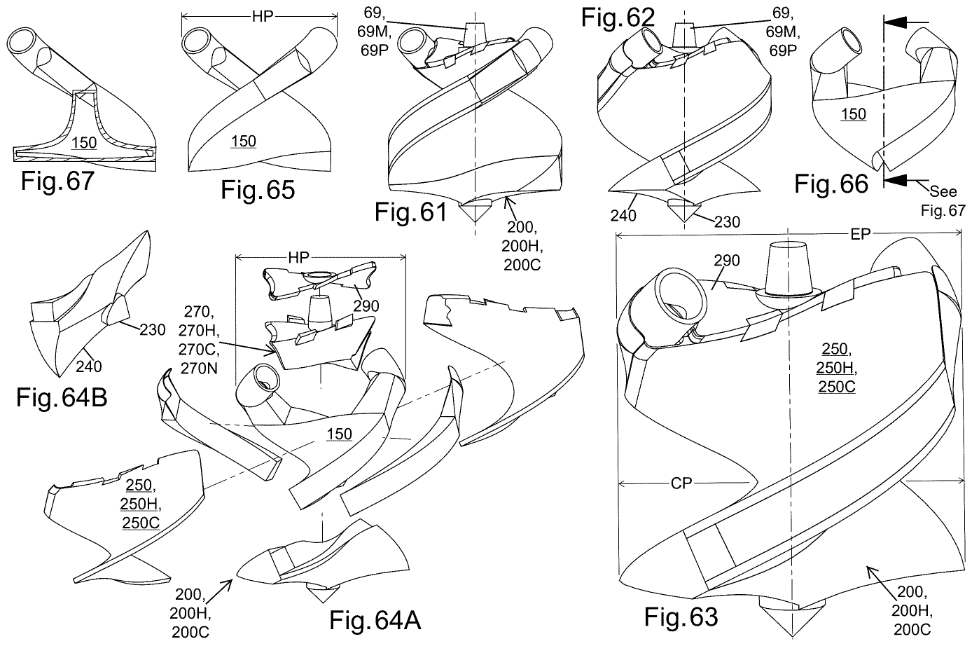

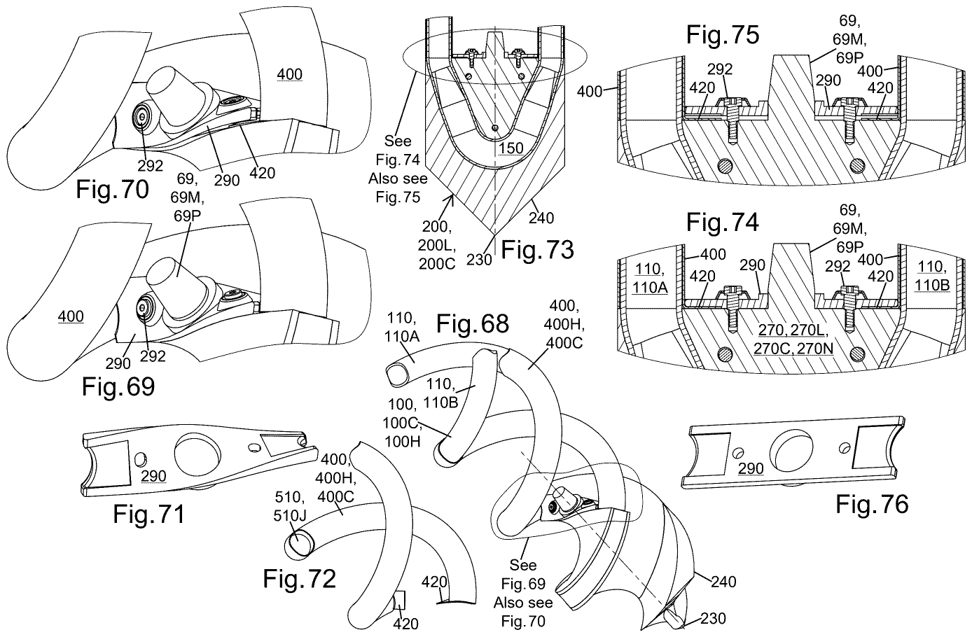

FIGS. 68-72 further illustrate an example sheath retainer/releaser 290 for a center-driven helical installation. FIG. 68 is a perspective view of the penetrator assembly with a pair of tubes 110A and 110B fluidly connected to a fluid return 150 and a pair of sheaths 400H positioned around the pair of tubes. FIG. 69 is an enlarged portion of FIG. 68 illustrating a pair of sheath retaining tabs 420 captured by the sheath retainer/releaser 290. FIG. 70 is an enlarged replacement portion of FIG. 69 illustrating the pair of tabs 420 released by the sheath retainer/releaser 290. FIG. 71 is a perspective view of the sheath retainer/releaser 290. FIG. 72 is a perspective view illustrating the pair of sheaths 400H alone. In certain embodiments, after release, the sheaths 400H are withdrawn from the ground 90 and rewound onto one or more spools 560 while the tubes 110A and 110B remain installed in the ground 90.

FIGS. 73-76 illustrate an example sheath retainer/releaser 290 configured for a center-driven linear penetrator assembly. FIG. 73 is a cutaway side elevation view illustrating a penetrator 200L with a driver connector body 270L (e.g., a housing connector), a pair of tubes 110A and 110B fluidly connected to a fluid return 150, and a pair of sheaths 400L positioned around the tubes 110. FIG. 74 is an enlarged portion of FIG. 73 illustrating a pair of sheath retaining tabs 420 captured by a sheath retainer/releaser 290 held by a coupling-half 69P of a multi-thread-start coupling joint 68P (not shown). FIG. 75 is an enlarged replacement portion of FIG. 74 illustrating the sheath retainer/releaser 290 moved away from the driver connector body 270L along one or more guides 292 to release the tabs 420 when the coupling joint 68P is loosened. FIG. 76 is a perspective view of the sheath retainer/releaser 290.

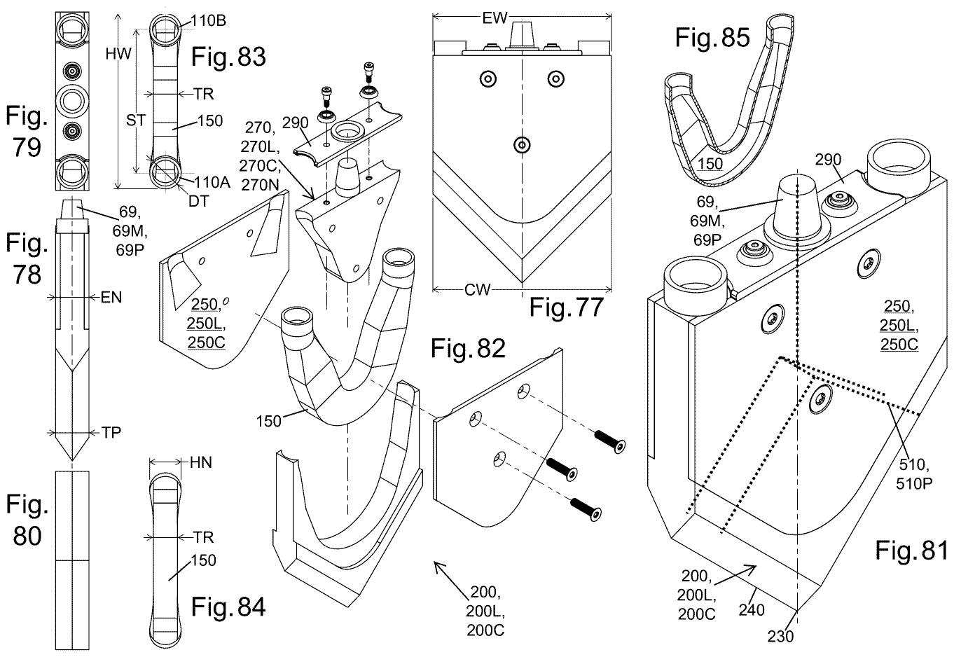

FIGS. 77-82 further illustrate an example center-driven linear penetrator assembly, shown without sheaths 400 and without extended tubing 110. FIG. 77 is a side elevation view and FIG. 78 is a front elevation view illustrating the linear penetrator 200L and associated components. FIG. 79 is a top view and FIG. 80 is a bottom view illustrating a wide cross dimension CW and a narrow cross dimension CN of the penetrator 200L. FIG. 81 is an enlarged perspective view schematically illustrating one or more fluid passages 510 including penetrator fluid passages 510P. FIG. 82 is an exploded perspective view illustrating assembly of the penetrator 200L and associated components.

In certain embodiments, the penetrator 200L is configured to be driven by axial load, vibration, and/or impact transmitted through the drill string 61, and optional fluid 96 is injected through penetrator fluid passages 510P to assist penetration (e.g., by lubrication, jetting, entrainment, and/or local fluidization of ground 90). In certain embodiments, the penetrator 200L is implemented as an integrated housing penetrator 200I such that at least a portion of a housing 250L is integral with and/or rigidly fixed to the penetrator 200L to protect the fluid return 150 during driving.

FIGS. 83-85 further illustrate an example fluid return 150 suitable for use with the linear penetrator assembly of FIGS. 73-82. FIG. 83 is the top view of FIG. 79, FIG. 84 is the bottom view of FIG. 80, and FIG. 85 is the perspective view of FIG. 82 with the fluid return 150 shown cutaway. In certain embodiments, the fluid return 150 is configured such that an outside thickness TR is less than an outside diameter DT of the tubes 110A and 110B, thereby facilitating a reduced housing thickness TH and/or reduced overall driven cross-sectional area while maintaining a desired flow area through the fluid return 150.

FIGS. 86-90 illustrate an example distal sub-assembly installed on distal portions of a first tube leg 110A, a second tube leg 110B, and a corresponding pair of sheaths 400 and configured for use in an overlapping joint driven installation system 20O (see FIGS. 35, 37A, & 39) for installing a linear geothermal heat exchanger 100L. As shown at FIG. 86, the sub-assembly includes heat exchanger tubing 110 having a first tube leg 110A and a second tube leg 110B and a fluid return 150 fluidly connecting the tube legs 110A, 110B. As further shown, the sheaths 400 are positioned around the tube legs 110A, 110B, and a distal driving member 310D of a driving assembly 300 is positioned adjacent the fluid return 150 and configured to transmit driving loads to a penetrator 200 via intermediate component(s) described below. Alternatively, the intermediate component(s) may be incorporated and/or integrated with a penetrator 200. FIG. 86 further illustrates a sheath retainer/releaser 290 configured to selectively retain and later release the sheaths 400 (e.g., via releasing sheath retaining tabs 420 electrically when an electrical current is passed through conductors that may be included in the sheaths 400 and may melt or otherwise release retaining elements).

FIG. 87 is an enlarged portion of FIG. 86 illustrating a driving flange 332F of the distal driving member 310D. In certain embodiments, the driving flange 332F provides one or more abutting surfaces configured to transfer axial compressive loads through one or more abutting joints 370 to a housing 250 and/or to the penetrator 200.

FIG. 88 is an enlarged portion of FIG. 86 illustrating a cutout in one of the sheaths 400 configured to accommodate the fluid return 150 and further illustrating a sheath retaining tab 420 extending from an end portion of the sheath 400. In certain embodiments, the cutouts prevent interference between the pair of sheaths 400 and the fluid return 150 and support minimizing a cross-sectional area driven into the ground 90.

FIG. 89 is an enlarged portion of FIG. 86 further illustrating the sheath retainer/releaser 290. In certain embodiments, the sheath retainer/releaser 290 is configured to capture and retain one or more sheath retaining tabs 420 during installation and to release the tabs 420 at an installed depth to allow withdrawal of the sheaths 400 while leaving the tubing 110 installed in the ground.

FIG. 90 illustrates the sub-assembly of FIG. 86 in an assembled configuration. In certain embodiments, the distal driving member 310D protects and supports a distal portion of the heat exchanger 100L while the heat exchanger tubing 110 is dispensed from one or more spools 560 and driven into the ground 90.

FIG. 91 illustrates an example ground loop with penetrator assembly 800 (e.g., 800L, 800O) including the sub-assembly of FIG. 86, a penetrator 200 (e.g., 200L, 200O) with a housing 250 (e.g., 250L, 250O) configured to transmit driving loads between the distal driving member 310D and a blade portion 240 of the penetrator 200 (e.g., via the housing 250) while protecting the fluid return 150 and the tubing 110. In the depicted embodiment, a piloting portion 220 of the blade portion 240 engages an interior of the housing 250 (e.g., via a penetrator blade stub insert 222). An anchor 210 is coupled to the penetrator 200 and is shown transparently and deployed. In certain embodiments, the housing 250 is configured to substantially enclose the fluid return 150 and to shield the fluid return 150 from the ground 90 during driving.

FIG. 92 illustrates the ground loop with penetrator assembly 800 of FIG. 91 cutaway to reveal and illustrate internal features and further schematically illustrates an example arrangement of fluid passages 510 through the penetrator 200. In certain embodiments, the fluid passages 510 include one or more penetrator fluid passages 510P and/or one or more housing fluid passages 510H (see FIG. 100) configured to convey fluid 96 to a distal region of the penetrator 200 (e.g., for lubrication, jetting, entrainment, and/or grout placement).

FIG. 93 illustrates the ground loop with penetrator assembly 800 in an assembled configuration and illustrates the anchor 210 in a non-transparent depiction and deployed. In certain embodiments, the anchor 210 is configured to move between a retracted orientation 216 and a deployed orientation 218 to retain the installed heat exchanger 100L in the ground 90 after withdrawal of at least a portion of the elongate load-transferring assembly 58.

FIG. 94 illustrates the penetrator 200 of FIG. 91 and schematically illustrates the fluid passages 510P. In certain embodiments, the penetrator 200 includes one or more driven surfaces on a driven flange 332F configured to receive axial loads from the housing 250 and/or from the driving assembly 300. FIG. 95 illustrates another perspective view of the penetrator 200 and further illustrates a cutting edge configured to cut and/or displace the ground 90 during installation.

FIG. 96 illustrates an enlarged elevation view of the ground loop with penetrator assembly 800 cutaway to reveal and illustrate internal features. In certain embodiments, the housing 250 is configured to minimize a housing thickness TH while protecting the fluid return 150, and the fluid return 150 is configured to provide adequate or enhanced flow area while maintaining a reduced thickness TR relative to a tube diameter DT of the tubing 110.

FIG. 97 illustrates an example driving assembly with ground loop and penetrator 900 (e.g., 900L, 900O) including the ground loop with penetrator assembly 800 of FIG. 91, a disassembled proximal driving member 310P, and a disassembled example fastener 360. In certain embodiments, the proximal driving member 310P and the distal driving member 310D form a lap joint 340 along an interface 338. In certain embodiments, the fastener 360 forms an attachment joint 366 that secures adjoining driving members 310 together to transmit loads through and/or within the driving assembly 300.

FIG. 98 illustrates the assembly of FIG. 97 in an assembled configuration and illustrates the driving assembly 300 configured without a medial driving member 310M. In certain embodiments, the penetrator 200 and/or the anchor 210 are in the retracted orientation 216 during installation, and the lap joint 340 between the proximal driving member 310P and the distal driving member 310D transmits axial compressive loads while the penetrator 200 is driven into the ground 90.

FIG. 99 illustrates the driving assembly with ground loop and penetrator 900 in a configuration including a medial driving member 310M forming a lap joint 340 with the distal driving member 310D and with the proximal driving member 310P to lengthen the driving assembly 300. In certain embodiments, the medial driving member 310M is substantially identical to other medial driving members 310M used to lengthen and shorten the driving assembly 300 in stages, as described above with respect to FIGS. 38A-38I.

FIG. 100 is a cross-sectional plan view of the assembly of FIG. 99 and further illustrates the fluid return 150, the housing 250, the sheaths 400 positioned around the tube legs 110A and 110B, and example fluid passages 510 through the housing 250 (e.g., housing fluid passages 510H) for conveying fluid 96 during installation and/or withdrawal.

FIG. 101 is a cross-sectional plan view of the assembly of FIG. 99 and further illustrates an interface 338 between the medial driving member 310M and the distal driving member 310D and an attachment joint 366 formed by the fastener 360, 360S. In certain embodiments, the attachment joint 366 is configured to be releasable and/or shearable (e.g., using the shearable fastener 360S) to allow separation of a reusable portion 740 (see FIG. 37G) of the driving assembly 300 from a distal portion that remains in the ground 90. In certain embodiments, the driving members 310 include interfacing features 350 (e.g., female interfacing features 350F and male interfacing features 350M) configured to form one or more interlocking joints 350J and thereby provide alignment and load transfer across the lap joint(s) 340. In certain embodiments, one or more fluid passages 510 extend through and/or along the driving members 310 to convey fluid 96 during installation and/or withdrawal.

FIG. 102 is a cross-sectional plan view of the assembly of FIG. 99 and further illustrates an interface 338 between the medial driving member 310M and the proximal driving member 310P and an attachment joint 366 formed by a fastener 360 installed in a pin hole 354P and a threaded hole 354T (see FIGS. 97 & 104).

FIG. 103 is a plan view of an example medial driving member 310M. In certain embodiments, the medial driving member 310M includes an interface 338 configured to overlap an adjoining driving member 310 to form a lap joint 340. In certain embodiments, the medial driving member 310M includes interfacing features 350 (e.g., 350F, 350M) and a threaded hole 354T and a pin hole 354P configured to receive corresponding portions of a fastener 360 (e.g., a threaded portion 360T and a pin portion 360P). In certain embodiments, the medial driving member 310M includes one or more protective guards 328 configured to shield the tubing 110 and/or the sheaths 400 during driving into the ground 90.

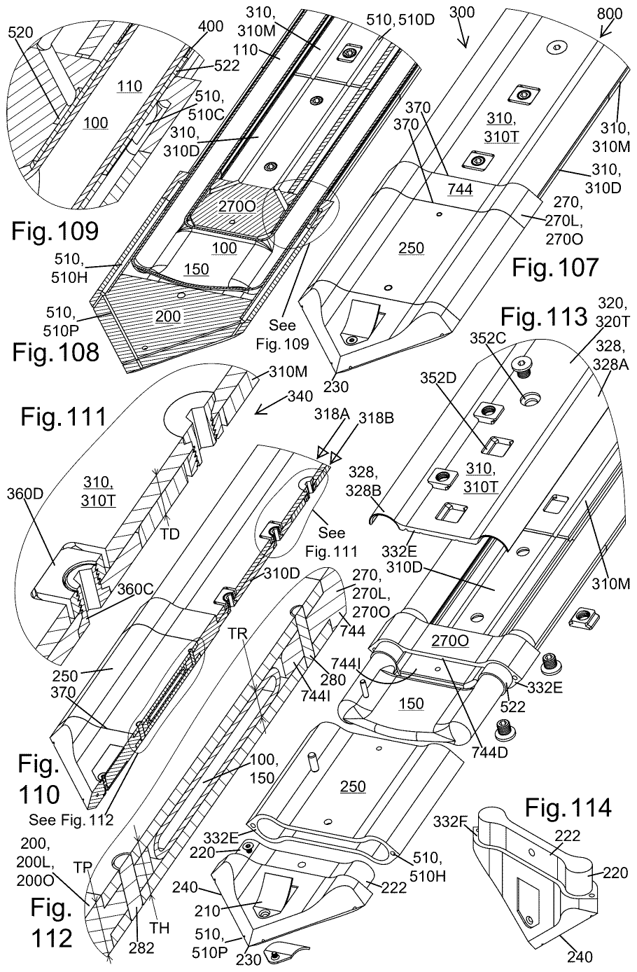

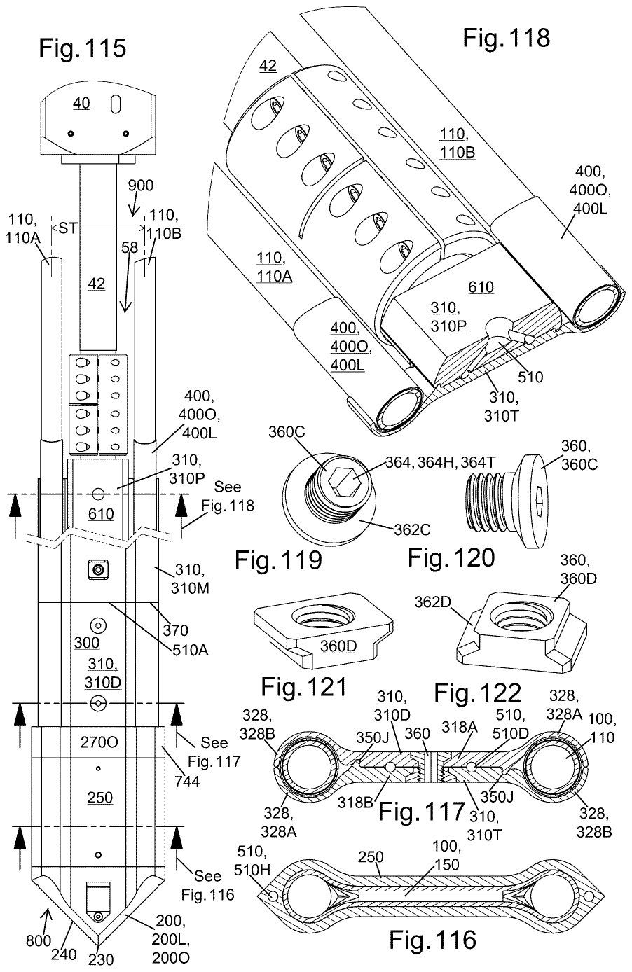

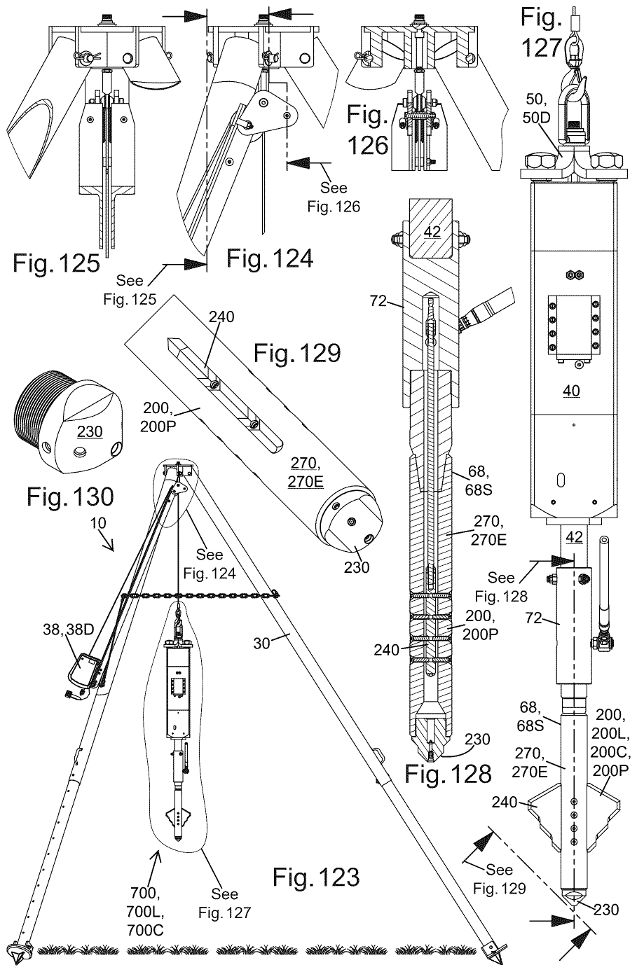

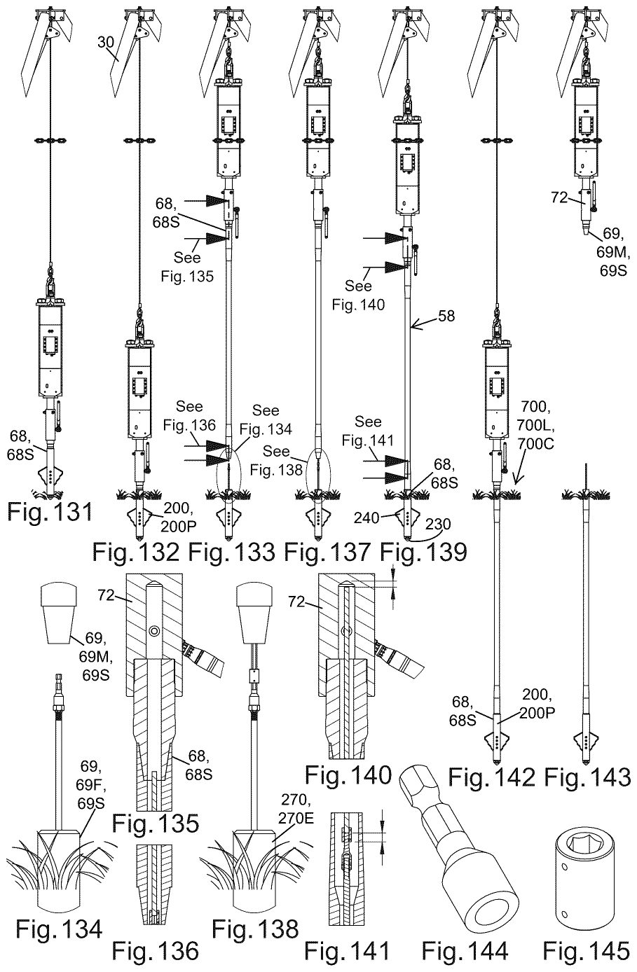

FIG. 104 is a perspective view of the medial driving member 310M and further illustrates the interface 338 and the interfacing features 350 for forming the lap joint 340.

FIG. 105 illustrates a broken perspective view of the proximal driving member 310P. In certain embodiments, the proximal driving member 310P includes an interface 338 configured to overlap an adjoining driving member 310 and includes attachment features configured to receive a fastener 360 to form an attachment joint 366. In certain embodiments, the proximal driving member 310P includes a coupling-half 69 configured to couple to a drill rod 60 and/or other component of an elongate load-transferring assembly 58.

FIG. 106 illustrates a partial cutaway perspective view of the proximal driving member 310P and further illustrates example fluid passages 510, 510D through the proximal driving member 310P. In certain embodiments, the fluid passages 510 provide a fluid path from the supply system 500 to a distal region adjacent the penetrator 200 via the driving assembly 300, thereby supporting injection of fluid 96 during installation and/or withdrawal.

FIGS. 107-118 illustrate an alternate driving assembly arrangement for an alternate ground loop with penetrator assembly 900 and further illustrate an alternate fluid passage arrangement configured to transfer fluid 96 through the driving assembly 300 to the penetrator 200 and/or to a housing 250 while accommodating the presence of the heat exchanger tubing 110, sheaths 400, and/or the fluid return 150.

As shown at FIG. 107, an alternate driving assembly 300 (i.e., an elongate load-transferring assembly 58) is configured for use with an alternate ground loop (i.e., a geothermal heat exchanger 100, e.g., a dual-tube geothermal heat exchanger including a first tube leg 110A, a second tube leg 110B, and a fluid return 150) and an alternate penetrator 200. In certain embodiments, the driving assembly 300 includes a shortened distal driving member 310D, a transitional driving member 310T, and a plurality of medial driving members 310M configured to be added and removed to lengthen and shorten the driving assembly 300. In certain embodiments, the driving assembly 300 further includes an alternate proximal driving member 310P (see FIG. 115) configured to couple to (or be impacted by) a driver 40. In certain embodiments, an alternate driver connector body 270, 270O (e.g., a housing connector) is positioned between the driving assembly 300 and a housing 250, and the housing 250 is positioned between the driver connector body 270 and a blade portion 240 of the penetrator 200. As depicted at FIG. 107, an anchor 210 of the penetrator 200 is shown at a deployed configuration 218.

FIG. 108 is the partial perspective view of FIG. 107 cutaway to a thickness-wise center of the penetrator 200 and illustrates an alternate fluid passage arrangement configured to transfer fluid 96 from the driving assembly 300 to the blade portion 240 of the penetrator 200 via the driver connector body 270, 270O (e.g., the housing connector) and/or via the housing 250. In certain embodiments, the fluid passage arrangement includes at least one compact cross-over passage 510C that crosses over the heat exchanger tubing 110 and transitions a flow path from being positioned inward of the heat exchanger tubing 110 to being positioned outward of the heat exchanger tubing 110.

FIG. 109 is an enlarged portion of FIG. 108 and further illustrates the compact cross-over passage 510C. In certain embodiments, the cross-over passage 510C includes an annular portion 520 positioned around the heat exchanger tubing 110. In certain embodiments, the annular portion 520 is formed at least partly by a sleeve 522 positioned around the heat exchanger tubing 110 to define a sealed or semi-sealed flow path for the fluid 96 across the heat exchanger tubing 110.

FIG. 110 is the partial perspective view of FIG. 107 cutaway to a width-wise center of the penetrator 200 and illustrates joint arrangements between adjacent driving members 310 of the driving assembly 300, between the distal driving member 310D and the driver connector body 270 (e.g., the housing connector), between the driver connector body 270 and the housing 250, and between the housing 250 and a blade portion 240 of the penetrator 200. As depicted at FIG. 110, the anchor 210 of the penetrator 200 is shown at a retracted configuration 216.

FIG. 111 is an enlarged portion of FIG. 110 and further illustrates an example joint arrangement between adjoining driving members 310. In certain embodiments, the joint arrangement includes an interface 338 configured to provide overlapping engagement (e.g., a lap joint 340) and one or more interfacing features 350 (see FIG. 117) configured to maintain alignment and transmit loads between the adjoining driving members 310.

FIG. 112 is an enlarged portion of FIG. 110 and further illustrates the joint arrangements between the driver connector body 270, 270O (e.g., the housing connector) and the housing 250 and between the housing 250 and the blade portion 240 of the penetrator 200. In certain embodiments, the joint arrangements include one or more piloting features 220 and one or more abutting joints 370 formed by corresponding abutting ends 332E and/or abutting flanges 332F to transmit axial compressive load between the driving assembly 300, the driver connector body 270, the housing 250, and the blade portion 240 of the penetrator 200. As depicted, the housing 250 includes female portions that receive the piloting features 220 of the driver connector body 270O and/or the blade portion 240. In other embodiments, the male-female feature(s) may be reversed and/or may be hermaphroditic. As depicted, the piloting feature 220 of the blade portion 240 includes a penetrator blade stub insert 222, and the piloting feature 220 of the driver connector body 270O includes a driver bar stub insert 744I. In other embodiments, one or more of the distal driving member 310D, the driver connector body 270, the housing 250, and/or the blade portion 240 of the penetrator 200 may be combined (i.e., integrated) together.

FIG. 113 is an exploded perspective view of the components of FIG. 107 and further illustrates assembly relationships between the driving members 310, the driver connector body 270O, the housing 250, and the blade portion 240 of the penetrator 200. In certain embodiments, the components are assembled such that the sheaths 400, the heat exchanger tubing 110, and/or the fluid return 150 are protected during driving (e.g., by the blade portion 240, by the housing 250, and/or by at least portions of the driving assembly 300, such as the guards 328).

FIG. 114 is a perspective view of the penetrator 200 of FIG. 107. In certain embodiments, the penetrator 200 includes one or more fluid passages 510P, cutting edges, and/or driven surfaces 332F and is thereby configured to penetrate the ground 90 and to receive fluid 96 and axial and/or other driving loads transmitted through the housing 250.

FIG. 115 is a side elevation view of the driving assembly 300, ground loop 100, and penetrator 200 of FIGS. 107-113 further illustrating an alternate driver 40 and an alternate elongate load-transferring arrangement 58. In certain embodiments, the elongate load-transferring arrangement 58 includes the lengthenable and shortenable driving assembly 300 connected between an output 42 of the driver 40 and the penetrator 200. In certain embodiments, the proximal driving member 310P is integrated with an adapter 610 configured to couple to the output 42 of the driver 40.

FIG. 116 is a cross-sectional plan view of the driving assembly with ground loop and penetrator 900, as configured at FIG. 115, and further illustrates the fluid return 150 and the housing 250 of FIG. 107, including the fluid passages 510 through the housing 250. In certain embodiments, the fluid passages 510 include housing fluid passage(s) 510H configured to convey fluid 96 (including grout 96G) toward a distal region of the installation.

FIG. 117 is a cross-sectional plan view of the driving assembly with ground loop and penetrator 900 as configured at FIG. 115 and further illustrates the transitional driving member 310T engaged with the distal driving member 310D, a pair of sheaths 400 positioned around the tube legs 110A and 110B, and fluid passages 510 through the driving assembly 300.

In certain embodiments, the transitional driving member 310T includes an elongated portion 320T cross-sectionally similar to or the same as the elongated portion 320M of the medial driving member(s) 310M. The transitional driving member 310T allows a length LD (see FIG. 40) of the elongated portion 320D of the distal driving member 310D (and, if another is used, the length LP of the elongated portion 320P of the proximal driving member 310P) to be significantly shorter than half of a length LM (see FIG. 37G) of the medial driving members 310M (and the elongated portion 320M thereof). For example, if the elongated portion 320D of the distal driving member 310D was one-quarter the length LM, then the transitional driving member 310T (and the elongated portion 320T thereof) would be three-quarters of the length LM, and the various abutting ends 332E and the various abutting flanges 332F would abut each other in the driving assembly 300. Thus, the added burden of introducing the transitional driving member 310T could be paid for by significantly less material being used in the distal driving member 310D. In certain embodiments, the distal driving member 310D is consumed (i.e., stays in the ground 90 after the installation is complete). In a given geothermal field, multiple distal driving members 310D could be consumed, justifying the added transitional driving member 310T part. In other embodiments where the distal driving member 310D is recovered and reused, the added transitional driving member 310T part may have less or even negative value.

FIG. 117 further illustrates a flush-mount fastener pair including a first fastener 360C and a second fastener 360D that connect pairs of the driving members 310 to each other while maintaining a low-profile exterior suitable for driving through the ground 90.

FIG. 118 is a cutaway partial perspective view of the driving assembly with ground loop and penetrator 900 as configured at FIG. 115 and further illustrates engagement between another transitional driving member 310T and the proximal driving member 310P and further illustrates fluid passages 510 and an inlet port configured to receive fluid 96 from a supply system 500. In certain embodiments, the inlet port is fluidly connected to one or more driving assembly fluid passages 510D (and thereby to the cross-over passage 510C, if used) to route the fluid 96 to one or more penetrator fluid passages 510P and/or housing fluid passages 510H.

FIGS. 119 & 120 illustrate perspective views of the first fastener 360C of the fastener pair of FIG. 117. In certain embodiments, the first fastener 360C includes a socket portion 364 configured to be engaged by a tool to tighten and loosen the fastener pair. In certain embodiments, the socket portion 364 is a thru-socket portion 364T, to facilitate tool engagement from either side, and/or a hex-socket portion 364H. The thru-socket portion 364T further allows any dirt, etc. to simply be pushed through the fastener by the tool and no picking dirt, etc. from a blind pocket is needed. In certain embodiments, the first fastener 360C includes a driving member interface 362C configured to interface with a fastener interface 352C of the driving members 310, and the driving member interface 362C comprises a tapered interface configured to promote seating and load transfer when the fastener pair is tightened.

FIGS. 121 & 122 illustrate perspective views of the second fastener 360D of the fastener pair of FIG. 117. In certain embodiments, the second fastener 360D includes a driving member interface 362D configured to interface with a fastener interface 352D of the driving members 310. In certain embodiments, the driving member interface 362D comprises a slidable interface configured to prevent rotation of the second fastener 360D during tightening and loosening of the first fastener 360C, thereby allowing single-tool installation. The slidable interface may further allow the primary axial loads (including impact loads from the driver 40) to substantially bypass the fastener pair and instead be carried/transmitted by the various abutting ends 332E and the various abutting flanges 332F of the driving assembly 300.

FIGS. 123-129 illustrate an example preinstallation system 10 configured with a tripod as the driver base 30D and a winch as part of a driver actuator set 38D for lowering and raising a driver 40 and a penetrator 200 at an installation site. Geothermal tubing installation systems 20 may also use the tripod as the driver base 30D, the winch as part of the driver actuator set 38D, the same (or different) driver as the driver 40, and the same or similar elongate load-transferring assembly 58 (see FIG. 139) and a suitable penetrator 200. The tripod may optionally serve as the spool base 30S for the systems 20. The tripod may optionally serve as the utility base 30U for the systems 10 and/or the systems 20. In the depicted service position of FIG. 123, the tripod supports the driver 40 above ground level 92 and optionally above a trench 94 (not shown at FIGS. 123-129, see FIG. 10A) such that components may be assembled, coupled, and prepared for use. In certain embodiments, the driver 40 is suspended from a winch cable and may be translated vertically along a lift path to position a distal working tool (e.g., the penetrator 200) for ground contact and subsequent penetration.

As shown at FIG. 123, a winch and cable set of the driver actuator set 38D is arranged to raise and lower the driver 40 while maintaining orientation suitable for coupling to an injection adapter 72 and for aligning the penetrator 200 at the ground level 92. In certain embodiments, the tripod includes three legs arranged around a head, and the winch is mounted to, or adjacent, the head so that a load path and cable travel are substantially centered over the penetrator 200.

FIG. 124 illustrates a pivoting mount configured to mount a drive-spool of the winch and a winch cable and optionally a cable spool to the tripod so that their positions self-adjust to any changing cable orientation/configuration as the driver 40 is raised and lowered. In certain embodiments, the pivoting mount maintains a substantially constant pulling direction relative to a pulling adapter and thereby reduces lateral loading on the tripod head and/or improves control of the suspended driver 40.

FIGS. 125 & 126 are cross-sectional elevation views of FIG. 124 and further illustrate the mounting of a hook hanger, the winch, the cable spool, and the winch cable to the driver base 30D (e.g., the tripod). In certain embodiments, the hook hanger is mounted to the pivoting mount to allow quick connect and disconnect of a cable hook (see FIGS. 166 & 168) to configure the winch cable in a block-and-tackle configuration while maintaining the capacity to rotate, pivot, and self-adjust as the driver 40 is maneuvered and/or when the elongate load-transferring assembly 58 is pulled out of the ground 90 (see FIG. 166).

FIG. 127 illustrates the driver 40 held by a hook of the winch cable and attached to a penetrator 200 via an injection adapter 72 configured to inject fluid 96 through the penetrator 200 and thereby to assist in penetration of the ground 90 (e.g., via jetting). In certain embodiments, the injection adapter 72 is connected between the output 42 of the driver 40 (directly or via an adapter 610) and a proximal end of a driver connector body 270 (i.e., a penetrator body), and a fluid hose, tube, etc. from the supply system 500 is connected to the injection adapter 72 to provide a controlled supply of fluid 96.

FIG. 128 is an enlarged cross-sectional elevation view of FIG. 127 and illustrates a proximal end portion of a fluid passage within the injection adapter 72 in fluid communication with the supply system 500 (e.g., via the fluid hose), fluid passages 510P through the driver connector body 270, a nose cone, and a blade of the penetrator 200. FIG. 128 further illustrates a distal end of the injection adapter 72 connected to a proximal end of the driver connector body 270 at a coupling joint 68 formed by coupling-halves 69 (e.g., 69M, 69F). In certain embodiments, seals within the adapter and/or the driver connector body 270 are selected to maintain fluid integrity at elevated pressures associated with jetting, as further described hereinafter. As depicted, the injection adapter 72 is illustrated as a two-piece injection adapter 72. In other embodiments, the injection adapter 72 may be one-piece, multi-piece, or a rotary union 70, 70L.

FIG. 129 is an auxiliary view of FIG. 127 that further illustrates the nose cone, the body, and the blade of the penetrator 200. In certain embodiments, the nose cone and blade include spray-nozzle orifices and/or channels that direct fluid 96 forward and/or laterally to lubricate, erode, entrain, and/or fluidize ground 90 in the vicinity of the penetrating edges, thereby reducing drive force and improving placement efficiency. During operation, the winch lowers the driver 40 until the nose cone contacts the ground 90, after which the driver 40 applies axial and/or impact loading and the optional injection adapter 72 optionally supplies fluid 96 to assist penetration into the ground 90.

FIG. 130 is a perspective view of the nose cone of the penetrator 200 of FIG. 128 and further illustrates a distribution of nozzle ports configured to discharge fluid 96 at desired angles relative to the blade. In certain embodiments, nozzle orientation and orifice size are selected to balance lubrication and cutting assistance with minimal washout around the intended drive path.

FIGS. 131-143 illustrate an example sequence of operations using a penetrator position indicator coordinated with the tripod-based preinstallation system 10. The same or similar penetrator position indicator may also be used and/or adapted to other preinstallation systems 10. Likewise, the geothermal tubing installation systems 20 may adapt or use a similar arrangement with the same or similar components, as will be further described hereinafter. As shown at FIG. 131, the winch cable lowers the driver 40 until the nose cone contacts ground level 92. At FIG. 132, the driver 40 drives the nose cone and the penetrator blade beneath the ground level 92 via the injection adapter 72 while a proximal end of the driver connector body 270 remains above the ground level 92, allowing visual confirmation of initial penetration and access to the proximal end of the driver connector body 270 to extend a penetrated depth with the elongate load-transferring assembly 58.

FIGS. 133 & 134 illustrate the injection adapter 72 separated and raised from the proximal end of the driver connector body 270 to permit connection of a drill rod 60 (i.e., the elongate load-transferring assembly 58) at a coupling joint 68 and to expose a distal rod of the penetrator position indicator that extends above the proximal end of the driver connector body 270. In certain embodiments, the penetrator position indicator comprises two or more sections that couple at an indicator joint and that translate and rotate together to reflect relative motion between the coupling joint(s) 68 and the penetrator 200. (Upon the coupling joint(s) 68 being tightened, there should be no rotational relative motion.) Thus, the penetrator position indicator thereby monitors joint integrity (e.g., loosening) during driving and pulling out the elongate load-transferring assembly 58 (e.g., the drill string 61) into and out of the ground 90.

FIGS. 135 & 136 are cross-sectional elevation views of FIG. 133 and illustrate that a proximal end of an extension rod of the penetrator position indicator is spaced from a proximal end of a fluid passage at the injection adapter 72 by a clearance and that a distal end of the extension rod may be temporarily held (e.g., by tape) at a distal end of the drill rod 60 to facilitate assembly and subsequent release from the interior of the drill rod 60.

FIGS. 137 & 138 illustrate that the distal end of the extension rod drops from the distal end of the drill rod 60 after removal of the temporary holder (e.g., the tape) and rotationally and translationally couples with a proximal end of the distal rod of the penetrator position indicator. In certain embodiments, the indicator joint is shaped to provide a keyed engagement that resists rotation relative to the adjacent rods and that provides an audible or tactile confirmation of connection.

FIG. 139 illustrates the driver 40, the injection adapter 72, and the drill rod 60 having been lowered by the winch cable and connected with the proximal end of the penetrator 200 (e.g., the distal end of the drill rod 60 connected to the proximal end of the driver connector body 270 (i.e., the penetrator body) at a coupling joint 68). FIGS. 140 & 141 are cross-sectional elevation views of FIG. 139 and illustrate that the proximal end of the extension rod of the penetrator position indicator is spaced from the proximal end of the fluid passage by an end clearance and that the indicator joint is positioned within an enlarged bore portion of the drill rod 60 (to allow low-restriction fluid flow). A separating distance of the indicator joint is greater than the end clearance such that the indicator joint remains assembled during operation without requiring separate fasteners at the indicator joint.

FIG. 142 illustrates that the driver 40 has been lowered by the winch cable and thereby the penetrator 200 has been driven farther beneath ground level 92 with a proximal end of the drill rod 60 remaining above ground level 92 for monitoring and access for additional coupling operations. In certain embodiments, fluid 96 continues to be supplied through the injection adapter 72 and through the penetrator fluid passages 510P to assist penetration by lubrication, jetting, and/or local fluidization of the ground 90.

FIG. 143 illustrates that the injection adapter 72 has been separated and raised from the proximal end of the drill rod 60 by the winch cable to make way for another drill rod 60 with another extension rod of the penetrator position indicator therein, thereby allowing an extension cycle of the elongate load-transferring arrangement 58 to repeat as desired. In certain embodiments, the tripod, the driver 40, the injection adapter 72, the drill string 61, and/or the winch are subsequently used to install a dual-tube linear geothermal heat exchanger 100L along the prepared path, with the penetrator position indicator continuing to provide confirmation of coupling joint condition during drive-in and pull-out.

As shown at FIGS. 123-143, the tripod-based preinstallation workflow provides a compact, low-headroom method of preparing an installation path using controlled lowering, fluid-assisted penetration via the injection adapter 72, and coupling monitoring via the penetrator position indicator. The pivoting mount 124 maintains alignment between the driver base 30D and the lifting/pulling direction, and the hook hanger allows rapid connection and reconnection of the cable hook when extra pulling force is needed. These features may be combined with the earlier-described center-driven and overlapping joint-driven installation systems to reduce staging area requirements, to avoid costs of mobile equipment, to reduce impact to the installation site (e.g., less or no landscape damage) and to extend applicability to space-constrained installation sites.

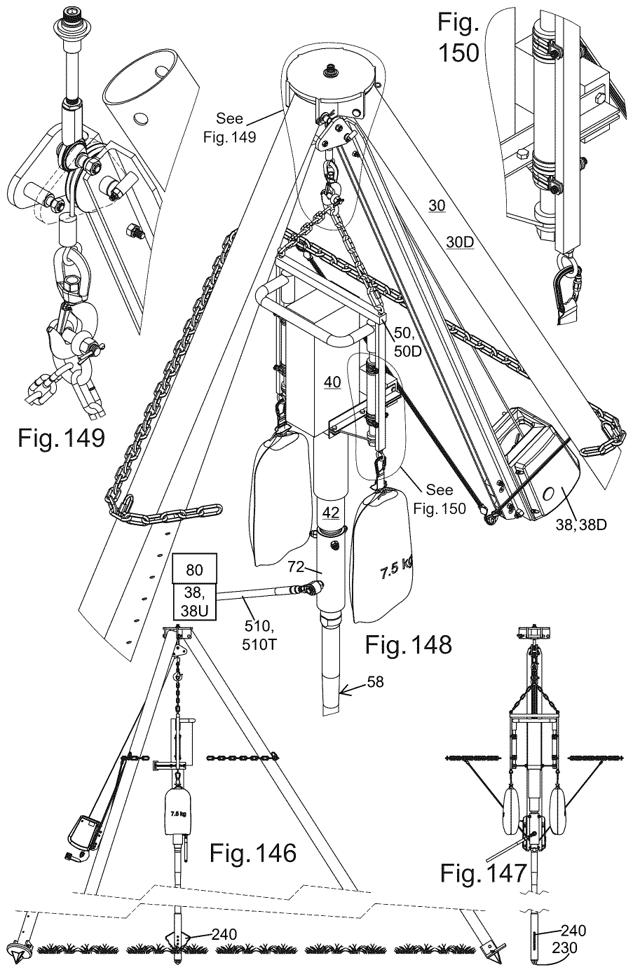

FIG. 144 illustrates an adapter suitable for use at the proximal end of the distal rod of the penetrator position indicator and configured to couple with a complementary coupling (e.g., a hex coupling of FIG. 145) of an extension rod. In certain embodiments, the adapter provides a keyed interface that transmits rotational displacement from the distal rod to the extension rod(s) while permitting axial assembly and disassembly and placement within the enlarged bore portion of the drill rod 60 without the use of tools at the installation site.

FIG. 145 illustrates a coupling suitable for use at the distal end of the extension rod(s) of the penetrator position indicator and configured to join to the adapter of FIG. 144 (or to a hex male extension) to form the indicator joint. In certain embodiments, the coupling includes a locking geometry that resists inadvertent separation during driving and a release geometry that allows disassembly when the penetrator position indicator rods are removed from the drill string 61.

As shown at FIGS. 144 & 145, the adapter and coupling permit the indicator rods to be modularly extended or shortened in coordination with drill rod additions or removals, thereby preserving the function of the penetrator position indicator throughout the preinstallation sequence. In certain embodiments, a through-opening remains clear adjacent the indicator rods and joints to allow fluid 96 to be delivered through the drill string 61 without significant obstruction when the injection adapter 72 is connected upstream.

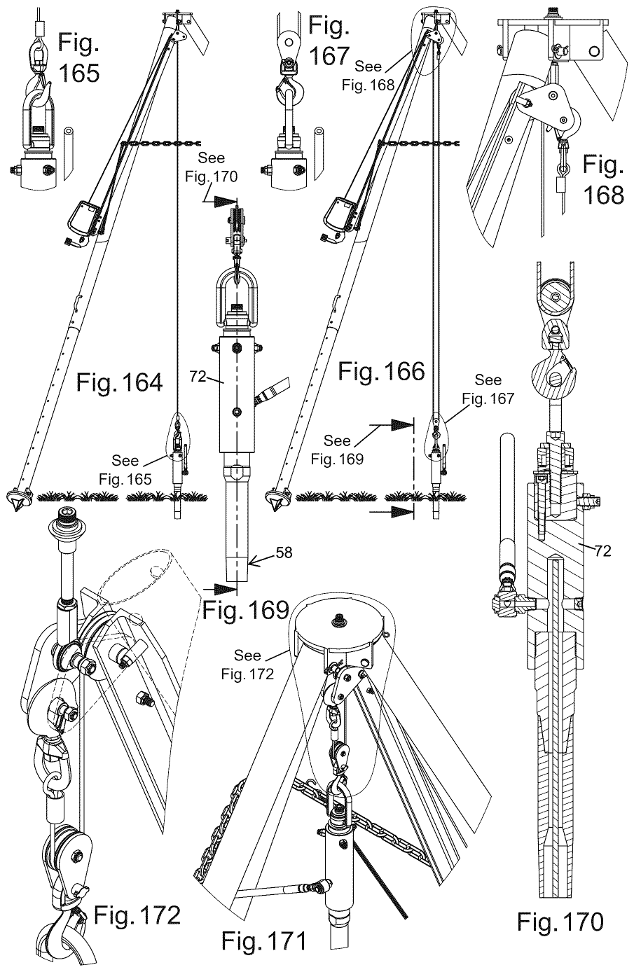

In operation, the tripod-based arrangement may also be reconfigured with downstream pulling accessories and/or block-and-tackle arrangements (described hereinafter with reference to FIGS. 164-172) to extract the penetrator 200 and/or drill rods 60 from the ground 90 after preinstallation and heat exchanger installation. The modularity of the indicator rods and the lifting accessories, combined with the pivoting mount 124, facilitates a controlled transition from drive-in to retrieval (i.e., pull-out) without excessive repositioning of components at the installation site and further facilitates an efficient transition from preinstallation operations to heat exchanger installation operations.

FIGS. 146-150 illustrate an alternate driver arrangement connected to the driver base 30D (e.g., the tripod) via a dynamic suspension and/or including weight(s) to assist in penetration of the ground 90 in the preinstallation system 10. The alternate driver arrangement of FIGS. 146-150 is also suitable for use and/or adaptation in geothermal tubing installation systems 20, as will be further described hereinafter. FIG. 146 is a side elevation view similar to FIG. 123 but with a tripod leg stabilizer chain partially cut away instead of one of the tripod legs being partially cut away and with the penetrator nose cone having penetrated the ground level 92 and the penetrator blade contacting the ground level 92. FIG. 147 is a broken elevation view projected off of FIG. 146 with the tripod legs hidden and the stabilizer chain partially cut away and/or hidden. FIGS. 148-150 are enlarged partial cutaway perspective views further illustrating a spreader bar and rigging connected to a pair of brackets, a pair of weights respectively connected to the pair of brackets, a pair of dynamic driver mounts respectively connected between the pair of brackets and the alternate driver 40, and a third weight mounted to the alternate driver 40 by a third bracket. The fluid supply tubing from the supply system 500 is connected to the injection adapter 72. In certain embodiments, the combination of the weights and the dynamic driver mounts forms a mass-spring and/or damper arrangement that allows the alternate driver 40 to oscillate relative to the tripod while keeping the penetrator 200 aligned with the intended drive path.

As shown at FIGS. 148-150, the spreader bar and rigging are supported by the winch cable hook and couple the weights and dynamic driver mounts to the tripod head. The dynamic driver mounts and brackets allow the alternate driver 40 to move vertically while constraining lateral movement, thereby transferring the majority of impact and vibratory energy into the penetrator 200 and the ground 90 via an elongate load-transferring assembly 58 while reducing transmitted vibration to the tripod. In certain embodiments, the magnitude and distribution of the weights, the spring rates of the dynamic driver mounts, and/or damping characteristics of the dynamic driver mounts are selected to tune the dynamic suspension to a desired operating characteristic of the alternate driver 40 so that the systems 10, 20 can operate efficiently and/or with low noise transmission while still delivering sufficient impact energy, vibration energy, etc. to drive the penetrator 200.

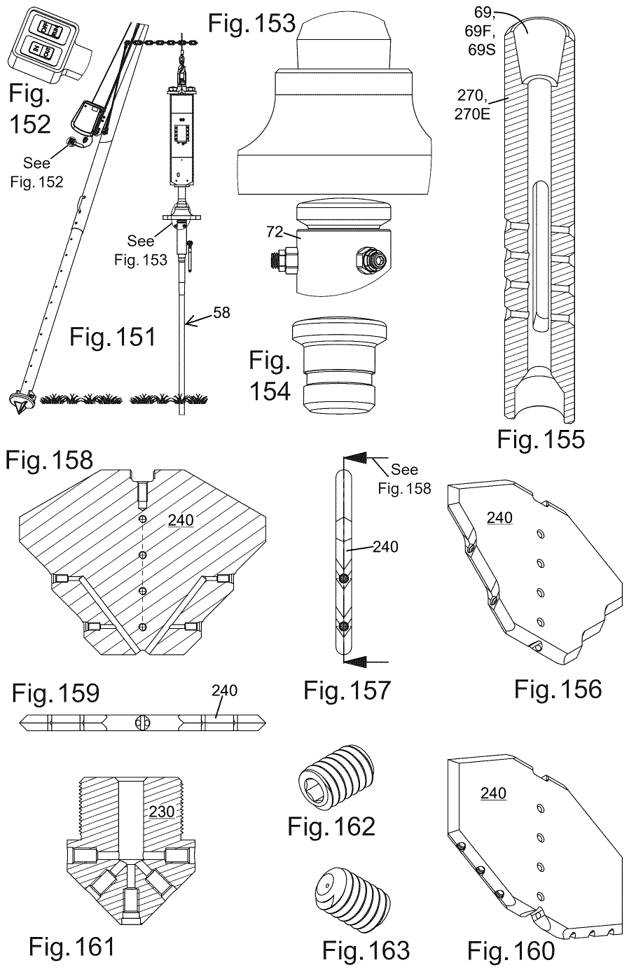

FIGS. 151, 153, & 154 illustrate another alternate driver arrangement for the preinstallation system 10. The alternate driver arrangement of FIGS. 151, 153, & 154 is also suitable for use and/or adaptation in geothermal tubing installation systems 20, as will be further described hereinafter. FIG. 151 is a portion of the cutaway side elevation view of FIG. 123, but with another alternate driver 40 connected to the driver base 30D (e.g., the tripod). In this configuration, the alternate driver 40 includes a compacting plate configured to contact a drive cap mounted to the injection adapter 72. The compacting plate of the driver 40 repeatedly impacts the drive cap, which in turn transmits driving loads into the injection adapter 72 and the penetrator 200 (e.g., thereby driving the penetrator 200 into the ground 90 via the elongate load-transferring assembly 58). FIG. 152 illustrates an operator control interface configured to control the winch, utilities, and/or the alternate driver 40 and may further regulate impact rate and energy, etc. The same or a similar operator control interface may be used in the various systems 10, 20. FIG. 153 is an enlarged portion of FIG. 151 illustrating the drive cap mounted to the injection adapter 72 and the compacting plate of the alternate driver 40. FIG. 154 is a perspective view of the drive cap illustrating an upper impact surface configured to engage the compacting plate and a lower coupling interface configured to connect to the injection adapter 72 and/or otherwise connect to the elongate load-transferring assembly 58 and the penetrator 200. In certain embodiments, this arrangement allows use of commercially available plate compactors, driving plates, hammers, etc. as drivers for the systems 10, 20. For example, a commercially available hammer fitted with a compacting plate may be attached to a skid steer loader, a pile driver, etc. and be used to drive the penetrator 200 into the ground 90 via the elongate load-transferring assembly 58 and the drive cap.

FIG. 155 is a cutaway perspective view of a driver connector body 270, 270E (e.g., the body of the penetrator 200 of FIG. 128 that includes a connection, via the elongate load-transferring assembly 58, ultimately to the driver 40) illustrating a central bore that serves as an internal fluid passage 510P routed along a length of the body 270. In certain embodiments, the central bore directs fluid 96 toward a nose portion 230 (e.g., a nose cone) and/or a blade 240 of the penetrator 200. FIGS. 156-159 further illustrate the blade 240 of the penetrator 200. FIG. 156 is a perspective view of the blade 240, FIG. 157 is a front elevation view, FIG. 158 is a cross-sectional elevation view of FIG. 157 illustrating fluid passages 510P through the blade 240, and FIG. 159 is a bottom plan view. The blade 240 may include one or more cutting edges and a plurality of outlets for fluid 96 so that, during penetration, the blade 240 both cuts the ground 90 and delivers fluid 96 to lubricate, erode, or fluidize the ground 90 adjacent the cutting edges. FIG. 160 illustrates an alternate blade configuration that may be substituted for the blade 240 of FIGS. 156-159 to adapt the penetrator 200 for different soil conditions (e.g., harder or more abrasive formations).

FIG. 161 is a cutaway side elevation view of the nose portion 230 of the penetrator 200 (see FIGS. 128-130) illustrating a plurality of spray-nozzle ports and the fluid passages 510P that feed the ports. FIGS. 162 & 163 are perspective views of a spray nozzle/orifice suitable for insertion into the spray-nozzle ports of FIG. 161. In certain embodiments, the spray nozzles are removable and interchangeable and are selected to provide a desired spray pattern, orifice size, and discharge angle relative to the penetrator axis. This allows the operator to tune the jetting characteristics (e.g., more forward-directed for hard layers or more lateral for loosening and fluidizing soil around the penetrator 200), to balance effective cutting and lubrication with limited washout around the intended drive path, and to minimize or eliminate plugging with ground particles as the penetrator 200 is driven into the ground 90.

FIGS. 164-172 illustrate a pulling configuration of the tripod-based arrangement used to remove the penetrator 200 and/or the drill rods 60 from the ground 90 after preinstallation and/or heat exchanger installation. FIG. 164 is a portion of the cutaway side elevation view of FIG. 123, and FIG. 165 is an enlarged portion thereof. As shown, a pulling adapter is connected to the injection adapter 72 and thereby to the penetrator 200 and any drill rods 60 still attached. A hoist ring on the pulling adapter is engaged by the winch cable hook so that tension in the winch cable applies an axial pulling load to the penetrator 200 and the drill rods 60. FIGS. 166 & 167 are respectively duplicates of FIGS. 164 & 165 but with the winch cable, the winch cable hook, the hook hanger of FIG. 126, and an added pulley arranged in a block-and-tackle configuration. The block-and-tackle configuration multiplies a pulling capacity of the winch so that higher extraction forces can be generated without changing the winch itself.

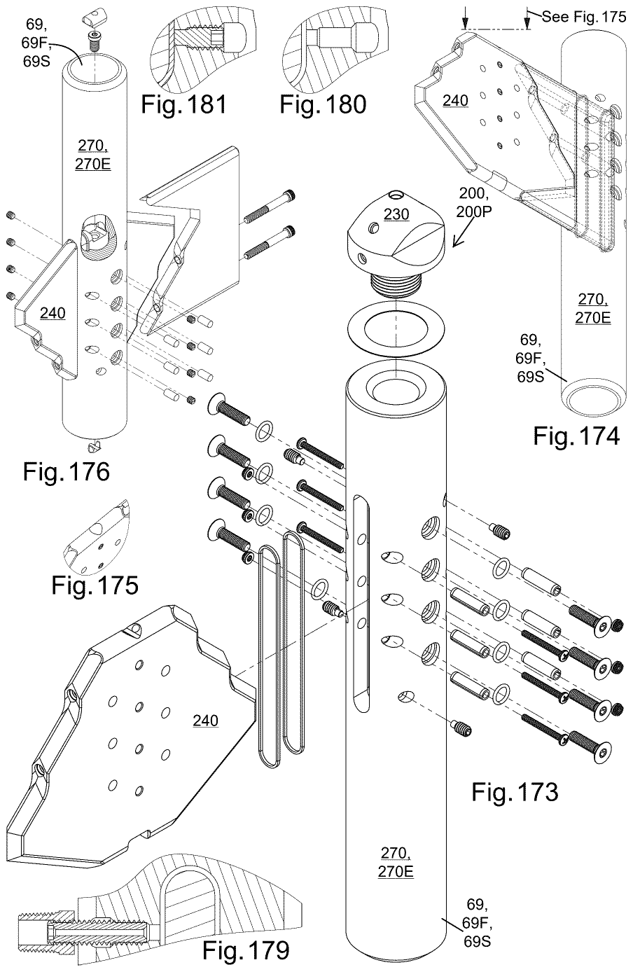

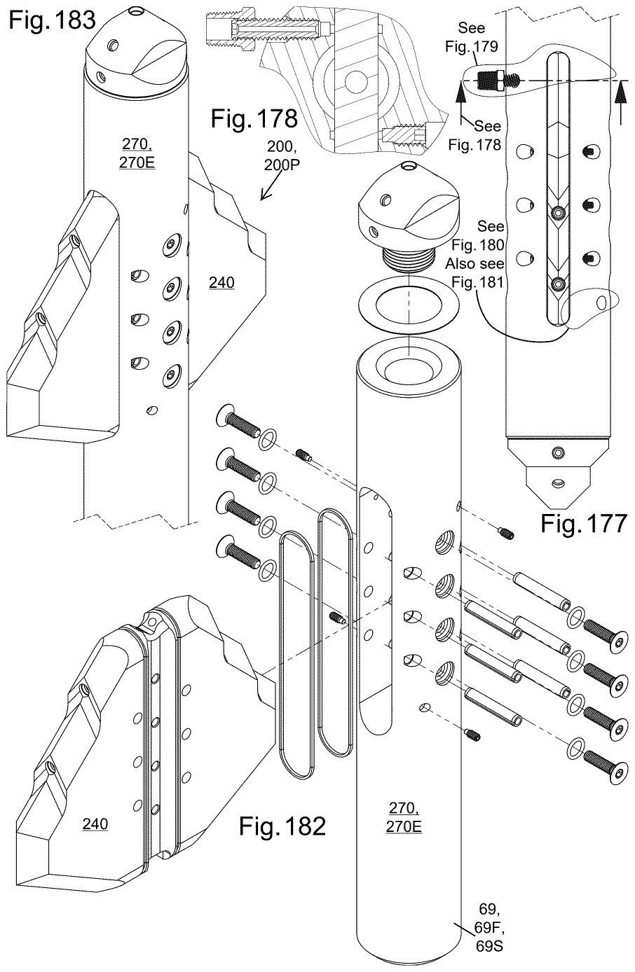

FIG. 168 is an enlarged portion of FIG. 166 and further illustrates the pivoting mount (see FIG. 124) self-adjusting to keep a pulling position and direction between the driver base 30D and the pulling adapter substantially constant with or without use of the block-and-tackle configuration. FIG. 169 is an enlarged projected partial elevation view of FIG. 166, and FIG. 170 is a further enlarged cross-sectional elevation view of FIG. 169. These views illustrate how the pivoting mount, the hoist ring, and the hook hanger cooperate to allow the winch cable and pulley arrangement to rotate and pivot as needed so that the pulling force remains substantially aligned with the penetrator axis, thereby reducing bending loads on the drill rods 60 and on the tripod. FIG. 171 is a portion of FIG. 148 but illustrating the block-and-tackle pulling configuration of FIGS. 166-170. FIG. 172 is an enlarged portion of FIG. 171, similar in perspective to FIG. 149 but with the tripod head and two of the three legs hidden and the third leg shown as transparent. As shown, the pivoting mount accommodates changes in cable angle during pulling and maintains a consistent load path substantially free of binding, thereby facilitating smooth extraction of the penetrator 200 and/or drill rods 60 from the ground 90 while minimizing undesirable lateral and/or binding loads.

FIGS. 173-176 illustrate an alternative penetrator 200, 200P configured for high-pressure jetting of the ground 90 and thus having robustly sealed internal fluid passages 510P and further adapted to couple at its proximal end to an injection adapter 72 (optionally via an elongate load-transferring assembly 58). In the depicted embodiment, the alternative penetrator 200 includes a driver connector body 270, 270E that includes a central fluid passage 510P and accommodates a nose portion 230 at a distal end and further accommodates a blade portion 240 at a medial obround slot. In the depicted embodiment, the driver connector body 270 and the blade portion 240 are pinned together and sealed by obround O-rings positioned within O-ring grooves (e.g., depicted as a pair of O-ring grooves around the obround slot) so that high-pressure fluid 96 can be routed to the nose portion 230 and/or the blade portion 240 without significant leakage. In certain embodiments, circular O-rings are used as crush seals under heads of flat-head fasteners that secure the blade portion 240 to the driver connector body 270 and thereby also inhibit deformation of the obround slot under pressure loads. In certain embodiments, pins (e.g., hollow spring pins captured with vibration resistant clinchable fasteners) mechanically secure the pinned joint. O-ring installation fixtures may temporarily be inserted into fluid inlet/outlet features of the blade portion 240 and/or into the obround slot to facilitate assembly while protecting the obround O-rings and thereby facilitate installation of the blade portion 240 into the slot of the driver connector body 270.

FIGS. 177-181 illustrate a variation of the high-pressure sealing arrangement in which inject-in-place seals are used instead of O-rings (or in addition to O-rings). In certain embodiments, a seal injecting tool is temporarily installed into a seal injection port of the driver connector body 270 and injects sealing material into a first sealing groove between the blade portion 240 and the obround slot (e.g., in a groove of the obround slot that may be the same as or similar to the above-mentioned O-ring groove and/or a groove around a blade portion 240), and a similar second sealing groove(s) is filled via a separate port. Vent ports may be temporarily opened to allow air to escape during injection and to confirm filling of the seal grooves and then plugged after the sealing grooves are filled. The injected seals may include elastomeric, polymeric, or hybrid materials suitable for maintaining a high-pressure seal under vibration, impact, and axial loading of the penetrator 200.

FIGS. 182 & 183 illustrate another alternative penetrator 200, 200P with high-pressure sealing of fluid passages 510P in which obround O-rings are mounted to O-ring grooves of the blade portion 240 rather than to the O-ring grooves of the driver connector body 270. In certain embodiments, circular O-rings serve as crush seals under fastener heads, and pins (e.g., hollow spring pins) secure the blade portion 240 to the driver connector body 270. A thick blade portion 240 and a thick wall thickness of the driver connector body 270 adjacent the nose portion 230 may be used to increase structural capacity in abrasive and/or hard formations of the ground 90 while jetting fluid 96 at elevated pressures.

In other embodiments, the nose portion 230 and/or the blade portion 240 are integrated with at least a portion of the driver connector body 270 so that jetting outlets and load-transfer surfaces are provided by an integrated penetrator head assembly thereby reducing or eliminating the need for seals and/or fasteners with the driver connector body 270 remaining directly or indirectly connectable to the elongate load-transferring assembly 58.

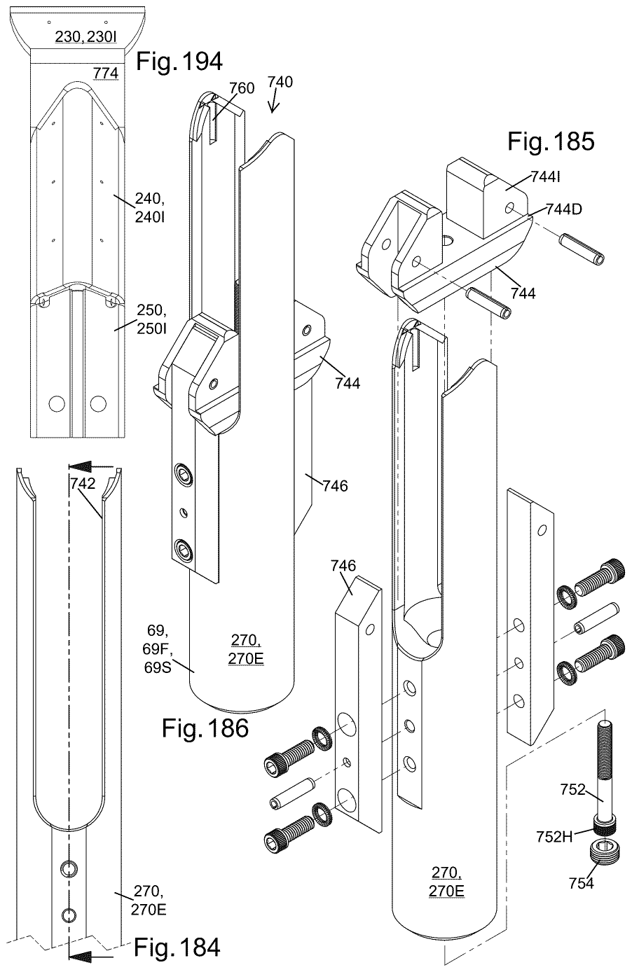

FIG. 184 is an inverted partial front elevation view of a driver connector body 270, 270E of a penetrator 200 illustrating a slot 742 open at a distal end portion of the driver connector body 270, a pair of tips adjacent a distal end of the slot 742 with a set of releasable constraints and a set of driving surfaces, and a set of attachment features adjacent a proximal end of the slot 742. The attachment features are configured to attach a driver bar 744 via a pair of connectors 746. In certain embodiments, the driver connector body 270 includes and/or partially forms fluid passage(s) 510P configured to transfer fluid 96 toward a distal end portion of the penetrator 200 (e.g., a nose portion 230, 230I and/or a blade portion 240, 240I).

FIGS. 185 & 186 each include an inverted perspective view illustrating a reusable portion 740 of a penetrator 200, where the driver bar 744 is positioned at the proximal end of the open slot 742 of the driver connector body 270, 270E and includes driving surfaces 744D. The pair of connectors 746 join the driver connector body 270 and the driver bar 744 in the depicted embodiment. A jacking/retaining arrangement 750 is constrained by the driver bar 744. A proximal end of the driver connector body 270 is connectable to the distal end of the injection adapter 72 and/or to the distal end of the drill rod 60 to form a coupling joint 68. FIG. 185 is an exploded view, and FIG. 186 is an unexploded view.

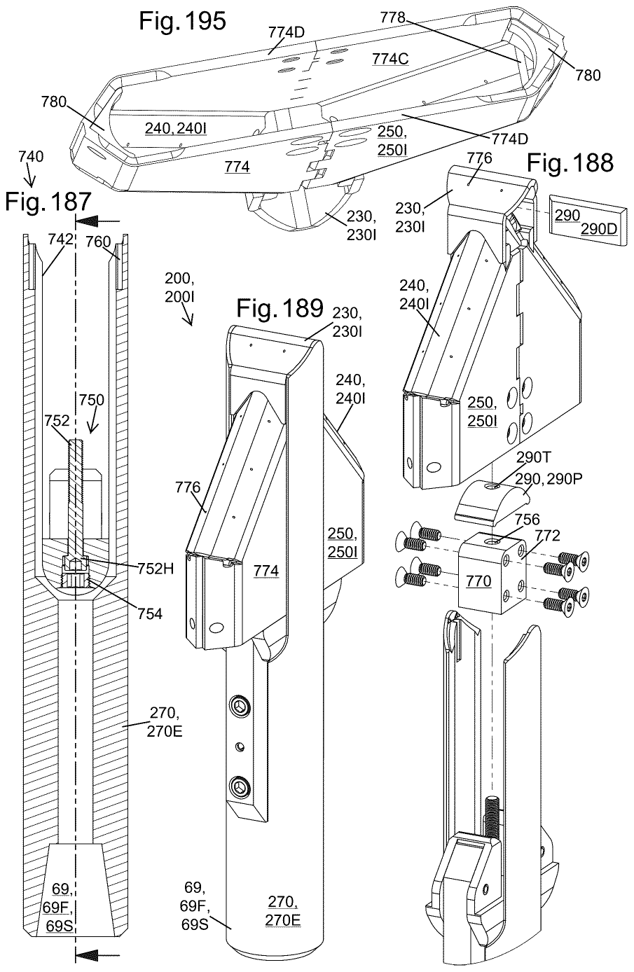

FIG. 187 is an inverted front cutaway elevation view of the reusable portion 740 of FIGS. 185 & 186 further illustrating the driver bar 744 mounted at the proximal end of the slot 742, a head 752H of an actuator screw 752 of the jacking/retaining arrangement 750 constrained by a hollow set screw 754 (i.e., a stop) within a counter bore of the driver bar 744, a pair of retaining slides 760 adjacent the set of releasable constraints, a female coupling half 69F at the proximal end of the driver connector body 270 that is connectable to the male coupling half 69M of the distal end of the injection adapter 72 and/or of the distal end of the drill rod 60 to form a coupling joint 68, and fluid passages 510P including a central bore of the driver connector body 270, a pair of branch passages that fork around a central portion of the driver bar 744, and a pair of channels that respectively continue from the pair of branch passages to the pair of tips.

FIGS. 188 & 189 each include an inverted perspective view illustrating consumable portions of the penetrator 200 including a mount member 770 that includes a jacking/retaining interface 756 and a head mount 772, a first retainer 290, 290D positioned between the pair of retaining slides 760 at the tips of the driver connector body 270, a second retainer 290, 290P positioned adjacent a distal end portion of the jacking/retaining arrangement 750, and a penetrator head 774 with an interior cavity 774C, a plurality of fluid nozzles 776, and a proximal set and a distal set of driven surfaces. In certain embodiments, the penetrator head 774 includes and integrates a nose portion 230I, a blade portion 240I, and a housing portion 250I of the penetrator 200 with each other. FIG. 188 is an exploded view, and FIG. 189 is an unexploded view.

In certain embodiments, the housing portion 250I includes at least the interior cavity 774C and is configured to protect at least a portion of the heat exchanger 100 (including, e.g., the fluid return 150 and adjacent portions of tube legs 110A, 110B) during driving into the ground 90 and further is configured to convey and/or distribute fluid 96 to the plurality of fluid nozzles 776.

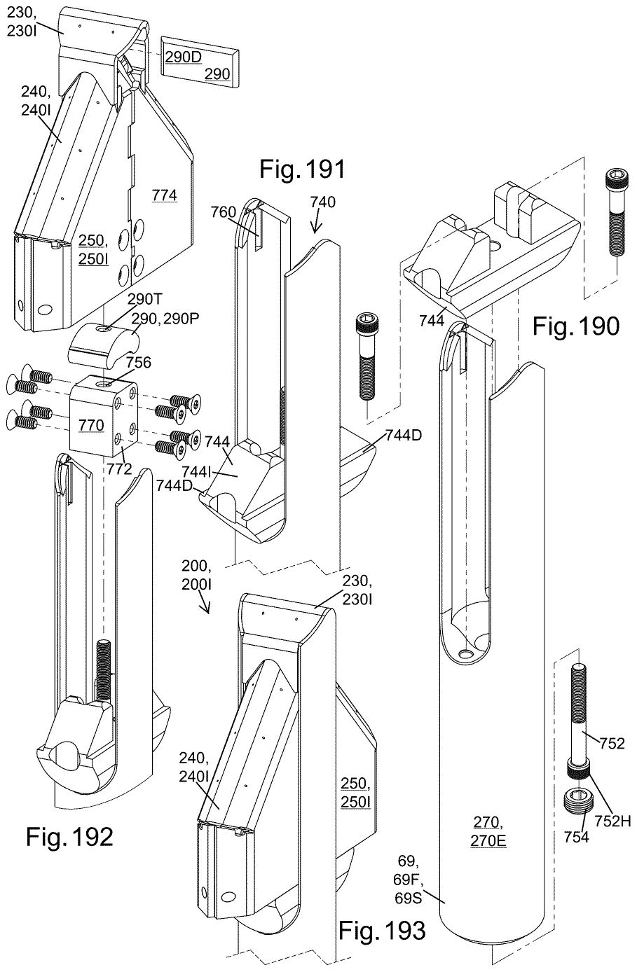

FIGS. 190 & 191 each include an inverted perspective view illustrating an alternate reusable portion 740 of the penetrator 200 similar to the reusable portion 740 of FIGS. 185 & 186 but where an alternate driver bar 744 with alternate driving surfaces 744D is joined to an alternate driver connector body 270, 270E by a pair of axial fasteners at a proximal end of the open slot 742. A proximal end of the alternate driver connector body 270 is connectable to the distal end of the injection adapter 72 and/or to the distal end of the drill rod 60 to form a coupling joint 68. FIG. 190 is an exploded view, and FIG. 191 is a partial unexploded view.

FIGS. 192 & 193 each include a partial inverted perspective view illustrating consumable portions of the alternate penetrator 200 of FIGS. 190 & 191, similar to or the same as the consumable portions of FIGS. 188 & 189, including an alternate second retainer 290, 290P positioned adjacent the distal end portion of the jacking/retaining arrangement 750. FIG. 192 is a partial exploded view, and FIG. 193 is a partial unexploded view.

FIGS. 194 & 195 are enlarged views further illustrating the penetrator head 774 of the penetrator embodiments of FIGS. 188 & 189 and FIGS. 192 & 193. FIG. 194 is an inverted front elevation view illustrating parallel side walls adapted to slide within and out of the open slot 742 of the driver connector bodies 270, an enlarged integrated tip defining the nose portion 230I that extends beyond the side walls and engages and is constrained by the set of releasable constraints and the set of driving surfaces of the pair of tips of the driver connector body 270, and an integrated pair of angled edges defining, at least in part, the blade portion 240I with the plurality of fluid nozzles 776. FIG. 195 is a perspective view illustrating the integrated interior cavity 774C defining, at least in part, an interior of the housing portion 250I, an integrated (e.g., welded-on) pair of restraining pins 778, an added-in set of fluid passage stops 780 including a pair of tube/sheath cradles, the integrated distal set of driven surfaces at the proximal side of the enlarged tip, the integrated proximal set of driven surfaces at the proximal end of the penetrator head 774, and a plurality of integrated fluid nozzles 776.

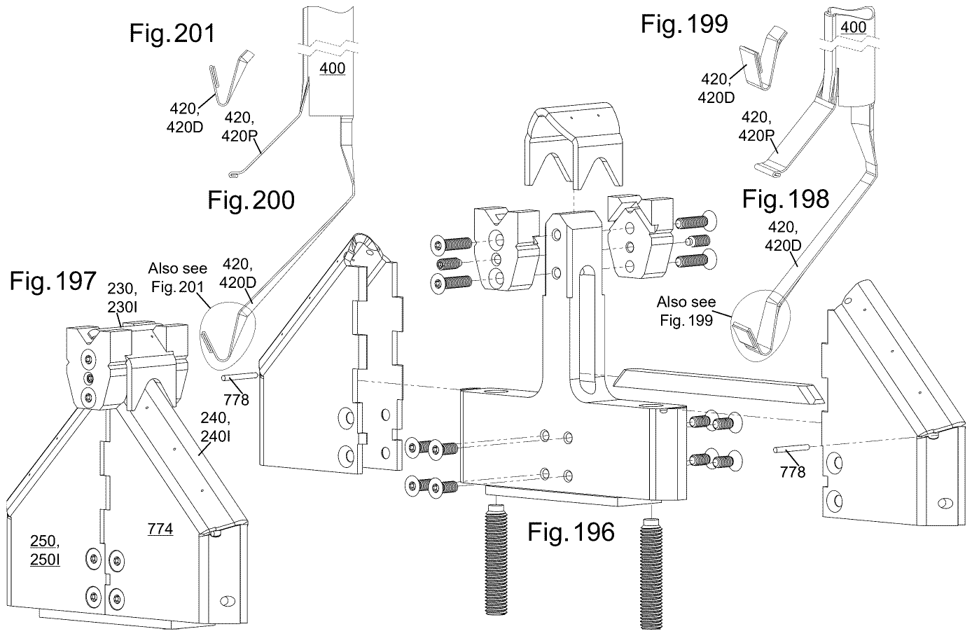

FIGS. 196 & 197 are perspective views of a weld fixture for the penetrator head 774. FIG. 196 is an exploded view illustrating that the penetrator head 774 includes a sheet metal tip, a pair of duplicate sheet metal side walls with the angled edge, and a pair of restraining pins 778, and FIG. 197 is an unexploded view illustrating the welded penetrator head 774.

FIGS. 198-201 are partial views of a pair of sheaths 400 each having a pair of sheath retaining tabs 420 extending from a tabbed end of the sheath 400 for engaging a sheath holding mechanism including the first retainer 290, 290D and/or the second retainer 290, 290P. In certain embodiments, ends of the tabs 420 are thickened (e.g., by sewing and/or bonding multiple layers of sheath fabric) and the thickened ends are selectively trapped by the first retainer 290D and/or the second retainer 290P. In certain embodiments, the sheath 400 is gathered or bunched to provide increased annular area between the sheath 400 and the heat exchanger tubing 110, e.g., when filled with fluid 96, 96G.

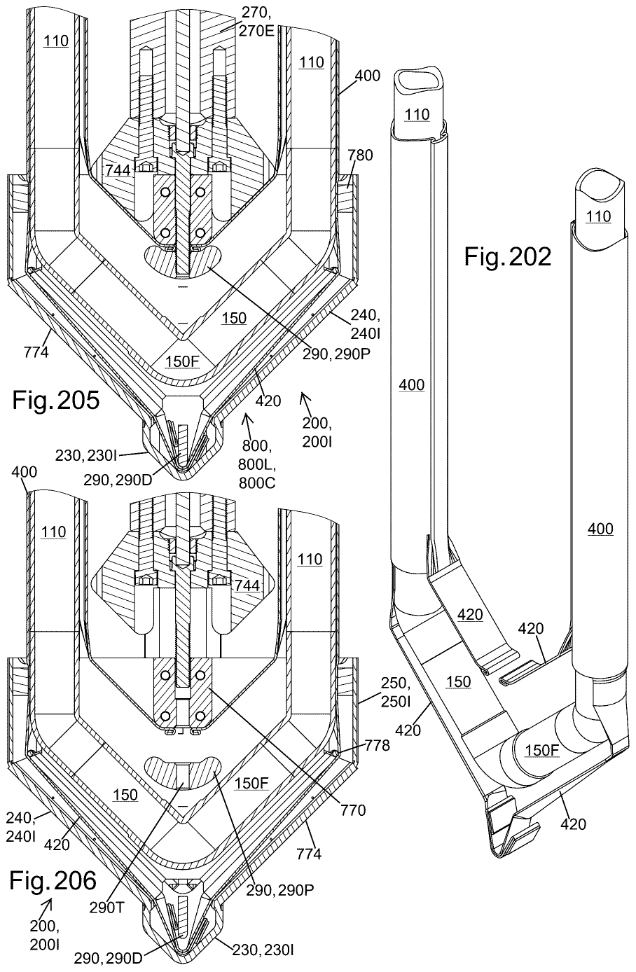

FIG. 202 is a partial perspective view of the pair of sheaths 400 installed over a pair of heat exchanger tube leg portions 110A, 110B that are butt-welded (i.e., butt-fused) to a three-fitting fluid return 150 thereby fluidly connecting the pair of tube legs 110A, 110B.

FIGS. 203 & 204 each include a partial perspective view illustrating an alternate heat exchanger suitable for use with the penetrator embodiments of at least FIGS. 188, 189, 192, 193, & 205-212, where an alternate fluid return 150, 150B is formed by bending a portion of the heat exchanger tubing 110. The alternate bent return 150, 150B may be joined (e.g., butt-fused) to the heat exchanger tube leg portion(s) 110A, 110B and/or may be formed along a continuous heat exchanger tube 110. Depending on the curvature of the bend, fluid passage stops 780 may be customized to fit angled/curved portions of the bent return 150B. In certain embodiments, a thickness TR of the alternate fluid return 150 is reduced (e.g., by squeezing) during and/or separately from bending. In certain embodiments, a cylindrical shape of the heat exchanger tubing 110 may be changed to another shape (e.g., obround, oval, rectangular, etc.) via upsetting, hot upsetting, blow molding, swaging, etc. and/or combinations thereof. For example, the cylindrical shape of a portion of the heat exchanger tubing 110 may be bent and transformed into the fluid return 150 illustrated at FIGS. 82 & 85. Heat, molding, internal pressure, and/or external pressure may be applied to the heat exchanger tubing 110 to facilitate the bending, the reduction in thickness TR, wall thickness change, and/or the cross-sectional change. A bending angle typically extends to 180°. By forming the bent return 150B and/or the transformed cross-section return 150 from the heat exchanger tubing 110, fusing (e.g., butt-welding) a return 150 to the heat exchanger tubing 110 may be unnecessary.

FIGS. 205-212 generally illustrate a same penetrator assembly and a same heat exchanger assembly including the pair of sheaths 400 substantially installed over the pair of heat exchanger tube leg portions 110A, 110B with at least a portion of the sheaths 400 and a portion of the heat exchanger 100 within the interior cavity 774C of the penetrator head 774. Alternatively, the sheaths 400 may be absent (e.g., for heat exchanger 100 installation in soft and/or slippery soil and/or if suitably strong material is used in the heat exchanger 100 and/or leg portions 110A, 110B thereof). Alternatively, the sheaths 400 may be connected to the penetrator head 774 but not necessarily present within the interior cavity 774C.

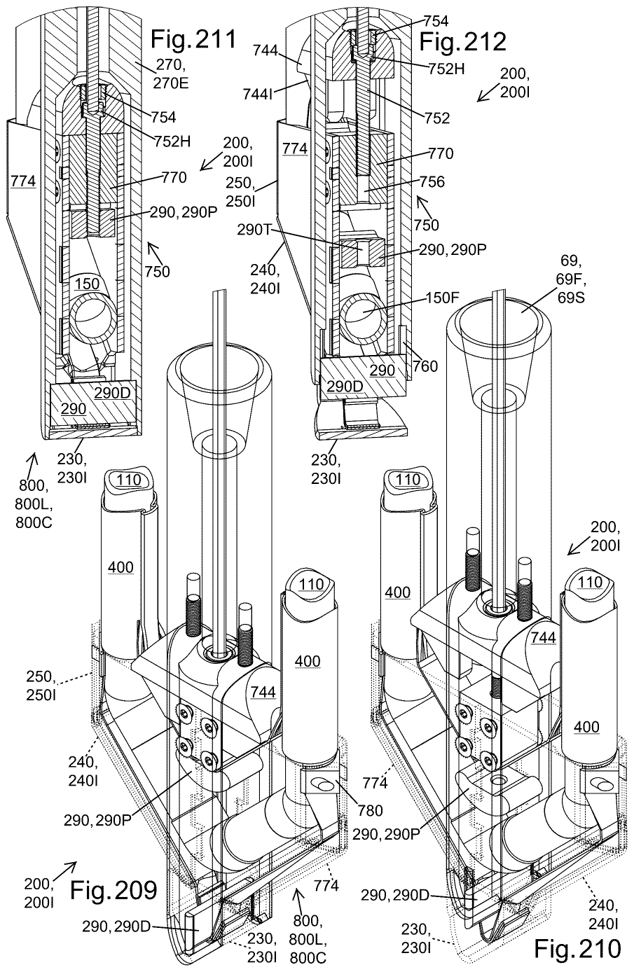

FIGS. 205-212 further illustrate selective retaining and releasing of the pair of sheaths 400 and a method of remotely actuating the jacking/retaining arrangement 750. FIGS. 205 & 206 each include a partial cutaway side elevation view of the same penetrator assembly and the same heat exchanger assembly respectively at the retained and the released configurations. At FIGS. 207-210, the driver connector body 270 of the penetrator 200I is shown as transparent, and the penetrator head 774 of the penetrator 200I is shown as transparent and in dotted-line. FIGS. 211 & 212 are perspective cutaway views. FIGS. 205, 207, 209, & 211 show both the proximal set and the distal set of driving surfaces and the corresponding driven surfaces engaged and shows the pair of sheaths 400 retained, and FIGS. 206, 208, 210, & 212 show both sets of the driving and driven surfaces disengaged from each other and the pair of sheaths 400 released. FIGS. 209 & 210 illustrate a hex drive shaft extending through the hollow set screw 754 and engaging the head 752H of the actuator screw 752 and further illustrate loosening and unscrewing the actuator screw 752 from threads of the jacking/retaining interface 756 to jack the driver bar 744 away from the penetrator head 774 and facilitate disengagement and sheath release. FIGS. 211 & 212 further illustrate the first retainer 290D sliding between the pair of retaining slides 760 at the tips of the driver connector body 270 and the second retainer 290P sliding within and between parallel side walls of the penetrator head 774. In certain embodiments, releasing and/or jacking facilitates removal of the reusable portion 740 of the penetrator 200 from the ground 90 while leaving the penetrator head 774 (including the integrated nose portion 230I, blade portion 240I, and housing portion 250I) in the ground 90 with the heat exchanger 100.

FIGS. 205, 207, 209, & 211 illustrate the pair of sheaths 400 attached to the penetrator 200, 200I and the consumable portions of the penetrator 200, 200I attached to the reusable portions 740 of the penetrator 200, 200I. FIGS. 206, 208, 210, & 212 illustrate the pair of sheaths 400 freed from the penetrator 200, 200I and the consumable portions of the penetrator 200, 200I released from the reusable portions 740 of the penetrator 200, 200I.

In certain embodiments, a first tab 420, 420D of each sheath 400 is routed past the corresponding tube/sheath cradle of the fluid passage stops 780 and past the corresponding restraining pin 778 (and constrained by the pin 778). The fluid passage stops 780 close off one or more fluid passages formed between an exterior of the heat exchanger 100 and/or the sheaths 400 and/or the cavity 774C of the penetrator head 774 (with sealant/adhesive optionally joining and/or sealing components) and thereby facilitate providing pressurized fluid flow to the plurality of fluid nozzles 776 of the penetrator head 774. In certain embodiments, the first tabs 420D of each sheath 400 are further routed past the first retainer 290, 290D positioned between the retaining slides 760 at the tips of the driver connector body 270, and thickened ends of the first tabs 420D are captured by the first retainer 290.

In the depicted embodiment, the first retainer 290D bottoms out in the retaining slides 760 (i.e., cannot move proximally in the slides 760 from a position illustrated at FIG. 205), and a rounded tip of the first retainer 290D is thereby held close to an interior fillet of the integrated nose portion 230I. As illustrated at FIGS. 205 & 211, an expandable gap is thereby created between the rounded tip and the interior fillet, and both tabs 420D are fed through and/or otherwise placed in the expandable gap from opposite directions. The feeding through and/or the placing may be accomplished before the jacking/retaining arrangement 750 engages (or fully engages) the mount member 770 and/or before the penetrator head 774 is positioned (or fully positioned). Side openings of the integrated nose portion 230I of the penetrator head 774 may be used to accomplish the feeding through and/or the placing (see FIGS. 188 & 192). Upon the penetrator 200I being fully assembled, the side openings (and the fluid passages) are closed off by the tips of the driver connector body 270E. Thus, the first tabs 420D of each sheath 400 are attached to (i.e., constrained by) the penetrator 200I, and the routing of the tabs 420D substantially avoids mechanical loading of the heat exchanger 100 by loads carried by the pair of sheaths 400 (e.g., when driven through the ground 90). The sheaths 400 may thereby further protect the heat exchanger 100.

In certain embodiments, an actuator screw 752 (e.g., a socket head cap screw) of the jacking/retaining arrangement 750 secures the jacking/retaining interface 756 (e.g., a threaded hole) of the mount member 770 and thereby secures the mount member 770 to the driver bar 744 and thereby clamps driven surfaces 774D of the penetrator head 774 to driving surfaces 744D of the driver bar 744. The above-described assembled configuration is thereby secured. The assembled configuration may be remotely disassembled via, at least in part, the penetrator position indicator and/or via extension rods thereof and/or similar extendible actuator rods including, for example, the hex drive shaft illustrated at FIGS. 209-212.

In certain embodiments, a second tab 420, 420P of each sheath 400 is routed past the second retainer 290, 290P positioned adjacent the distal end portion of the jacking/retaining arrangement 750, and thickened ends of the second tabs 420P are captured by the second retainer 290.

As depicted at FIGS. 205, 207, & 211, the actuator screw 752 of the jacking/retaining arrangement 750 further engages and thereby retains the second retainer 290, 290P at a capturing position (but does not necessarily clamp the second retainer 290). When at the capturing position, the second retainer 290P forms two capturing pockets (e.g., with the mount member 770) or otherwise forms capturing feature(s). The pair of thickened ends of the second tabs 420P are positioned within the capturing feature(s) (e.g., one of the corresponding thickened ends of the second tab 420P of each sheath 400 is positioned in each of the two capturing pockets). The placing of the thickened ends within the capturing pockets may be accomplished before the actuator screw 752 engages (or fully engages) the second retainer 290P and/or before the penetrator head 774 is positioned (or fully positioned).

FIGS. 206, 208, 210, & 212 further illustrate the mount member 770, and thereby the penetrator head 774 attached thereto, released from the jacking/retaining arrangement 750 and thereby released from the elongate load-transferring assembly 58. (The example threaded hole 756 of the mount 770 is only at a distal portion of the overall hole, as best shown at FIG. 206.) Thus, the driven surfaces 774D of the penetrator head 774 are released from the driving surfaces 744D of the driver bar 744, and the penetrator head 774 may separate from the driver connector body 270 (which is attached to the driver bar 744). The integrated nose portion 230I of the penetrator head 774 thereby separates from the tips of the driver connector body 270. As the tips of the driver connector body 270 separate from the integrated nose portion 230I, the first retainer 290, 290D (positioned between the retaining slides 760 at the tips and previously bottomed out in one or both of the slides 740) may also separate from the integrated nose portion 230I and the expandable gap between the rounded tip and the interior fillet is free to expand and thereby release the first tabs 420D of each sheath 400. The first retainer 290, 290D (positioned between the retaining slides 760 at the tips) may slide off of the retaining slides 760 and thereby not interfere with the installed heat exchanger 100 as the driver connector body 270 is removed from the ground 90.

The release of the second retainer 290, 290P frees the second tabs 420P from the second retainer 290 and thereby allows withdrawal of the second tabs 420P of each sheath 400. By first partially loosening the actuator screw 752 of the jacking/retaining arrangement 750, the retainers 290 may be released before the mount member 770 and thereby before the penetrator head 774. The heat exchanger tubing 110 may thereby be retained in the ground 90 by the elongate load-transferring assembly 58 while the sheaths 400 are withdrawn (upon releasing all tabs 420 of both sheaths 400).

FIGS. 206, 208, 210, & 212 further illustrate the second retainer 290, 290P and the mount member 770 released from the jacking/retaining arrangement 750 and thereby released from the elongate load-transferring assembly 58. (See the above-mentioned details of the threaded hole 756.) Thus, the driven surfaces 774D of the penetrator head 774 are released from the driving surfaces 744D of the driver bar 744. The release of the second retainer 290, 290P frees the second tabs 420P from the second retainer 290 and thereby allows withdrawal of the second tabs 420P of each sheath 400. By first partially loosening the actuator screw 752 of the jacking/retaining arrangement 750, the second retainer 290, 290P may be released before the mount member 770 and thereby before the penetrator head 774. The heat exchanger tubing 110 may thereby be retained in the ground 90 by the elongate load-transferring assembly 58 while the sheaths 400 are withdrawn (upon releasing all tabs 420 of both sheaths 400). The elongate load-transferring assembly 58 may thereby resist friction from the sheaths 400 urging the heat exchanger 100 from the ground 90.

As used herein, a “placing penetrator” refers to a penetrator 200 configured to be driven into the ground 90 while assembled with, and thereby placing, heat exchanger tubing 110 (e.g., any of the penetrators 200, 200I, 200H, 200L, 200C, 200O when used with a heat exchanger 100). Thus, for example, the placing penetrator embodiments include the center-driven and overlapping joint-driven penetrators described above when used to install the heat exchanger 100. As used herein, a “preinstallation penetrator” refers to a penetrator 200, 200P, 200C, 200H, 200L, 200O used to prepare and/or check an installation path prior to placing the heat exchanger tubing 110. Thus, for example, the preinstallation penetrator embodiments include the center-driven and overlapping joint-driven penetrators.

As used herein, a “driver connector body 270” refers to a penetrator body portion that is connectable (directly or indirectly) to the driver 40 and/or an elongate load-transferring assembly 58 and that transfers one or more loads (e.g., axial loads, bending loads, torsional loads, impact loads, and/or vibratory loads) to a nose portion 230, a blade portion 240, and/or a housing portion 250 of the penetrator 200. In certain embodiments, the driver connector body 270 further defines one or more internal fluid passages 510P for transferring fluid 96 toward and/or through the penetrator 200. In certain embodiments, the driver connector body 270 is reusable and is removed from the ground 90 with the elongate load-transferring assembly 58, and in other embodiments the driver connector body 270 remains in the ground 90 and thus may be considered part of the penetrator 200 and/or part of the installed assembly. The driver connector body 270, 270N may be internal (e.g., may be substantially positioned within the housing portion 250, 250I, the blade portion 240, 240I, the nose portion 230, 230I, and/or the overall penetrator head). The driver connector body 270, 270E may be external (e.g., may be substantially positioned outside the housing portion 250, 250I, the blade portion 240, 240I, the nose portion 230, 230I, and/or the overall penetrator head). A coupling-half 69 of the driver connector body 270, 270N, 270E may be a male coupling-half 69M. A coupling-half 69 of the driver connector body 270, 270N, 270E may be a female coupling-half 69F. As used herein, “housing connector” refers to a connector portion interfacing a housing 250 to the driving assembly 300.

The various components can be combined together and/or separated apart from what is depicted in the example embodiments and thereby form additional embodiments (e.g., the housing and penetrator, the adapter and proximal driving member, etc.). The reuseable components of the example embodiments may instead be consumed, and certain of the consumable components of the example embodiments may be reused. Thus, additional embodiments may be formed. (E.g., the distal driving member may be reused or may be left in the ground 90. In either case, it may be considered part of the driving assembly. The housing and/or the housing adapter may similarly be reused or consumed.) Features and/or characteristics of the various embodiments and/or optional features and/or characteristics thereof may be adapted and/or applied to other of the various embodiments and/or the optional features and/or characteristics thereof. For example, an integrated sheet metal penetrator head 774 is depicted in a center-driven embodiment but could be adapted to an overlapping joint driven embodiment. Likewise, removing the sheaths 400 from use in the installation of the heat exchanger 100 in the ground 90 is mentioned as an option for a certain embodiment but can also be applied to other embodiments and options thereof. A removal sequence of the elongate load-transferring assembly 58 and the sheaths 400 may be reversed in any of the example embodiments.

Unless otherwise indicated, all ranges recited herein include their endpoints and all subranges therebetween. As used herein, “about” or “approximately” in reference to a numeric value means within ±10% of the stated value, unless a different tolerance is expressly specified.

As used herein, “comprising” is open-ended. Conjunctions such as “and/or” are inclusive. The terms “first,” “second,” and similar ordinals are used solely to distinguish elements and do not imply order or priority.

The term “coupled” or “connected” includes direct or indirect attachment, engagement, or linkage, and can be permanent or releasable unless the context dictates otherwise. “Integral” refers to components formed as a single piece or monolithic structure.

Any features described with respect to a particular embodiment may be combined with, substituted into, or omitted from other embodiments unless such combination would be technically incompatible. Components described herein may be reused or consumed, and reuse/consumption may be varied across embodiments.

To the extent trademarks, tradenames, or commercial product references (e.g., Firestick®, EarthBuster) are used, they are provided solely for identification of components or illustrative examples and do not imply endorsement. All such marks are the property of their respective owners.

Incorporation by Reference: Any references cited herein are incorporated by reference solely for the purposes of describing exemplary systems, components, materials, or methods and not to admit such references are prior art to any claim of this application.

Means-Plus-Function: No claim element is intended to be construed under 35 U.S.C. § 112(f) unless expressly recited as “means for” performing a function and without recitation of structure. Where functional language is used, it is understood to be supported by the structures, materials, and acts described herein.

From the foregoing it will be observed that numerous modifications and variations may be effectuated without departing from the true spirit and scope of the novel concepts of the present disclosure. It is to be understood that no limitation with respect to the specific embodiments illustrated is intended or should be inferred.

1. A method for installing heat exchanger tubing into ground, the method comprising:
supplying the heat exchanger tubing;
supplying a penetrator
supplying a plurality of driving members
connecting a first driving member of the plurality of driving members oriented at a first orientation and a second driving member of the plurality of driving members oriented at a second orientation opposite the first orientation and thereby configuring a driving assembly ; and
driving at least a first portion of the driving assembly into the ground and thereby driving the penetrator into the ground with the driving assembly and thereby installing at least a portion of the heat exchanger tubing in the ground.

2. The method of claim 1, further comprising forming a lap joint by the connecting of the first driving member and the second driving member.

3. The method of claim 2, wherein the lap joint is a fully overlapping lap joint.

4. The method of claim 1, further comprising supplying the heat exchanger tubing and the penetrator assembled together.

5. The method of claim 1, wherein an elongated portion of the first driving member and an elongated portion of the second driving member are substantially equal in longitudinal length.

6. The method of claim 1, wherein a longitudinal length of an elongated portion of the first driving member is substantially half of a longitudinal length of the second driving member.

7. The method of claim 1, wherein the first driving member and the second driving member (310M) are substantially equal in longitudinal length.

8. The method of claim 1, wherein a longitudinal length of the first driving member is substantially double a longitudinal length of an elongated portion of the second driving member.

9. The method of claim 1, further comprising:
disconnecting the first driving member and the second driving member from each other;
reorienting the second driving member from the second orientation to the first orientation;
connecting a third driving member of the plurality of driving members oriented at the second orientation and the first driving member and the second driving member and thereby configuring the driving assembly; and
further driving the penetrator into the ground with the driving assembly and thereby installing at least a first additional portion of the heat exchanger tubing in the ground.

10. The method of claim 9, further comprising moving the second driving member away from the first driving member after disconnecting the first driving member and the second driving member from each other and thereby providing a space for installation of the third driving member.

11. The method of claim 9, further comprising:
disconnecting the third driving member and the second driving member from each other;
reorienting the second driving member from the first orientation to the second orientation;
connecting a fourth driving member of the plurality of driving members oriented at the first orientation and the third driving member and the second driving member and thereby configuring the driving assembly; and
further driving the penetrator into the ground with the driving assembly and thereby installing at least a second additional portion of the heat exchanger tubing in the ground.

12. (canceled)

13. The method of claim 11, wherein the third driving member and the fourth driving member are substantially identical to each other.

14. The method of claim 1, further comprising driving at least a second portion of the driving assembly out of the ground while substantially leaving at least the penetrator and the installed portion(s) of the heat exchanger tubing in the ground.

15-26. (canceled)

27. The method of claim 1, further comprising:
positioning a housing of the driving assembly around a fluid return portion of the heat exchanger tubing; and
supplying the heat exchanger tubing, the penetrator, the housing, and the first driving member assembled together as a ground loop with penetrator assembly.

28. (canceled)

29. The method of claim 1, wherein:
the heat exchanger tubing includes a first tube portion a second tube portion, and a fluid return portion that fluidly connects the first tube portion and the second tube portion; and
the first tube portion and/or the second tube portion have a diameter.

30. The method of claim 29, wherein a thickness of the fluid return portion is less than the diameter of the first tube portion and/or the second tube portion.

31. The method of claim 29, wherein a passage area of the fluid return portion is equal to or greater than a passage area of the first tube portion and/or the second tube portion.

32-33. (canceled)

34. The method of claim 29, wherein the thickness of the fluid return portion is less than 80% of the diameter of the first tube portion and/or the second tube portion.

35. (canceled)

36. The method of claim 29, wherein:
the driving assembly includes a housing;
the housing is positioned around the fluid return portion of the heat exchanger tubing; and
a thickness across a medial portion of the housing is equal to or less than the diameter of the first tube portion and/or the second tube portion.

37-38. (canceled)

39. The method of claim 29, wherein a spacing adjacent the fluid return portion between the first tube portion and the second tube portion is greater than three times the diameter of the first tube portion and/or the second tube portion.

40-146. (canceled)
